(19) United States
(12) Patent Application Publication
(10) Pub. No.: US 2011/0026240 A1
(43) Pub. Date: Feb. 3, 2011

(54) OPTICAL ELEMENT LAMINATE AND MANUFACTURING METHOD THEREOF, BACKLIGHT, AND LIQUID CRYSTAL DISPLAY DEVICE

(75) Inventors: Hiroshi Hayashi, Miyagi (JP); Eiji Ohta, Miyagi (JP); Ken Hosoya, Miyagi (JP); Yasuyuki Kudo, Miyagi (JP); Shigehiro Yamakita, Miyagi (JP); Masayasu Kakinuma, Miyagi (JP); Taku Ishimori, Miyagi (JP); Shogo Shinkai, Miyagi (JP); Yoshiyuki Maekawa, Hokkaido (JP); Masami Miyake, Miyagi (JP); Yohei Kanno, Miyagi (JP); Fumiko Sasaki, Miyagi (JP); Akihiro Horii, Miyagi (JP)

Correspondence Address: K&L Gates LLP, P. O. BOX 1135, CHICAGO, IL, 60690, US

(73) Assignee: SONY CORPORATION, Tokyo (JP)

(21) Appl. No.: 12/743,466

(22) PCT Filed: Sep. 18, 2009
(86) PCT No.: PCT/JP2009/066871

§ 371 Date: Aug. 30, 2010

(30) Foreign Application Priority Data
Sep. 22, 2008 (JP) 2008-243268

(51) Int. Cl. G09F 13/04; B32B 3/02; B32B 7/04; G02B 1/04; B32B 37/00

(52) U.S. Cl. 362/97.1; 428/68; 428/192; 428/1.3; 156/163

(57) ABSTRACT

An optical element laminate is provided which, while an increase in thickness of a liquid crystal display device is suppressed, improves insufficient rigidity of an optical element and, in addition, which does not degrade display characteristics of the liquid crystal display device. The optical element laminate includes a plate-shaped support member having a first primary surface and a second primary surface and an optical element which is laminated on at least one of the first primary surface and the second primary surface of the support member and, in addition, which has a film shape or a sheet shape. The periphery of the laminated optical element is at least bonded to facing two sides of the support member, the optical element and the support member are placed in close contact with each other, and a thickness t of the support member, a length L of the support member, and a tensile force F of the optical element satisfy the relational expression of 0≦F≦1.65×10⁴×t/L in an environment at a temperature of 70° C.

### TECHNICAL FIELD

The present invention relates to an optical element laminate and a manufacturing method thereof, and a backlight and a liquid crystal display device, each including the optical element laminate. In particular, the present invention relates to an optical element laminate which improves display characteristics of a liquid crystal display device.

### BACKGROUND ART

Heretofore, in a liquid crystal display device, many optical elements have been used in order to improve the viewing angle, luminance, and the like. As the optical elements mentioned above, for example, film-shaped and sheet-shaped materials, such as a diffusion film and a prism sheet, have been used.

FIG. 1 shows the structure of a conventional liquid crystal display device. As shown in FIG. 1, this liquid crystal display device includes a lighting device 101 emitting light, a diffusion plate 102 diffusing light emitted from the lighting device 101, a plurality of optical elements 103 which perform, for example, condensation and/or diffusion of light diffused by the diffusion plate 102, and a liquid crystal panel 104.

Incidentally, in recent years, concomitant with an increase in size of an image display device, the weight and the size of an optical element itself tend to increase. When the weight and the size of an optical element itself increase, since the rigidity of the optical element becomes insufficient, the optical element is unfavorably deformed. The deformation of the optical element as described above adversely influences on optical directivity toward a display surface, and as a result, a serious problem, that is, luminance irregularity, may arise.

Accordingly, it has been proposed to improve insufficient rigidity of an optical element by increasing the thickness thereof. However, since the thickness of a liquid crystal display device is increased, advantages thereof, that is, a small thickness and a light weight, are degraded. Hence, it has been proposed that optical elements are adhered to each other with a transparent adhesive to improve insufficient rigidity of a sheet-shaped or a film-shaped optical element (for example, see Japanese Unexamined Patent Application Publication No. 2005-301147).

### SUMMARY OF INVENTION

### Technical Problem

However, according to the technique disclosed in Japanese Unexamined Patent Application Publication No. 2005-301147, since the optical elements are adhered to each other with an transparent adhesive provided therebetween, although it is not so serious as compared to the improvement method in which the thickness of each optical element is increased, there has been still a problem in that the thickness of the liquid crystal display device itself is increased. In addition, by the transparent adhesive, display characteristics of the liquid crystal display device may be degraded in some cases.

Hence, an object of the present invention is to provide an optical element laminate which improves insufficient rigidity of an optical element while suppressing an increase in thickness of a liquid crystal display device and which also does not degrade display characteristics thereof and a method for manufacturing the optical element laminate, and a backlight and a liquid crystal display device, each including the optical element laminate.

### Solution to Problem

The inventors of the present invention carried out intensive research in order to improve insufficient rigidity of an optical element while an increase in thickness of a liquid crystal display device and degradation of display characteristics thereof are suppressed, and as a result, an optical element laminate was finally invented in which a film-shaped or a sheet-shaped optical element is bonded to facing two side portions of a peripheral portion of a primary surface of a plate-shaped support member or to facing two end surfaces of end surfaces of the support member.

However, according to the knowledge of the inventors of the present invention, in the optical element laminate as described above, when an optical element having a contractive property or a stretch property is bonded to the support member, since the contractive property of the optical element is not uniform, if an excessive contractive stress is allowed to remain, a stress to the support member is excessively increased, and as a result, warping and twisting occur.

For example, when the optical element laminate is warped in a convex shape toward a liquid crystal panel side of a liquid crystal display device and comes into contact therewith to apply a pressure, light shielding properties of liquid crystal are degraded, thereby generating image quality defects, such as white voids. In addition, when warping in a convex shape is generated toward a backlight side, a strain is generated in the support member, an optical film is undulated to increase luminance irregularities, and/or an end portion is warped to the liquid crystal panel side to generate white voids, so that image quality defects are generated. Alternatively, when warping toward the backlight side occurs strongly, the clearance is decreased to zero, and as a result, problems may arise in which inconveniences, such as creaking noises, are generated.

Accordingly, the inventors of the present invention carried out intensive research in order to suppress the degradation of image quality in the optical element laminate. As a result, it was finally discovered that when a tensile force of the optical element to be bonded to the support member is controlled, warping and creaking noises can be suppressed.

The present invention has been conceived based on the above research.

In order to achieve the above object, in accordance with a first aspect of the present invention, there is provided an optical element laminate comprising:

a plate-shaped support member having a first primary surface, a second primary surface, and end surfaces between the first primary surface and the second primary surface; and

a contractive or a stretch optical element which covers the first primary surface or the second primary surface of the support member and which has a film shape or a sheet shape,

wherein the optical element has a bond surface at least bonded to facing two side portions of a peripheral portion of the first primary surface or the second primary surface of the support member or to facing two end surfaces of the end surfaces of the support member, and

a tensile force F acting on the optical element satisfies the following relational expression (1) in an environment at a temperature of 70° C.

0≦F≦1.65×10⁴×t/L (1)

(Where, in the expression (1), t, L, and F indicate the following.
t: a distance between the first primary surface and the second primary surface of the support member,
L: a length of the facing two side portions to which the optical element is bonded or a length of a long side of the facing two end surfaces to which the optical element is bonded, and
F: a tensile force of the optical element acting in a direction parallel to a side portion having the length L or a tensile force of the optical element acting in a direction parallel to the long side of an end surface having the length L.)

In accordance with a second aspect of the present invention, there is provided an optical element laminate comprising:

a plate-shaped support member having a first primary surface, a second primary surface, and end surfaces between the first primary surface and the second primary surface; and

an optical element which covers the first primary surface or the second primary surface of the support member and which has a film shape or a sheet shape,

wherein the optical element has a bond surface at least bonded to facing two side portions of a peripheral portion of the first primary surface or the second primary surface of the support member or to facing two end surfaces of the end surfaces of the support member, and

a shear tensile strength between the optical element and the support member is 0.14 N/15 mm or more.

In addition, particularly, an optical element laminate in which a peeling strength between the optical element and the support member is less than 20 N/15 mm is preferable from a recycling point of view. Incidentally, the shear tensile strength is a critical bonding strength immediately before peeling occurs when the support member and the optical element are pulled at an angle of 0° which is formed thereby. In addition, the peeling strength is a critical bonding strength immediately before peeling occurs when the support member and the optical element are pulled at an angle of 180° which is formed thereby.

In accordance with a third aspect of the present invention, there is provided a method for manufacturing an optical element laminate comprising:

a step of, while a tensile force is applied to a contractive or a stretch optical element having a film shape or a sheet shape, bonding the optical element to facing two side portions of a peripheral portion of a first primary surface or a second primary surface of a plate-shaped support member or to facing two end surfaces of end surfaces of the support member,

wherein a thickness t of the support member, a length L of the support member, and a tensile force F of the optical element satisfy the following relational expression (1) in an environment at a temperature of 70° C.

0≦F≦1.65×10⁴×t/L (1)

(Where, in the expression (1), t, L, and F indicate the following.
t: a distance between the first primary surface and the second primary surface of the support member,
L: a length of the facing two side portions to which the optical element is bonded or a length of a long side of the facing two end surfaces to which the optical element is bonded, and
F: a tensile force of the optical element acting in a direction parallel to a side portion having the length L or a tensile force of the optical element acting in a direction parallel to the long side of an end surface having the length L.)

In accordance with a fourth aspect of the present invention, there is provided a method for manufacturing an optical element laminate comprising:

a step of, while a tensile force is applied to an optical element having a film shape or a sheet shape, bonding the optical element to facing two side portions of a peripheral portion of a first primary surface or a second primary surface of a plate-shaped support member or to facing two end surfaces of end surfaces of the support member,

wherein a shear tensile strength between the optical element and the support member is 0.14 N/15 mm or more.

According to the first and the third aspects of the present invention, the optical element having a film shape or a sheet shape is bonded to the facing two side portions of the peripheral portion of the primary surface of the plate-shaped support member or to the facing two end surfaces of the end surfaces of the support member, and the tensile force acting on the optical element is controlled. Accordingly, while the generation of sags, irregularities, and wrinkles of the optical element is suppressed, the generation of warping of the optical element laminate can be suppressed. Since the generation of this warping is suppressed, the degradation of image quality, such as white voids, and creaking noises caused by the warping of the optical element laminate can be suppressed.

According to the second and the fourth aspects of the present invention, the optical element having a film shape or a sheet shape is bonded to the facing two side portions of the peripheral portion of the primary surface of the plate-shaped support member or to the facing two end surfaces of the end surfaces of the support member, and the bonding strength between the optical element and the support member is controlled. Accordingly, while the generation of sags, irregularities, and wrinkles of the optical element is suppressed, the generation of warping of the optical element laminate can be suppressed. Since the generation of this warping is suppressed, the degradation of image quality, such as white voids, and creaking noises caused by the warping of the optical element laminate can be suppressed.

### ADVANTAGEOUS EFFECTS OF INVENTION

As has thus been described, according to the present invention, while the increase in thickness of a liquid crystal display device or the degradation of display characteristics thereof is suppressed, insufficient rigidity of the optical element can be improved.

### BRIEF DESCRIPTION OF DRAWINGS

FIG. 1 is a schematic view showing the structure of a conventional liquid crystal display device.

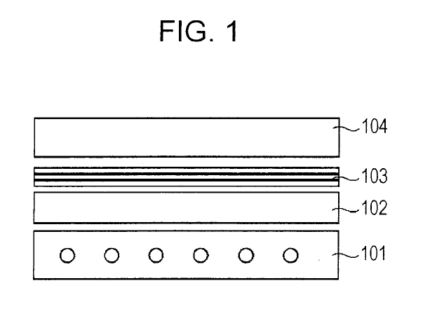

FIG. 2 is a schematic view showing one structural example of a liquid crystal display device according to a first embodiment of the present invention.

FIG. 3 is a schematic plan view showing the relationship between sides of a support member and tensile forces F of a packaging member acting in directions perpendicular to the sides.

FIG. 4A is a schematic plan view showing an orientation axis direction of the packaging member in a first region.

FIG. 4B is a schematic plan view showing an orientation axis direction of the packaging member in a second region.

FIG. 5 is a schematic cross-sectional view showing one structural example of an optical element package according to the first embodiment of the present invention.

FIG. 6 is a schematic cross-sectional view showing a first example of a bond portion of the packaging member.

FIG. 7 is a schematic cross-sectional view showing a second example of the bond portion of the packaging member.

FIG. 8A is a plan view showing one structural example of an optical element package according to a second embodiment of the present invention. FIG. 8B is a perspective view showing one structural example of the optical element package according to the second embodiment of the present invention.

FIG. 9 is a perspective view showing one structural example of a backlight according to a third embodiment of the present invention.

FIG. 10 is a perspective view showing one structural example of a backlight according to a fourth embodiment of the present invention.

FIG. 11 is a perspective view showing a first structural example of an optical element package according to a fifth embodiment of the present invention.

FIG. 12 is a perspective view showing a second structural example of the optical element package according to the fifth embodiment of the present invention.

FIG. 13 is a perspective view showing a third structural example of the optical element package according to the fifth embodiment of the present invention.

FIGS. 14A to 14C are schematic cross-sectional views showing a first to a third example of bonding of a packaging member.

FIGS. 15A to 15C are schematic cross-sectional views showing a fourth to a sixth example of the bonding of the packaging member.

FIGS. 16A and 16B show a flowchart illustrating a method for manufacturing an optical element package according to the fifth embodiment of the present invention.

FIG. 17 is a perspective view showing one example of the structure of an optical element package according to a sixth embodiment of the present invention.

FIGS. 18A to 18D are schematic cross-sectional views showing a first to a fourth example of bonding of a packaging member.

FIGS. 19A to 19D are schematic cross-sectional views showing a fifth to an eighth example of the bonding of the packaging member.

FIG. 20 is a perspective view showing one structural example of a liquid crystal display device according to a seventh embodiment of the present invention.

FIG. 21 is a schematic plan view showing the relationship between sides of a support member and tensile forces F of an optical element acting in directions perpendicular to the sides.

FIG. 22A is an exploded perspective view showing a first example of the optical element. FIG. 22B is a perspective view showing the first example of the optical element.

FIG. 23A is an exploded perspective view showing a second example of the optical element. FIG. 23B is an exploded perspective view showing the second example of the optical element.

FIG. 24A is an exploded perspective view showing a third example of the optical element. FIG. 24B is a perspective view showing the third example of the optical element.

FIGS. 25A to 25D show a flowchart illustrating one example of a method for manufacturing a liquid crystal display device according to the seventh embodiment.

FIG. 26A is an exploded perspective view showing one structural example of an optical element laminate according to an eighth embodiment of the present invention. FIG. 26B is a perspective view showing one structural example of the optical element laminate according to the eighth embodiment of the present invention.

FIG. 27A is an exploded perspective view showing one example of bonding positions of optical elements laminated on respective two primary surfaces of a support member. FIG. 27B is a perspective view showing one example of the bonding positions of the optical elements laminated on the respective two primary surfaces of the support member.

FIGS. 28A to 28C are schematic cross-sectional views showing a first to a third example of a bond portion of the optical element laminate.

FIGS. 29A to 29C are schematic cross-sectional views showing a fourth to a sixth example of the bond portion of the optical element laminate.

FIG. 30A is an exploded perspective view showing one structural example of an optical element laminate according to a ninth embodiment of the present invention. FIG. 30B is a perspective view showing one structural example of the optical element laminate according to the ninth embodiment of the present invention.

FIGS. 31A and 31B are schematic cross-sectional views showing a first and a second example of a bond portion of the optical element laminate.

FIGS. 32A to 32C are schematic cross-sectional views showing a third to a fifth example of the bond portion of the optical element laminate.

FIGS. 33A to 33C are schematic cross-sectional views showing a sixth to an eighth example of the bond portion of the optical element laminate.

FIG. 34 is a schematic cross-sectional view showing one structural example of an optical element laminate according to a tenth embodiment of the present invention.

FIG. 35 is a schematic cross-sectional view showing one structural example of an optical element laminate according to an eleventh embodiment of the present invention.

FIG. 36 is a schematic cross-sectional view showing one structural example of a liquid crystal display device according to a twelfth embodiment of the present invention.

FIG. 37A is a perspective view showing one structural example of an optical element package according to the twelfth embodiment of the present invention. FIG. 37B is a schematic cross-sectional view showing one structural example of the optical element package according to the twelfth embodiment of the present invention.

FIG. 38 is a schematic cross-sectional view showing one structural example of a liquid crystal display device according to a thirteenth embodiment of the present invention.

FIG. 39A is a plan view showing one structural example of an optical element package according to a fourteenth embodiment of the present invention. FIG. 39B is a perspective view showing one structural example of the optical element package according to the fourteenth embodiment of the present invention.

FIG. 40 is a schematic view showing one structural example of a liquid crystal display device according to a fifteenth embodiment of the present invention.

FIGS. 41A to 41C are schematic views each illustrating a structural example of an optical element laminate.

FIGS. 42A to 42C are schematic views each illustrating a structural example of the optical element laminate.

FIGS. 43A to 43C are schematic views each illustrating a structural example of the optical element laminate.

FIGS. 44A to 44C are schematic views each illustrating a structural example of the optical element laminate.

FIGS. 45A and 45B are schematic views each illustrating the principle of degradation of display characteristics due to generation of warping of a support member.

FIG. 46A is a schematic cross-sectional view showing one structural example of a support member on which a bonding layer is formed on a peripheral portion thereof.

FIG. 46B is a schematic cross-sectional view showing one structural example of the support member on which no bonding layer is formed on the peripheral portion thereof.

FIGS. 47A to 47C are schematic cross-sectional views illustrating a first to a third structural example of the bonding layer.

FIG. 48 is a schematic cross-sectional view showing an example of an optical element bonded to an emission surface (first primary surface) of the support member.

FIGS. 49A to 49D are schematic views each illustrating an example of a bonding position.

FIGS. 50A to 50E show a flowchart illustrating one example of a method for manufacturing an optical element laminate according to the fifteenth embodiment of the present invention.

FIGS. 51A to 51C show a flowchart illustrating one example of the method for manufacturing an optical element laminate according to the fifteenth embodiment of the present invention.

FIGS. 52A and 52B are schematic cross-sectional views showing one structural example of an optical element laminate in which a surface layer of a support member or an optical element is used as a bonding layer.

FIG. 53 is an enlarged cross-sectional view showing a structural example of the support member.

FIG. 54 is a schematic cross-sectional view showing an example of a bonding optical element bonded to a peripheral portion of an incident surface of the support member.

FIG. 55A is a schematic cross-sectional view showing a first example of an optical element laminate in which a protrusion is provided on an optical element bonded to a support member. FIG. 55B is a schematic cross-sectional view showing an example in which the optical element laminates each according to the first example are stacked to each other.

FIG. 56A is a schematic cross-sectional view showing the relationship between the height of a structure and that of a protrusion portion. FIG. 56B is a schematic cross-sectional view illustrating the case in which the optical element laminate is warped.

FIG. 57A is a schematic cross-sectional view showing a second example of the optical element laminate in which the protrusion is provided on the optical element bonded to the support member. FIG. 57B is a schematic cross-sectional view showing an example in which the optical element laminates each according to the second example are stacked to each other.

FIG. 58 is a schematic cross-sectional view showing a third example of the optical element laminate in which protrusions are provided on respective optical elements bonded to two primary surfaces of the support member.

FIG. 59A is a schematic cross-sectional view showing a fourth example of the optical element laminate in which a protrusion is provided on a peripheral portion of the support member. FIG. 59B is a schematic cross-sectional view showing a fifth example of the optical element laminate in which the protrusion is provided on the peripheral portion of the support member.

FIG. 60A is a schematic cross-sectional view showing a sixth example of the optical element laminate in which the protrusion is provided on the peripheral portion of the support member. FIG. 60B is a schematic cross-sectional view showing a seventh example of the optical element laminate in which the protrusion is provided on the peripheral portion of the support member.

FIG. 61A is a schematic view showing a first example of the placement of the protrusion portion. FIG. 61B is a schematic view showing a second example of the placement of the protrusion portion. FIG. 61C is a schematic view showing a third example of the placement of the protrusion portion. FIG. 61D is a schematic view showing a fourth example of the placement of the protrusion portion.

FIG. 62A is a schematic view showing one example of the positional relationship between the protrusion portion and a bond portion. FIG. 62B is a schematic view showing another example of the positional relationship between the protrusion portion and the bond portion.

FIG. 63A is a schematic cross-sectional view showing one structural example of a liquid crystal display device according to an eighteenth embodiment of the present invention. FIG. 63B is a schematic cross-sectional view showing another structural example of the liquid crystal display device according to the eighteenth embodiment of the present invention.

FIG. 64A is a schematic view showing a first example of a bonding position between an optical element laminate and a middle frame. FIG. 64B is a schematic view showing a second example of the bonding position between the optical element laminate and the middle frame. FIG. 64C is a schematic view showing a third example of the bonding position between the optical element laminate and the middle frame. FIG. 64D is a schematic view showing another example of the bonding position between the optical element laminate and the middle frame.

FIG. 65 includes schematic views showing one example of a method for forming a liquid crystal display device.

FIG. 66 is a graph showing the relationship between a tensile force of a sample and a ratio t/L.

FIG. 67A is a schematic view showing an example in which cylindrical protrusion portions are provided in the vicinity of at least one pair of facing sides of a rectangular support member. FIG. 67B is a schematic cross-sectional view showing an example in which wedge-shaped protrusion portions are provided in the vicinity of at least one pair of facing sides of a rectangular support member.

FIG. 67C is a schematic cross-sectional view showing an example in which the optical element laminates each shown in FIG. 67B are stacked to each other.

### DESCRIPTION OF EMBODIMENTS

With reference to the drawings, embodiments of the present invention will be described in the following order. In addition, in all the drawings of the following embodiments, the same or corresponding portions are designated by the same symbols.

(1) First embodiment (example of an optical element package wrapping a support member and an optical element)
(2) Second embodiment (example of an optical element package having openings at corner portions)
(3) Third embodiment (example in which a reflection type polarizer is disposed at an outer side)
(4) Fourth embodiment (example in which an optical function of a packaging member is imparted)
(5) Fifth embodiment (example in which an optical element laminate is wrapped with a belt-shaped packaging member)
(6) Sixth embodiment (example in which a bonding member is disposed at a periphery of an optical element laminate)
(7) Seventh embodiment (example of an optical element laminate in which an optical element is bonded to one primary surface of a support member)
(8) Eighth embodiment (example of an optical element laminate in which optical elements are bonded to two primary surfaces of a support member)
(9) Ninth embodiment (example of an optical element laminate in which a plurality of optical elements is bonded to one primary surface of a support member)
(10) Tenth embodiment (example in which a support member and an optical element are also bonded to each other at positions other than peripheries thereof)
(11) Eleventh embodiment (example in which a support member and an optical element are point-bonded to each other)
(12) Twelfth embodiment (example of a side light type backlight)
(13) Thirteenth embodiment (example of a side light type backlight)
(14) Fourteenth embodiment (example of an optical element package having openings at side portions)
(15) Fifteenth embodiment (example in which a bonding layer is provided between an optical element and a support member)
(16) Sixteenth embodiment (example in which a surface layer is used as a bonding layer)
(17) Seventeenth embodiment (example in which a protrusion is provided on a periphery portion of an optical element laminate)
(18) Eighteenth embodiment (example in which a middle frame is provided which supports an optical element laminate)

### (1) First Embodiment

### (1-1) Structure of Liquid Crystal Display Device

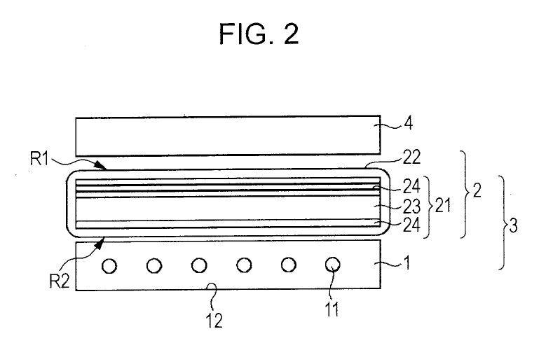

FIG. 2 shows one structural example of a liquid crystal display device according to a first embodiment of the present invention. As shown in FIG. 2, this liquid crystal display device includes a backlight 3 emitting light and a liquid crystal panel 4 displaying an image based on light emitted from the backlight 3. The backlight 3 includes a lighting device 1 which emits light and an optical element package 2 which improves characteristics of light emitted from the lighting device 1 and which sends light toward the liquid crystal panel 4. Hereinafter, in various optical members such as the optical element package 2, a surface on which light from the lighting device 1 is incident is referred to as an incident surface, a surface emitting light incident through this incident surface is referred to as an emission surface, and a surface located between the incident surface and the emission surface is referred to as an end surface. In addition, the incident surface and the emission surface are collectively referred to as primary surfaces in some cases. In addition, hereinafter, the emission surface and the incident surface are referred to as a first primary surface and a second primary surface, respectively, in some cases.

### [Lighting Device]

The lighting device 1 is, for example, a direct type lighting device and includes at lease one light source 11 emitting light and a reflection plate 12 reflecting light emitted from the light source 11 in a direction toward the liquid crystal panel 4. As the light source 11, for example, a cold cathode fluorescent lamp (CCFL), a hot cathode fluorescent lamp (HCFL), organic electroluminescence (OEL), inorganic electroluminescence (IEL), or a light emitting diode (LED) may be used. The reflection plate 12 is provided, for example, so as to cover the bottom and the side portions of the at least one light source 11 and is configured so that light emitted from the at least one light source 11 to the bottom, the side portion, and the like is reflected in a direction toward the liquid crystal panel 4.

### [Optical Element Package]

The optical element package 2 includes, for example, at least one optical element 24 which changes light characteristics by performing a treatment, such as diffusion or condensation, on light emitted from the lighting device 1, a support member 23 supporting the at least one optical element, and a packaging member 22 wrapping the at least one optical element 24 and the support member 23 to form an integrated body. The optical element 24 is provided at least one of an incident surface side and an emission surface side of the support member 23. Hereinafter, a laminate in which the support member 23 and the at least one optical element 24 are laminated to each other is referred to as an optical element laminate 21.

The number and the type of optical elements 24 are not particularly limited and can be appropriately selected in accordance with characteristics of a desired liquid crystal display device. As the optical element 24, for example, a material composed of the support member 23 and at least one functional layer may be used. In addition, by omitting the support member, a material composed of only a functional layer may also be used. As the optical element 24, for example, a light diffusion element, a light condensation element, a reflection type polarizer, a polarizer, or a light division element may be used. As the optical element 24, for example, a film-shaped, a sheet-shaped, or a plate-shaped material may be used. The thickness of the optical element 24 is preferably 5 to 3,000 μm and more preferably 25 to 1,000 μm. In addition, as for the thickness of each optical element 24, compared to the case in which the optical elements 24 are laminated to each other, when at least one optical element 24 is wrapped together with the support member 23, the thickness can be decreased by approximately 20% to 50% as compared to the thickness used in the past.

The support member 23 is, for example, a transparent plate transmitting light emitted from the lighting device 1 or an optical plate changing light characteristics by performing a treatment, such as diffusion or condensation, on light emitted from the lighting device 1. As the optical plate, for example, a diffusion plate, a retardation plate, or a prism plate may be used. In addition, for example, a reflective polarizer or a sheet or the like having an irregular shape on the surface thereof may also be used. In the present invention, a material having a highest rigidity in the optical element laminate is called the support member for convenience and is not limited to the thickness and optical function thereof. Accordingly, the thickness of the support member 23 is, for example, 10 to 50,000 μm. The support member 23 is composed, for example, of a high molecular weight material, and the transmittance thereof is preferably 30% or more. In addition, the order of lamination of the optical element 24 and the support member 23 is selected in accordance with the function of the optical element 24 and that of the support member 23. For example, when the support member 23 is a diffusion plate, the support member 23 is provided at a side on which light from the lighting device 1 is incident, and when the support member 23 is a reflection type polarizer, the support member 23 is provided at a side at which light is emitted to the liquid crystal panel 4. The shapes of the incident surfaces of the optical element 24 and the support member 23 and the shapes of the emission surfaces thereof are selected in accordance with the shape of the liquid crystal panel 4, and for example, the shape is a rectangle having a different longitudinal/lateral ratio (aspect ratio). In addition, since the support member 23 preferably has an appropriate rigidity, as a material therefor, a material having an elastic modulus of approximately 1.5 GPa or more at ordinary temperature is preferable, and for example, a polycarbonate, a poly(methyl methacrylate), a polystyrene, a cycloolefinic resin (such as Zeonor (registered trade mark)), or glass may be mentioned.

The primary surfaces of the optical element 24 and the support member 23 are preferably processed by a roughing treatment or are preferably processed to contain fine particles. The reason for this is that rubbing and friction can be reduced. In addition, whenever necessary, additives, such as a light stabilizer, an ultraviolet absorber, an antistatic agent, a flame retardant, and an antioxidant, may be contained in the optical element 24 and the support member 23 so as to impart an ultraviolet absorbing function, an infrared absorbing function, an antistatic function, and the like to the optical element 24 and the support member 23. In addition, a surface treatment, such as an antireflection treatment (AR treatment) or an antiglare treatment (AG treatment), may be performed on the optical element 24 and the support member 23 so as to diffuse reflected light or to reduce reflected light itself. In addition, a function of reflecting ultraviolet rays and/or infrared rays may also be imparted to the surfaces of the optical element 24 and the support member 23.

The packaging member 22 is, for example, a single-layer or a multilayer film or sheet having transparent properties. The packaging member 22 has, for example, a bag shape, and all the surfaces of the optical element laminate 21 are closed by this packaging member 22. In addition, the packaging member 22 may have a structure in which end portions of films overlapped with each other with the optical element laminate 21 interposed therebetween are bonded to each other so that two, three, or four sides of the packaging member 22 are closed. In particular, for example, as the packaging member 22 in which two sides thereof are closed, there may be mentioned a packaging member in which end portions of a belt-shaped film or sheet in a longitudinal direction are bonded to each other and a packaging member in which after two rectangular films or sheets are overlapped with each other, facing two sides are bonded. As the packaging member 22 in which three sides are closed, there may be mentioned a packaging member in which after a belt-shaped film or sheet is folded so that end portions in a longitudinal direction are overlapped with each other, two sides are bonded and a packaging member in which after two rectangular films or sheets are overlapped with each other, three sides are bonded. As the packaging member 22 in which four sides are closed, there may be mentioned a packaging member in which after a belt-shaped film or sheet is folded so that end portions in a longitudinal direction are overlapped with each other, three sides are bonded and a packaging member in which after two rectangular films or sheets are overlapped with each other, four sides are bonded. Incidentally, hereinafter, of the surfaces of the packaging member 22, a surface located at the optical element laminate 21 side is referred to as an inside surface, and the surface opposite thereto is referred to as an outside surface. In addition, in the packaging member 22, a region at an incident surface side on which light from the lighting device 1 is incident is referred to as a second region R2, and a region at an emission surface side at which light incident from the lighting device 1 is emitted toward the liquid crystal panel 4 is referred to as a first region R1.

The thickness of the packaging member 22 is selected, for example, to be 5 to 5,000 μm. The thickness is preferably 10 to 500 μm and more preferably 15 to 300 μm. When the thickness of the packaging member 22 is large, for example, a decrease in luminance and/or non-uniform contraction of a thermal-welded portion (sealed portion) of the packaging member 22 occurs. In addition, since failure of adhesion to the optical element laminate 21 is generated, and wrinkles and the like are generated, when mounting is performed on an actual apparatus, deformation occurs, and an image is degraded thereby. Furthermore, the packaging member 22 may be designed such that the thickness at the incident surface side is different from that at the emission surface side. In addition, in view of rigidity, the packaging member 22 may include a frame member.

When the packaging member 22 has an anisotropy, its optical anisotropy is preferably small. In particular, its retardation is preferably 50 nm or less and more preferably 20 nm or less. As the packaging member 22, a uniaxial or a biaxial stretched sheet or film is preferably used. When the sheet or film as described above is used, since the packaging member 22 can be contracted in a stretched direction by applying heat thereto, the adhesion between the packaging member 22 and the optical element laminate 21 can be enhanced.

The packaging member 22 is preferably configured to have a contractive property. The reason for this is that when heat is again applied to the packaging member 22 which is stretched beforehand by heating, the heat contractive property can be obtained. In addition, the packaging member 22 preferably has a stretch property. Accordingly, after the support member 23 and the optical element 24, which are inclusions, are sandwiched by stretching end surfaces of the packaging member 22, when end portions are welded by heat sealing, packaging/contraction can be performed by the stretch property.

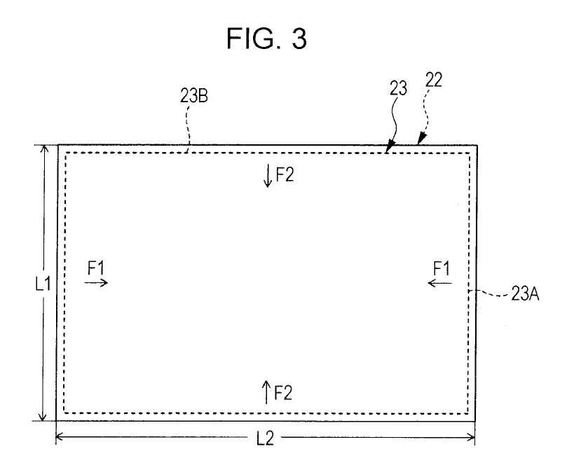

FIG. 3 is a schematic plan view showing the relationship between individual sides of the support member 23 and tensile forces F of the packaging member 22 acting in directions perpendicular to the individual sides. The support member 23 has a rectangular primary surface. The rectangular primary surface is formed of first sides 23A and 23A facing each other and second sides 23B and 23B which are perpendicular to the first sides and which face each other. A thickness t of the support member 23, lengths L1 and L2 of the first side 23A and the second side 23B of the support member 23, and tensile forces F2 and F1 of the packaging member acting parallel to the first side 23A and second side 23B, respectively, satisfy the following relational expressions (2) and (3) at a temperature of 70° C.

0≦F1≦1.65×10⁴×t/L2 (2)

0≦F2≦1.65×10⁴×t/L1 (3)

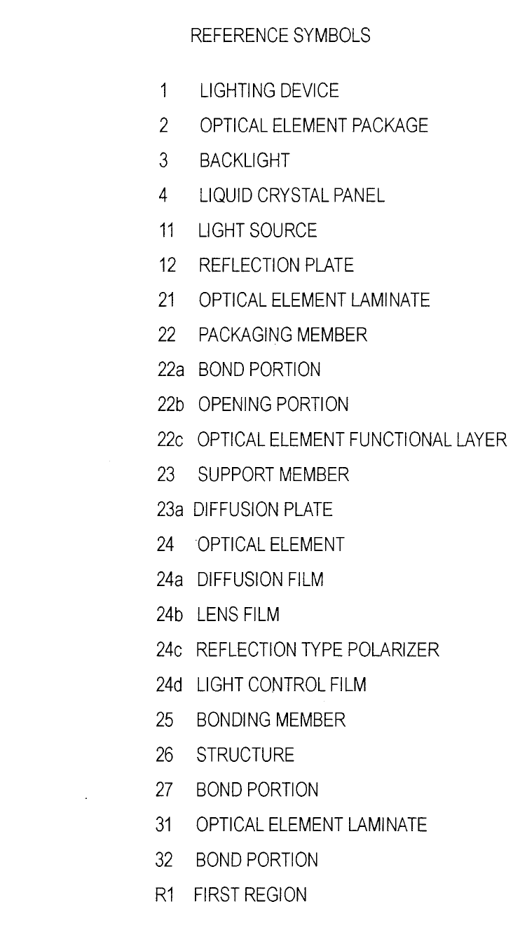

Hereinafter, with reference to FIG. 66, the relationship of the tensile force in a direction parallel to the first side 23A with the thickness t of the support member 23/the length L1 of the first side 23A and the relationship of the tensile force in a direction parallel to the second side 23B with the thickness t of the support member 23/the length L2 of the second side 23B will be described. From FIG. 66, it is found that by a slope factor of the tensile force with respect to the thickness t of the support member/the length L of the first side or the second side, a region of a high tensile force range in which a warping defect occurs can be separated from a region of a tensile force range in which no warping occurs. From this relational expression, it is understood that the direction of the tensile force F1 or the tensile force F2 has an inverse proportional relation to the length of the side parallel to the tensile force direction, a tensile force liable to generate warping may be decreased as the long side length is increased, and a tensile force liable to generate warping can be increased as the short side length is decreased. From the relationships described above, by the thickness t of the support member 23 and the shape thereof, a tensile force which generates no warping can be understood, and hence an image quality defect and the like caused by warping can be suppressed.

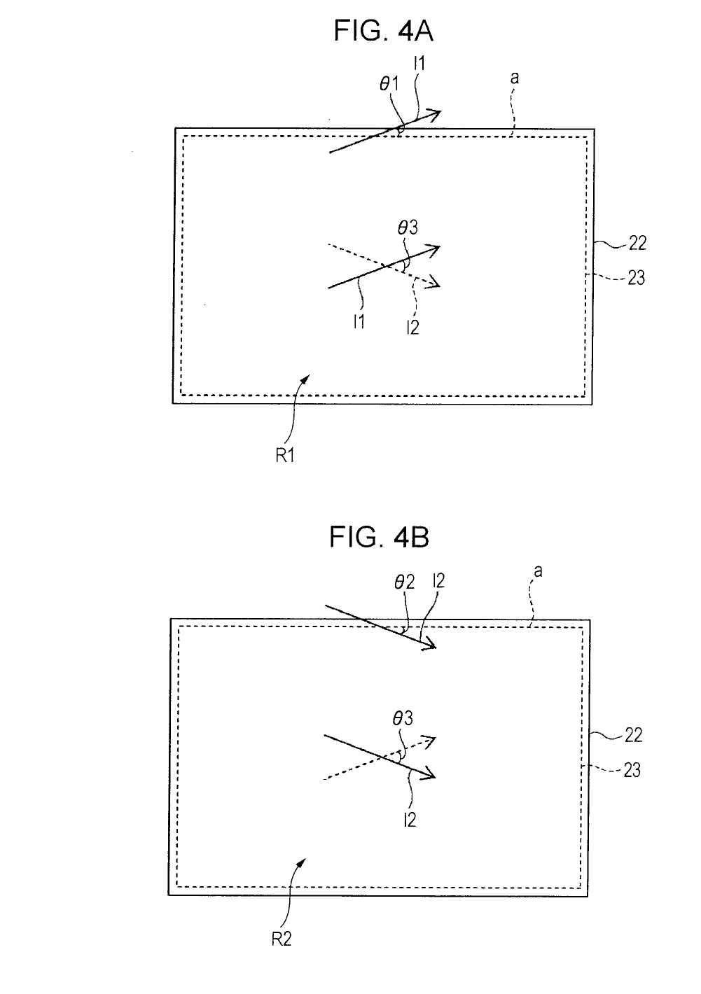

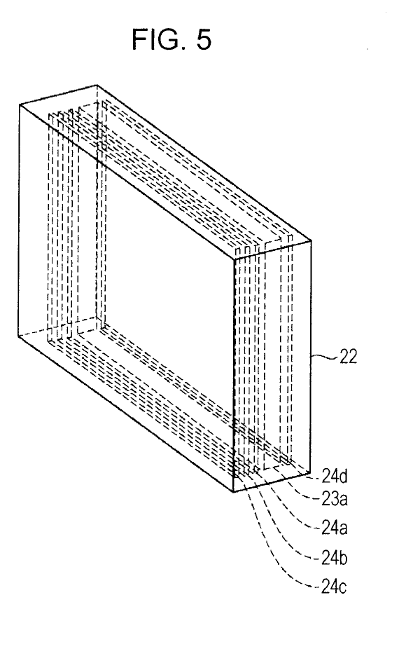

FIG. 4A shows an orientation axis direction of a high molecular weight material in the first region R1 of the packaging member 22. FIG. 4B shows an orientation axis direction of the high molecular weight material in the second region R2 of the packaging member 22. The packaging member 22 has orientation axes 11 and 12 of the high molecular weight material in the first region R1 and the second region R2, respectively. The orientation axis 11 in the first region R1 and a side surface a of the support member 23 form an angle θ1. The orientation axis 12 in the second region R2 and the side surface a of the support member 23 form an angle θ2. Those angles θ1 and θ2 thus formed are each preferably 8° or less and more preferably 3.5° or less. When the angle is more than the above numerical range, since the contractive property of the packaging member 22 is not uniform, the packaging member 22 cannot be completely contracted, and sags and/or wrinkles are unfavorably generated. Accordingly, as a surface light source, luminance irregularity is generated, and image quality of the liquid crystal display device is degraded.

In addition, the orientation axis 11 in the first region R1 of the packaging member 22 and the orientation axis 12 in the second region R2 of the packaging member 22 form an angle θ3. The angle θ3 thus formed is preferably 16° or less and more preferably 7° or less. When the angle is more than the above numerical range, since the contractive property of the packaging member 22 is not uniform, the packaging member 22 cannot be completely contracted, and sags and/or wrinkles are unfavorably generated. Accordingly, as the surface light source, luminance irregularity is generated, and image quality of the liquid crystal display device is degraded.

When the packaging member 22 is formed of a transparent resin material, as a method for measuring the orientation axis, for example, there may be mentioned a grasping method using a measurement method (retardation measurement) in which a slope obtained when a polarization wave is applied to a test piece or the like cut out of the packaging member 22 is measured or a measuring method performed using a transmission microwave by a molecular orientation meter or the like.

In addition, as a method for changing the angle formed between the long side of a film and the orientation axis thereof, a method can be practically realized in which after the long side direction of the film is rotated at an arbitrary angle, and cutting thereof is then performed, the support member and the optical element, which are to be included, are wrapped, and end portions are then heat sealed for heat contraction of the film. Alternatively, in an original contractive film, since the orientation axis at a central portion of the original film is different from that at two end portions thereof, the angle can also be changed depending on a position from which a contractive film is sampled. For example, in the case of a contractive film obtained from the central portion, when the orientation axis and the axis of the contractive film are made parallel to each other, the gap therebetween can be reduced, and alignment can be easily performed. On the other hand, in the case in which the end portion of the original contractive film is used, the gap between the longitudinal direction of the film and the orientation axis is increased, and when members to be included are simply disposed parallel to the longitudinal direction of the film, the gap from the orientation axis is increased. In order to avoid those described above, when the directions of the members to be included are placed parallel to the orientation axis, and the end portions are heat-sealed and heat-contracted, the gap can be reduced.

As a material for the packaging member 22, a high molecular weight material having a heat contractive property is preferably used, and more preferably, since the temperature inside the liquid crystal display device or the like increases up to approximately 70° C., a high molecular weight material which is contracted by heat application from ordinary temperature to 85° C. can be used. Although a material which satisfies the above-described relation is not particularly limited, in particular, for example, materials, such as a polystyrene (PS), a copolymer of a polystyrene and butadiene, a polypropylene (PP), a polyethylene (PE), an unstretched poly(ethylene terephthalate) (PET), polycarbonate (PC), a polyester-based resin such as poly(ethylene naphthalate) (PEN), and a vinyl bond base, such as a poly(vinyl alcohol) (PVA), a cycloolefin-based resin, a urethane-based resin, a vinyl chloride-based resin, a natural rubber-based resin, and an artificial rubber-based resin, may be used alone or in combination.

The heat contraction rate of the packaging member 22 is preferably selected in consideration, for example, of the sizes and materials of the support member 23 and the optical element 24, which are to be included, and the usage conditions of the optical element laminate 21. In particular, at 85° C., the contraction rate is preferably 0.2% to 100%, more preferably 0.5% to 20%, and even more preferably 0.5% to 10%. When the contraction rate is less than 0.2%, the adhesion between the packaging member 22 and the optical element 24 may be degraded, and when the contraction rate is more than 100%, since the heat contraction property may become non-uniform in the plane, the optical element may be contracted in some cases. The heat distortion temperature of the packaging member 22 is preferably 85° C. or more. The reason for this is that the degradation of optical characteristics of the optical element package 2 caused by heat generated from the light source 11 can be suppressed. The drying loss of the material for the packaging member 22 is preferably 2% or less. The refractive index of the material for the packaging member 22 (refractive index of the packaging member 22) is preferably 1.6 or less and more preferably 1.55 or less. However, when an optical functional layer obtained by shape impartation or shape transfer impartation is provided on the packaging member 22, since the influence thereof is increased as the refractive index is increased, the refractive index is preferably 1.5 or more, more preferably 1.57 or more, and most preferably 1.6 or more, and a preferable refractive index range is desirably selected in accordance with the functional layer. The reason for this is that as the refractive index is increased, optical effects are enhanced, and for example, a condensation effect, a diffusion effect, and the like can be improved.

The packaging member 22 preferably contains at least one type of filler. The reasons for this are that when optical element packages are overlapped with each other, the optical element packages are prevented from being adhered to each other, and that a packaging member 2 and inclusion members are prevented from being adhered to each other due to excessively enhanced adhesion between the packaging member 22 and the inclusion members. As the filler, for example, at least one of organic fillers and inorganic fillers may be used. As a material for the organic fillers, for example, at least one selected from the group consisting of an acrylic resin, a styrene resin, a fluorinated resin, and a hollow may be used. As the inorganic fillers, for example, at least one selected from the group consisting of silica, alumina, talc, titanium oxide, and barium sulfate may be used. As for the shape of the filler, various shapes, such as a needle, a sphere, an oval, a plate, and a scale shape, may be used. As the diameter of the filler, for example, at least one type of diameter is selected.

In addition, instead of the filler, a shape may be provided on the surface. As a method for forming the shape, for example, there may be mentioned a method in which when a contractive film or sheet for forming the packaging member 22 is formed, an arbitrary diffusive shape is imparted on the surface of the film or the sheet by transfer and a method in which after a film or a sheet is formed, an arbitrary diffusive shape is imparted thereto by transfer by application of heat and/or pressure.

In addition, whenever necessary, additives, such as a light stabilizer, an ultraviolet absorber, an antistatic agent, a flame retardant, and an antioxidant, may be further contained in the packaging member 22 so as to impart an ultraviolet absorbing function, an infrared absorbing function, an antistatic function, and the like to the packaging member 22. In addition, for example, a surface treatment, such as an antiglare treatment (AG treatment) and an antireflection treatment (AR treatment), may be performed on the packaging member 22 so as to, for example, diffuse reflected light or to reduce reflected light itself. Furthermore, a function of transmitting light, such as UV-A light (approximately 315 to 400 nm), in a particular wavelength region may also be imparted.

### [Liquid Crystal Panel]

The liquid crystal panel 4 functions to modulate light supplied from the light source 11 in terms of time and space to display information. As the liquid crystal panel 4, for example, panels having display modes, such as a twisted nematic (TN) mode, a super twisted nematic (STN) mode, a vertically aligned (VA) mode, an in-plane switching (IPS) mode, an optically compensated birefringence (OCB) mode, a ferroelectric liquid crystal (FLC) mode, a polymer dispersed liquid crystal (PDLC) mode, and a phase change guest host (PCGH) mode, may be used.

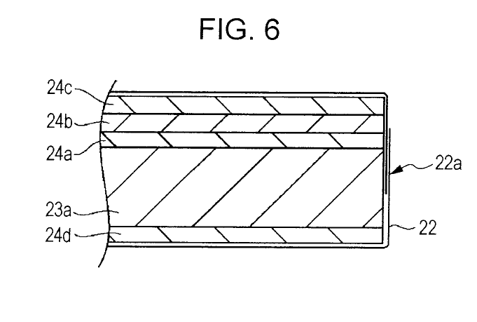

Next, with reference to FIGS. 5 to 7, a structural example of the optical element package 2 will be described in detail.

FIG. 5 shows one structural example of the optical element package according to the first embodiment of the present invention. As shown in FIG. 5, the optical element package 2 includes, for example, a diffusion plate 23a functioning as the support member; a diffusion film 24a, a lens film 24b, and a reflection type polarizer 24c, which are the optical elements; and the packaging member 22 wrapping those mentioned above to form an integrated body. In this case, the diffusion plate 23a, the diffusion film 24a, the lens film 24b, and the reflection type polarizer 24c form the optical element laminate 21. The primary surface of the optical element laminate 21 has, for example, a rectangular shape having a different longitudinal/lateral ratio. The packaging member 22 has, for example, a bag shape, and all the directions of the optical element laminate 21 are closed by this packaging member 22. The packaging member 22 is bonded by thermal welding or the like, for example, at an end surface of the optical element laminate 21.

The diffusion plate 23a is provided above the at least one light source 11 and functions to uniform the luminance by diffusing light emitted from the at least one light source 11 and light reflected by the reflection plate 12. As the diffusion plate 23a, for example, there may be used a material which includes a surface having an irregular structure for diffusing light, a material including fine particles or the like which have a refractive index different from that of a primary constituent material of the diffusion plate 23a, a material including hollow fine particles, or a material in which at least two of the above irregular structure, fine particles, and hollow fine particles are used in combination. As the fine particles, for example, at least one type of organic fillers and inorganic fillers may be used. In addition, the irregular structure, the fine particles, and the hollow fine particles are provided, for example, on the emission surface of the diffusion film 24a. The light transmittance of the diffusion plate 23a is, for example, 30% or more.

The diffusion film 24a is provided on the diffusion plate 23a and functions, for example, to further diffuse light diffused by the diffusion plate 23a. As the diffusion film 24a, for example, there may be used a material which includes a surface having an irregular structure for diffusing light, a material including fine particles or the like which have a refractive index different from that of a primary constituent material of the diffusion film 24a, a material including hollow fine particles, or a material in which at least two of the above irregular structure, fine particles, and hollow fine particles are used in combination. As the fine particles, for example, at least one type of organic fillers and inorganic fillers may be used. In addition, the irregular structure, the fine particles, and the hollow fine particles are provided, for example, on the emission surface of the diffusion film 24a.

The lens film 24b is provided above the diffusion film 24a and functions to improve the directivity and the like of radiated light. On the emission surface of the lens film 24b, for example, lines of fine prisms or lenses are provided, the cross section of the prism or the lens in the line direction has, for example, an approximately triangle shape, and the peak thereof is preferably rounded. The reasons for this are that the cut-off can be improved, and that a wide viewing angle can be improved. On the other hand, when the improvement in luminance is set as the primary object, a lens film in which the cross section of a prism or a lens has a perfect triangle shape (such as a rectangular equilateral triangle) or an approximately perfect triangle shape may also be used. The lens film as described above can be formed, for example, in such a way that a master having triangle irregularities is pressed to a film using a laminating machine, a press machine, or the like so that irregular shapes are transferred to the film.

A light control film 24d has an optical functional layer having an irregular structure on at least one of the incident surface and the emission surface and is provided to control light source irregularity of a CCFL or an LED. For example, there may be provided a continuous shape of prisms, circular arcs, hyperboloids, or paraboloids; a single triangle shape thereof; or a shape in combination therebetween, and depending on the case, there may also be provided a structure having a flat surface or a material such as the diffusion film 24a.

The diffusion film 24a and the lens film 24b are each formed, for example, of a high molecular weight material, and the refractive index thereof is, for example, 1.5 to 1.6. As a material for forming the optical element 24 or a material for forming an optical functional layer provided therefor, for example, a thermoplastic resin, an ionizing photosensitive resin to be cured by light or electron beams, a thermosetting resin to be cured by heat, or an ultraviolet curable resin to be cured by ultraviolet rays is preferable.

The reflection type polarizer 24c is provided on the lens film 24b and functions in such a way that among light beams each having directivity enhanced by the lens film 24b, only one of polarized components orthogonal to each other is allowed to pass and the other component is reflected. The reflection type polarizer 24C is a laminate, such as an organic multilayer film, an inorganic multilayer film, or a liquid crystal multilayer film. In addition, a material having a different refractive index may also be included in the reflection type polarizer 24C. Furthermore, a diffusion layer and a lens may also be provided for the reflection type polarizer 24C.

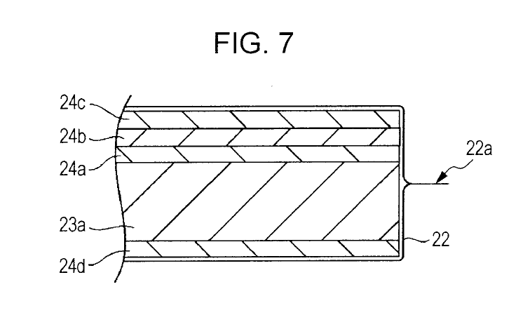

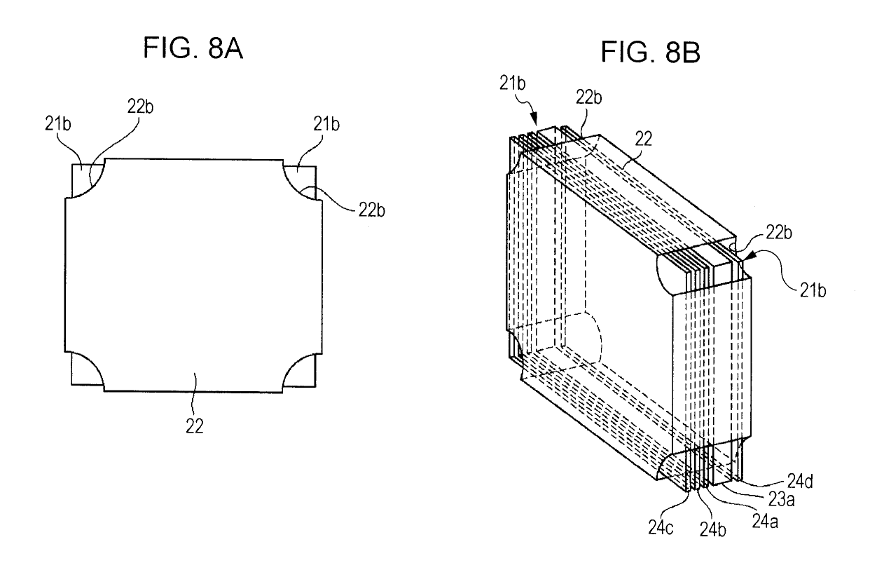

Hereinafter, with reference to FIGS. 6 and 7, an example of a bond portion of the packaging member 22 will be described.

### [Bond Portion of Packaging Member]

### (First Example)

FIG. 6 shows a first example of a bond portion of the packaging member. In this first example, as shown in FIG. 6, an inside surface and an outside surface of end portions of the packaging member are bonded so as to be overlapped with each other on an end surface of the optical element laminate 21. That is, the end portions of the packaging member 22 are bonded to each other so as to be along the end surface of the optical element laminate 21.

### (Second Example)

FIG. 7 shows a second example of the bond portion of the packaging member. In this second example, as shown in FIG. 7, inside surfaces of the end portions of the packaging member are bonded so as to be overlapped with each other at one end surface of the optical element laminate 21. That is, the end portions of the packaging member 22 are bonded to each other so as to stand erect from the end surface of the optical element laminate 21.

### (1-2) Method for Manufacturing Optical Element Package

Next, one example of a method for manufacturing the optical element package 2 having the above structure will be described. First, on the light control film 24d, the diffusion plate 23a, the diffusion film 24a, the lens film 24b, and the reflection type polarizer 24C are placed in this order, so that the optical element laminate 21 is obtained. Subsequently, an original film having a contractive property is prepared, and two rectangular films are cut out of this original film. In this step, the long side of this rectangular film and the orientation axis thereof are preferably set so as to form an angle of 8° or less.

Next, the two films are overlapped with each other, and two or three sides thereof are thermal-welded, so that a bag-shaped packaging member 22 is obtained. Alternatively, when the optical element laminate 21 is sandwiched between the two films, and at least two sides among the end portions of the two films are, for example, thermal-welded, the bag-shaped packaging member 22 can also be obtained. In this step, the angle formed between the orientation axes of the two films is preferably set to 16° or less. In addition, after the optical element laminate 21 is inserted between one or two films, opened two, three, or four sides are thermal-welded to seal the packaging member 22, so that the optical element package 2 can also be obtained. Subsequently, after the above optical element laminate 21 is inserted through an opened side, the opened side is thermal-welded to seal the packaging member 22, so that the optical element package 2 is obtained. Next, the optical element package 2 is transferred to an oven or the like, and the packaging member 22 is then contracted in a high-temperature environment.

Accordingly, a targeted optical element package can be obtained.

In this first embodiment, since the optical elements 24 and the support member 23 are wrapped with the packaging member 22, the insufficient rigidity of the optical element can be improved while an increase in thickness thereof is suppressed.

### (2) Second Embodiment

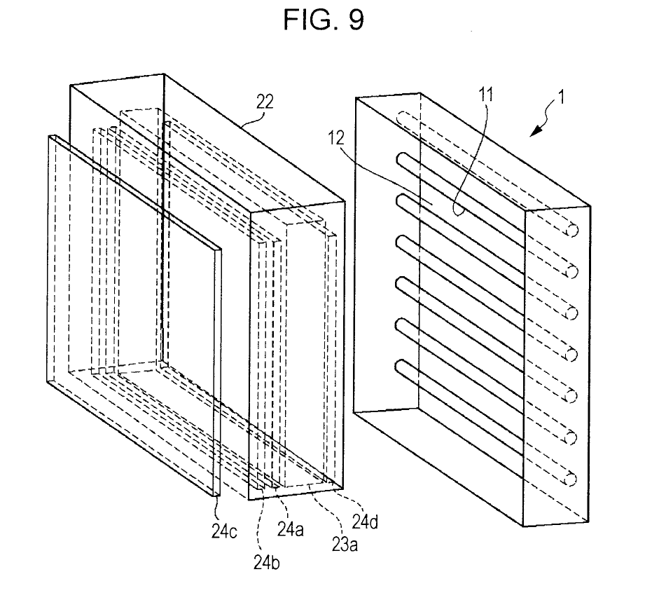

FIGS. 8A and 8B each show one structural example of an optical element package according to a second embodiment of the present invention. In this second embodiment, at least one opening 22c is provided in the packaging member 22 according to the first embodiment. The opening 22c is provided, for example, at a position corresponding to at least one of corner portions 21b of the optical element laminate 21.

In this second embodiment, since the at least one opening 22c is provided in the packaging member 22, when the packaging member 22 is contracted in a process for forming the optical element package 2, air inside the packaging member 22 can be discharged outside through the opening 22c. Hence, the packaging member 22 can be suppressed, for example, from being swelled. The reason for this is that when swelling occurs, deformation is generated if mounting is performed on an actual apparatus, and an image is degraded thereby. In addition, the packaging member 22 can be suppressed from being fractured. In addition, besides the function as an outlet for air during heat contraction, when mounting is performed in a liquid crystal display device, the opening also functions as an outlet for air when air expansion occurs by heat and/or as an outlet for air and the like which are generated from the optical element laminate 21.

### (3) Third Embodiment

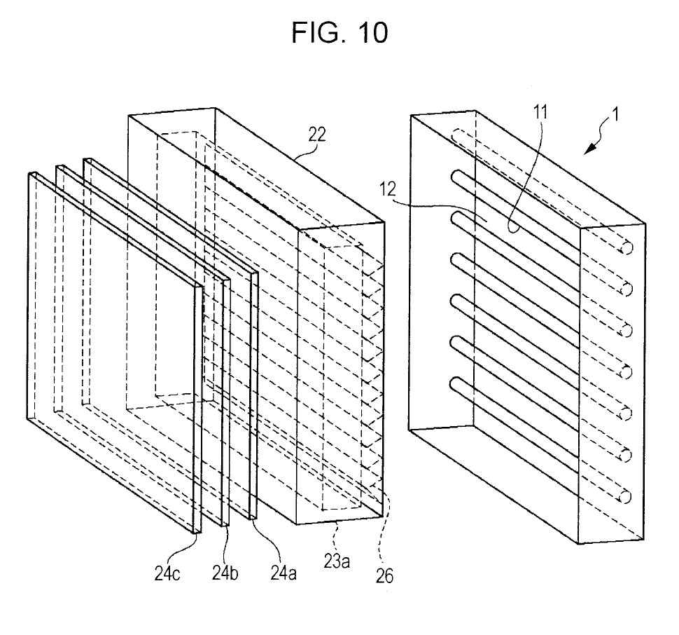

In FIG. 9, one structural example of a backlight according to a third embodiment of the present invention is shown. In this third embodiment, instead of using the reflection type polarizer 24c disposed immediately under the first region R1 of the packaging member 22 in the first embodiment, the lens film 24b such as a prism sheet is disposed.

The lens film 24b is one type of optical element in which a pattern is imparted to a surface of a transparent base material. As an optimum shape of a pattern formed on the surface, a triangle shape is preferable. By a prism pattern formed on this film, light emitted from the light source 11 is condensed by reflection refraction. Although the lens film 24b used in this third embodiment of the present invention is not particularly limited, for example, BEF manufactured by Sumitomo 3M Limited may be used.

In addition, in order to suppress the glare of the lens film 24b, slight diffuseness is also preferably included in the second region R2 of the packaging member 22.

As shown in FIG. 9, from the lighting device 1 toward the liquid crystal panel 4, for example, the optical element package 2 and the reflection type polarizer 24C which is an optical element are provided in this order. The optical element package 2 is formed such that the diffusion plate 23a, the diffusion film 24a, and the lens film 24b are wrapped with the packaging member 22 and are integrated together.

### (4) Fourth Embodiment

This fourth embodiment is an embodiment in which in the first embodiment, an optical element function is imparted to the packaging member 22. The packaging member 22 is a material in which an optical element functional layer is provided for at least one of the first region R1 and the second region R2. The optical element functional layer is provided, for example, on at least one of the inside surface and the outside surface of the packaging member 22. The optical element functional layer is a material which improves light emitted from the lighting device 1 to have desired characteristics by performing a predetermined treatment. As the optical element functional layer, for example, a diffusion functional layer having a function to diffuse incident light, a light condensation functional layer having a function to condense light, and a light source division functional layer having a function of the light control film 24d described above may be mentioned. In particular, in the optical element functional layer, for example, a structure, such as a cylindrical lens, a prism lens, or a fly-eye lens is provided. In addition, a wobble may be added to the structure, such as a cylindrical lens or a prism lens. As an optical functional layer, for example, an ultraviolet ray-cut functional layer (UV-cut functional layer) cutting ultraviolet rays or an infrared-cut functional layer (IR-cut functional layer) cutting infrared rays may also be used.

As a method for forming an optical functional layer of the packaging member 22, for example, there may be mentioned a method in which a diffusive functional layer is formed by applying a resin material on the packaging member 22, followed by drying; a method in which when a film or a sheet to be formed into the packaging member 22 is formed, a single-layer or a multilayer film or sheet is formed by extrusion molding or co-extrusion molding so that diffusive particles are contained in a resin material or voids are formed therein; a method in which a diffusive functional layer, a condensation functional layer such as a lens, or a light source division functional layer having an arbitrary shape is formed by transferring a predetermined shape to a resin material such as an ultraviolet curable resin; a method in which when a contractive film is formed, a predetermined shape in which the contraction rate is taken into consideration in advance is transferred, and a contractive property is imparted by stretching; a method in which after a contractive film is formed, the above-described functional layer is transferred thereto by heat/pressure application; and a method in which minute holes are formed in a film mechanically or by a thermal machining using a laser or the like.

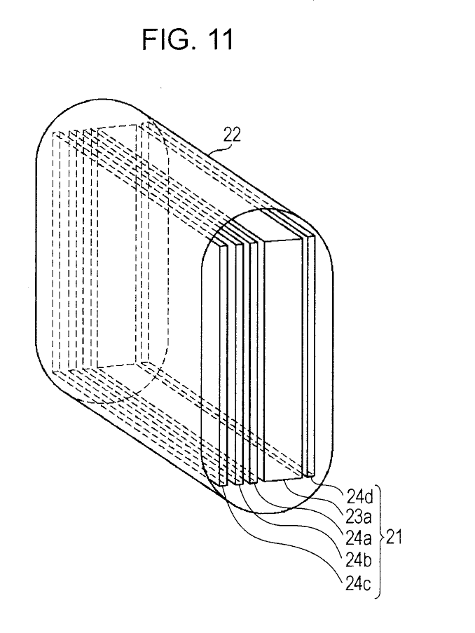

FIG. 10 shows one structure example of a backlight according to the fourth embodiment of the present invention. As shown in FIG. 10, from the lighting device 1 toward the liquid crystal panel 4, for example, the diffusion plate 23a, diffusion film 24a, the lens film 24b, and the reflection type polarizer 24c are provided in this order. In addition, the diffusion plate 23a is wrapped with the packaging member 22, and at an incident side portion of the inside surface of the packaging member 22, a structure 26 having an irregularity resolving function or the like is provided.

In this fourth embodiment, since the structure and the optical functional layer are provided on at least one of the inside surface and the outside surface of the packaging member 22, the number of optical elements wrapped with the packaging member 22 can be decreased. Hence, the thickness of the optical element package 2 and that of the liquid crystal display device can be further decreased.

### (5) Fifth Embodiment

The packaging member 22 has, for example, a belt shape, and end surfaces thereof in a longitudinal direction are preferably bonded to each other on an end surface of the optical element laminate 21. Alternatively, the packaging member 22 has a seamless cylindrical shape. Hereinafter, in the case in which the primary surface of the optical element laminate 21 has a rectangular shape having a different longitudinal/lateral ratio, the structure of the optical element package 2 will be descried.

### [Structure of Optical Element Package]

### (First Example)

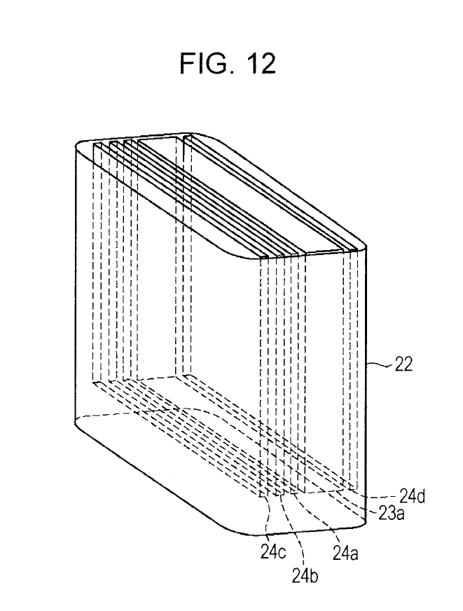

FIG. 11 shows a first structural example of an optical element package according to a fifth embodiment of the present invention. As shown in FIG. 11, the incident surface, the emission surface, and the two end surfaces along the long-side side of the optical element laminate 21 are wrapped with the belt-shaped packaging member 22, and the two end surfaces of the optical element laminate 21 along the short-side side are exposed. The two end portions of the belt-shaped packaging member 22 in the longitudinal direction are bonded to each other, for example, at one end surface of the optical element laminate 21 at the long-side side.

### (Second Example)

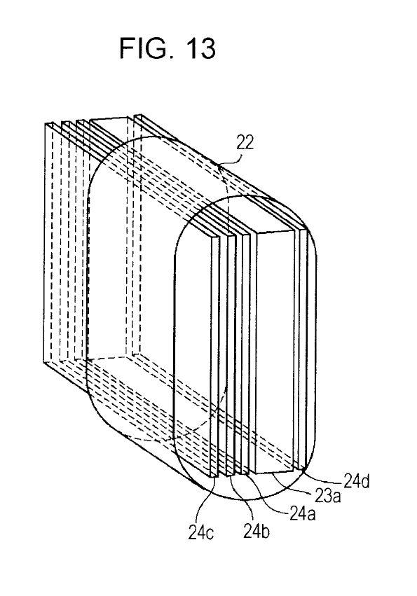

FIG. 12 shows a second structural example of the optical element package according to the fifth embodiment of the present invention. As shown in FIG. 12, the incident surface, the emission surface, and the two end surfaces along the short-side side of the optical element laminate 21 are wrapped with the belt-shaped packaging member 22, and the two end surfaces of the optical element laminate 21 along the long-side side are exposed. The two end portions of the belt-shaped packaging member 22 in the longitudinal direction are bonded to each other at one end surface of the optical element laminate 21 at the short-side side.

### (Third Example)

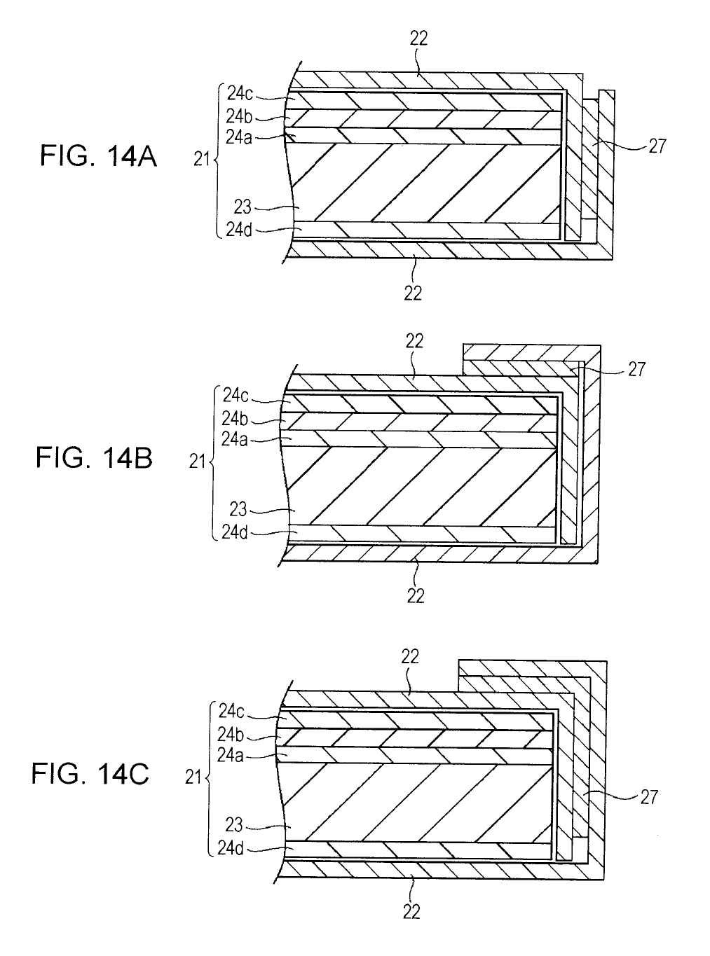

FIG. 13 shows a third structural example of the optical element package according to the fifth embodiment of the present invention. As shown in FIG. 13, a central portion of the optical element laminate 21 and the vicinity thereof are wrapped with the belt-shaped packaging member 22, and the two end portions of the optical element laminate 21 at the short-side side are exposed. The two end portions of the belt-shaped packaging member 22 in the longitudinal direction are bonded to each other, for example, at one end surface of the optical element laminate 21 at the long-side side.

### [Bond Portion of Packaging Member]

### (First Example)

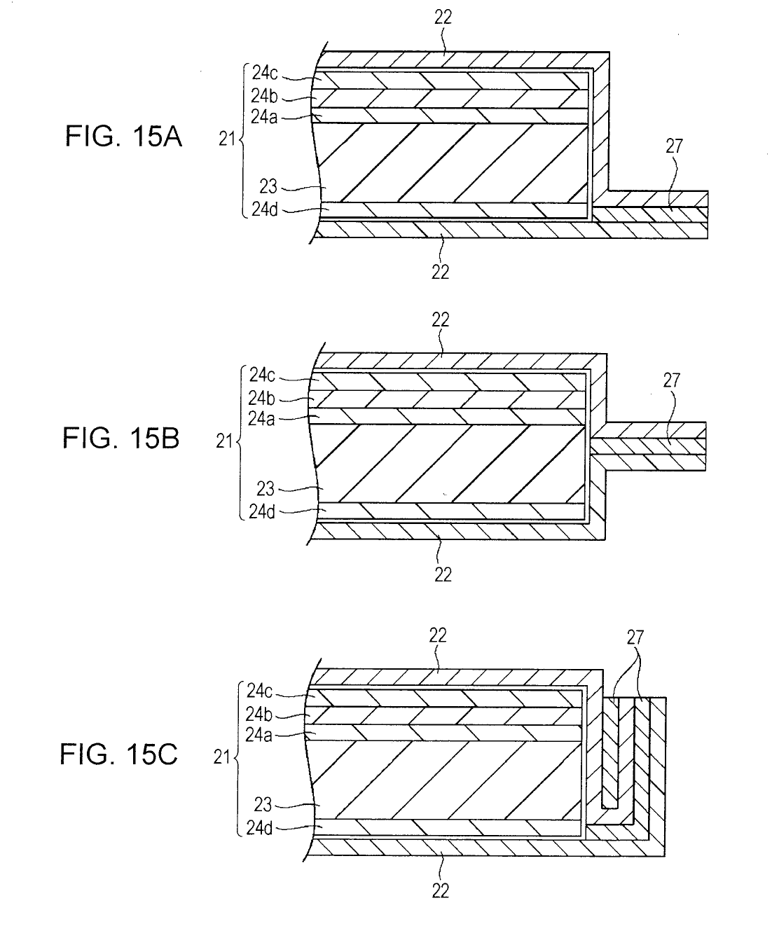

FIG. 14A shows a first example of the bond portion of the packaging member. As shown in FIG. 14A, at one end surface of the optical element laminate 21, the outside surface of the end portion of the packaging member 22 covering the first primary surface of the optical element laminate 21 and the inside surface of the end portion of the packaging member 22 covering the second primary surface are bonded to each other. Accordingly, the end portions of the packaging member 22 covering the two primary surfaces are bonded to each other along the end surface of the optical element laminate 21. In addition, a bond portion 27 indicates a bonding position of the packaging member 22. In the following description, as in the case described above, the bond portion 27 also indicates the bonding position of the packaging member 22.

In particular, after the whole one end surface of the optical element laminate 21 is covered with the end portion of the packaging member 22 covering the first primary surface, the whole one end surface of the optical element laminate 21 is further covered with the end portion of the packaging member 22 covering the second primary surface, so that the end portions of the packaging member 22 are overlapped with each other. The portions thus overlapped are partly or entirely bonded to each other.

A bonding mode is not particularly limited, and any one of point bonding, line bonding, and surface bonding may be used. In this example, the bonding indicates adhesion, welding, or the like, and the adhesion also includes tacky adhesion. For the adhesion, for example, an adhesive layer primarily composed of an adhesive is used. In this case, a tacky agent is also included in the adhesive. In addition, besides direct welding between the end portions, the welding conceptionally includes the case in which the end portions are indirectly bonded to each other with another member (welding layer) interposed therebetween.

When the packaging member 22 and the support member 23 are bonded to each other by welding, as materials for the packaging member 22 and the support member 23, a material having superior weldability is preferably selected. For example, as the materials for the packaging member 22 and the support member 23, similar type materials are preferably used. In addition, in order to suppress the degradation of display characteristics, the bond portion between the packaging member 22 and the support member 23 preferably has transparent properties. As a combination of the support member 23/the packaging member 22 having transparent properties, for example, a polycarbonate support member/a polycarbonate packaging member, a polystyrene support member/a polystyrene packaging member, a polyolefinic support member/a polyolefinic packaging member may be mentioned.

When the packaging member 22 and the support member 23 are formed of materials which cannot be bonded to each other by welding and adhesion, the packaging member 22 and the support member 23 may be bonded to each other by a mechanical bonding method. As the mechanical bonding method, for example, a caulk, an insertion, and a sandwich bonding method may be used.

### (Second Example)

FIG. 14B shows a second example of the bond portion of the packaging member. As shown in FIG. 14B, at the periphery of the first primary surface of the optical element laminate 21, the outside surface in the vicinity of the end portion of the packaging member 22 covering the first primary surface of the optical element laminate 21 and the inside surface of the end portion of the packaging member 22 covering the second primary surface are bonded to each other.

In particular, after the whole one end surface of the optical element laminate 21 is covered with the end portion of the packaging member 22 covering the first primary surface, the optical element laminate 21 from the whole one end surface to the periphery of the first primary surface is further covered with the end portion of the packaging member 22 covering the second primary surface, so that the end portions of the packaging member 22 are overlapped with each other. The portions thus overlapped are partly or entirely bonded to each other.

### (Third Example)

FIG. 14C shows a third example of the bond portion of the packaging member. As shown in FIG. 14C, in this third example, at the end surface of the optical element laminate 21, the outside surface of the end portion of the packaging member 22 covering the first primary surface of the optical element laminate 21 and the inside surface of the end portion of the packaging member 22 covering the second primary surface are further bonded to each other, and this is a point different from that of the second example.

### (Fourth Example)

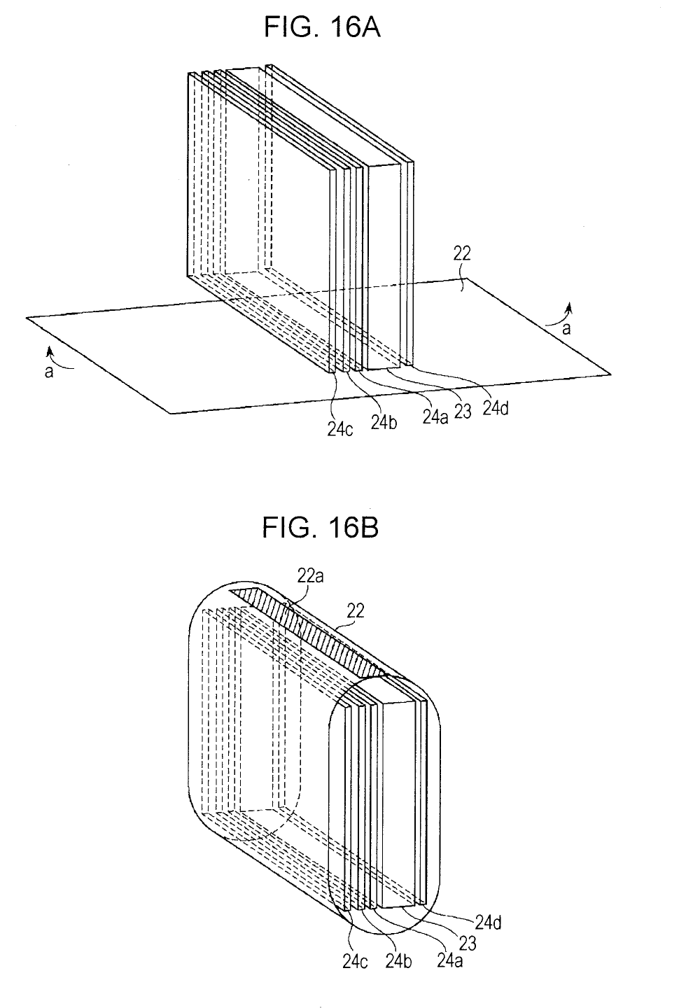

FIG. 15A shows a fourth example of the bond portion of the packaging member. As shown in FIG. 15A, at a corner portion of the optical element laminate 21, the inside surface of the end portion of the packaging member 22 covering the first primary surface of the optical element laminate 21 and the inside surface of the end portion of the packaging member 22 covering the second primary surface are bonded to each other. Accordingly, the end portions of the packaging member 22 covering the two primary surfaces are bonded to each other at the corner portion of the optical element laminate 21 so as to stand erect from the end surface of the optical element laminate 21.

### (Fifth Example)

FIG. 15B shows a fifth example of the bond portion of the packaging member. As shown in FIG. 15B, in this fifth example, at an approximately center of the end surface of the optical element laminate 21, the end portions of the packaging member 22 covering the two primary surfaces are bonded to each other, and this is a point different from that of the fourth example.

### (Sixth Example)

FIG. 15C shows a sixth example of the bond portion of the packaging member. As shown in FIG. 15C, in this sixth example, the bond portion which stands erect from the end surface of the optical element laminate 21 is bent and is further bonded to the end surface of the optical element laminate 21, and this is a point different from that of the fourth example.

### [Method for Manufacturing Optical Element Package]

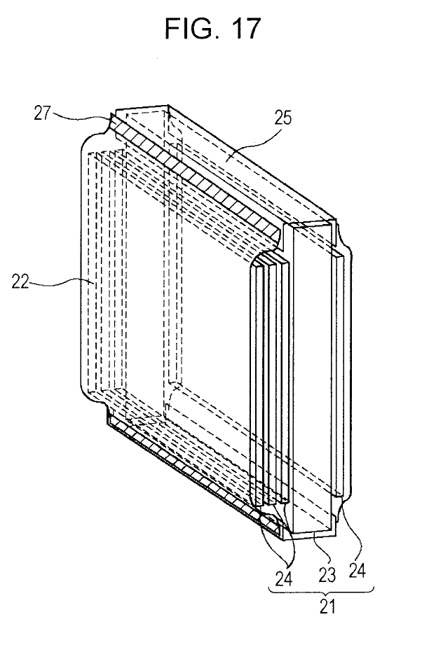

Next, one example of a method for manufacturing an optical element package 2 having the above-described structure will be described. First, as shown in FIG. 16A, at least one optical element 24 and the support member 23 overlapped with each other is placed, for example, on the belt-shaped packaging member 22. Next, as shown by arrows a in FIG. 16A, for example, the two end portions of the belt-shaped packaging member 22 in the longitudinal direction are lifted up, and the at least one optical element 24 and the support member 23 overlapped with each other are wrapped with the packaging member 22. Subsequently, as shown in FIG. 16B, for example, the end portions of the packaging member 22 in the longitudinal direction are bonded to each other at one end surface of the at least one optical element 24 or the support member 23. As a bonding method, for example, adhesion using an adhesive or by welding may be mentioned. As an adhesion method by an adhesive, for example, a hot-melt type adhesion method, a thermosetting type adhesion method, a pressure-sensitive (tacky) type adhesion method, an energy-ray curable type adhesion method, a hydration type adhesion method, or a moisture-absorbing•re-moisturizing type adhesion method may be mentioned. As an adhesion method by welding, for example, thermal welding, ultrasonic welding, or laser welding may be mentioned. Subsequently, whenever necessary, by applying heat to the packaging member 22, the packaging member 22 may be heat-contracted.

As another method for manufacturing the optical element package 2, the at least one optical element 24 and the support member 23 overlapped with each other are inserted into a cylindrical packaging member 22. Subsequently, whenever necessary, by applying heat to the packaging member 22, the packaging member 22 may be heat-contracted. As a result, a targeted optical element package 2 can be obtained.

### Sixth Embodiment

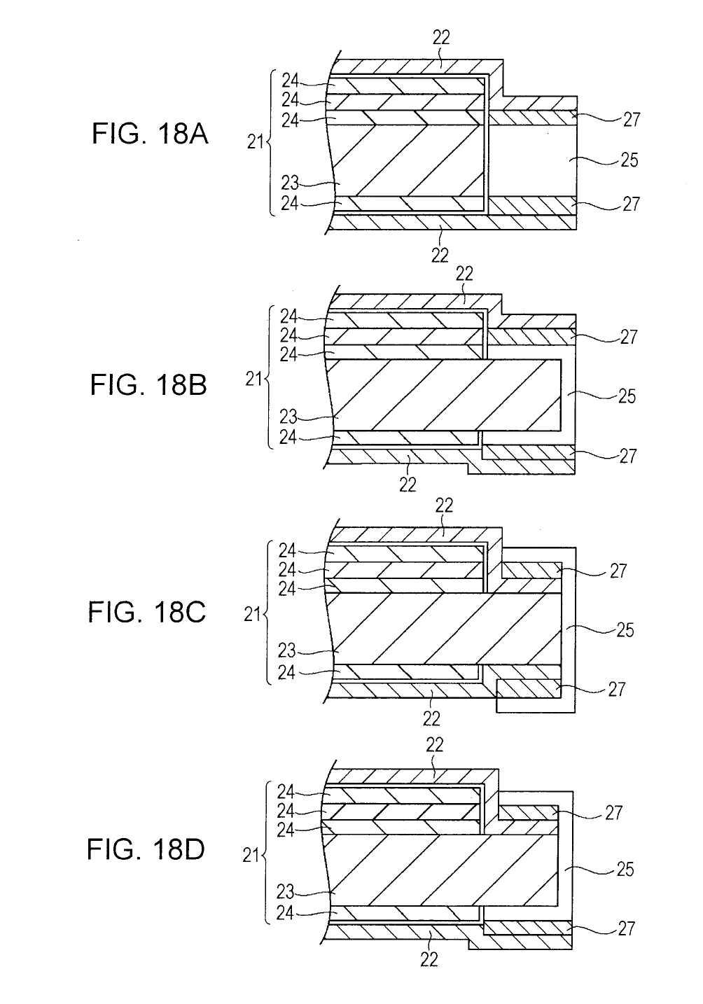

FIG. 17 shows one structural example of an optical element package according to a sixth embodiment. In this sixth embodiment, after a bonding member 25 is partly or entirely provided on the periphery of the optical element laminate 21, a packaging member 22 covering the first primary surface and a packaging member 22 covering the second primary surface are bonded to this bonding member 25, and this is a point different from that of the first embodiment.

The bonding member 25 has, for example, a film, a sheet, a plate, or a block shape. In addition, as the entire shape of the bonding member 25, for example, a long and thin rectangular shape or a frame shape may be mentioned. As the frame shape, for example, a frame shape covering three or four sides of the optical element laminate 21 may be mentioned. As a material for the bonding member, for example, a high molecular weight material or an inorganic material may be used. In addition, for the bonding member 25, besides a material having transparent properties, a material having opaque properties may also be used. As the high molecular weight material, for example, a material similar to that for the packaging member 22, the support member 23, or the optical element 24 may be used. As the inorganic material, for example, a metal or glass may be used. The packaging members 22 bonded by the boding member 25 have, for example, a cylindrical or a bag shape.

The bonding member 25 preferably has an optical function. As the optical function, the bonding member 25 preferably has a reflection function. The reason for this is that by the function described above, light leakage from the end surface of the optical element laminate 21 can be suppressed, and the luminance of the liquid crystal display device can be improved.

The bonding member 25 preferably has a heat contractive property or a stretch property. Since the bonding member 25 has a heat contractive property, in a manufacturing process of the optical element package, when only the bonding member 25 is contracted by heating, the optical element laminate 21 and the packaging member 22 can be brought into close contact with each other. That is, damage done to the optical element laminate 21 caused by heating can be suppressed. In addition, since the bonding member 25 has a stretch property, the optical element package 2 can be formed as described below. First, after the end portions of the packaging members 22 are bonded by the bonding member 25 so as to form a cylindrical shape or the like, the bonding member 25 is stretched, and the optical element laminate 21 is included in the packaging member 22. Subsequently, the stretch of the bonding member 25 is released, so that the bonding member 25 is contracted. As a result, the optical element laminate 21 can be wrapped with the packaging member 22. When the optical element package 2 is formed as described above, since a step of heating the packaging member 22 is not required in the manufacturing process, the degradation of characteristics of the optical element laminate 21 caused by heating does not occur.

### [Bond Portion of Packaging Member]

### (First Example)

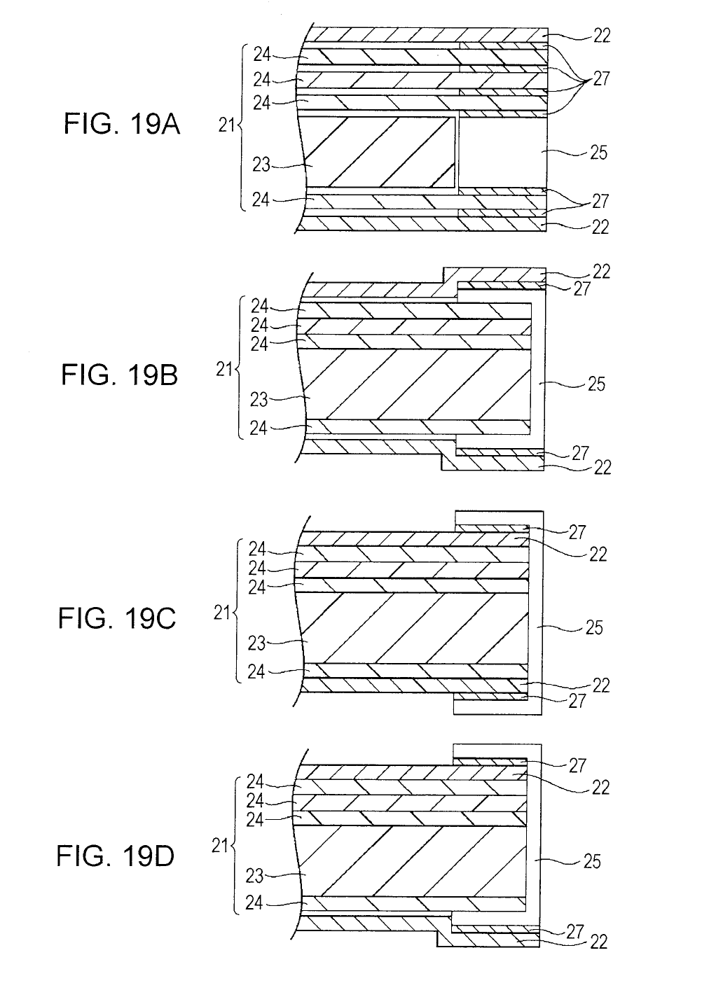

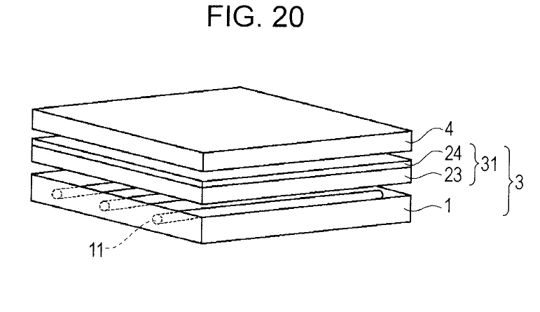

FIG. 18A shows a first example of the bond portion of the packaging member. As shown in FIG. 18A, the plate-shaped bonding member 25 is disposed at the periphery of the optical element laminate 21. To the respective two surfaces of this bonding member 25, the end portion of the packaging member 22 covering the first primary surface of the optical element laminate 21 and the end portion of the packaging member 22 covering the second primary surface are bonded. In addition, in FIGS. 18A to 18D and FIGS. 19A to 19D, reference symbol 27 indicates the bond portion.

### (Second Example)

FIG. 18B shows a second example of the bond portion of the packaging member. As shown in FIG. 18B, the bonding member 25 having an approximately U-shaped cross section is disposed at the periphery of the optical element laminate 21. This bonding member 25 covers the end surface of the support member 23 and the peripheries of the two primary surfaces thereof. At the periphery of the first primary surface of the support member 23, an outside surface of the bonding member 25 and the inside surface of the end portion of the packaging member 22 are bonded to each other. At the periphery of the second primary surface of the support member 23, the outside surface of the bonding member 25 and the inside surface of the end portion of the packaging member 22 are bonded to each other. In this example, an inside surface of the bonding member 25 indicates a surface facing the primary surface of the support member 23. In addition, the outside surface of the bonding member 25 indicates a surface opposite to the inside surface described above.

### (Third Example)

FIG. 18C shows a third example of the bond portion of the packaging member. As shown in FIG. 18C, at each of the peripheries of the two primary surfaces of the support member 23, the inside surface of the end portion of the bonding member 25 and the outside surface of the end portion of the packaging member 22 are bonded to each other, and this is a point different from that of the second example.

### (Fourth Example)

FIG. 18D shows a fourth example of the bond portion of the packaging member. As shown in FIG. 18D, at the periphery of the first primary surface of the support member 23, the inside surface of the bonding member 25 and the outside surface of the end portion of the packaging member 22 are bonded to each other. On the other hand, at the periphery of the second primary surface of the support member 23, the outside surface of the bonding member 25 and the inside surface of the end portion of the packaging member 22 are bonded to each other. This fourth example is the same as the second example except for the point described above.

### (Fifth Example)

FIG. 19A shows a fifth example of the bond portion of the packaging member. As shown in FIG. 19A, the plate-shaped bonding member 25 is disposed at the periphery of the support member 23. To the respective two surfaces of this bonding member 25, the peripheries of the optical elements 24 laminated on the two primary surfaces of the support member 23 are bonded. When at least two optical elements 24 are laminated on the two primary surfaces of the support member 23, the peripheries of the laminated optical elements 24 are bonded to each other. To the periphery of each topmost optical element 24, the periphery of the packaging member 22 is bonded.

### (Sixth Example)

FIG. 19B shows a sixth example of the bond portion of the packaging member. As shown in FIG. 19B, in this sixth example, the bonding member 25 covers the end surface of the optical element laminate 21 and the peripheries of the two primary surfaces thereof, and this is a point different from that of the second example.

### (Seventh Example)

FIG. 19C shows a seventh example of the bond portion of the packaging member. As shown in FIG. 19C, in this seventh example, at each of the peripheries of the two primary surfaces of the optical element laminate 21, the inside surface of the end portion of the bonding member 25 and the outside surface of the end portion of the packaging member 22 are bonded to each other, and this is a point different from that of the sixth example.

### (Eighth Example)

FIG. 19D shows an eighth example of the bond portion of the packaging member. As shown in FIG. 19D, at the periphery of the first primary surface of the optical element laminate 21, the inside surface of the bonding member 25 and the outside surface of the end portion of the packaging member 22 are bonded to each other. On the other hand, at the periphery of the second primary surface of the optical element laminate 21, the outside surface of the bonding member 25 and the inside surface of the end portion of the packaging member 22 are bonded to each other. This eighth example is the same as the sixth example except for the point described above.

### (7) Seventh Embodiment

### (7-1) Structure of Liquid Crystal Display Device

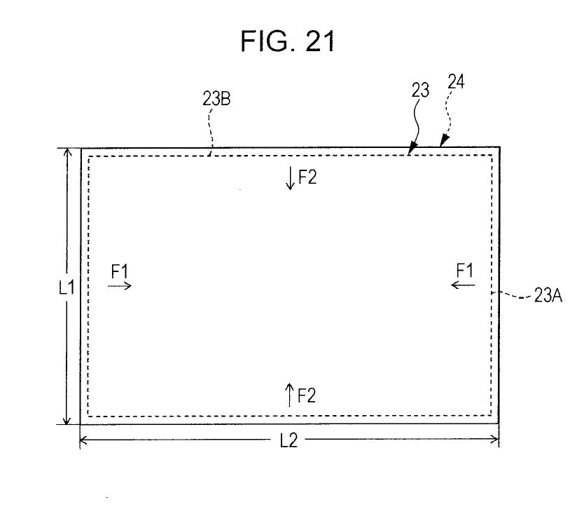

FIG. 20 shows one structural example of a liquid crystal display device according to a seventh embodiment of the present invention. This liquid crystal display device includes an optical element laminate 31 instead of the optical element package 2, and this is a point different from that of the first embodiment. In addition, portions similar to those in the above first embodiment are designated by the same symbols, and a description thereof is omitted.

### [Optical Element Laminate]

The optical element laminate 31 includes the support member 23 and the optical element 24 laminated at the emission surface (first primary surface) side of this support member. In order to suppress the degradation of image, the optical element 24 and the support member 23 are preferably placed in close contact with each other.

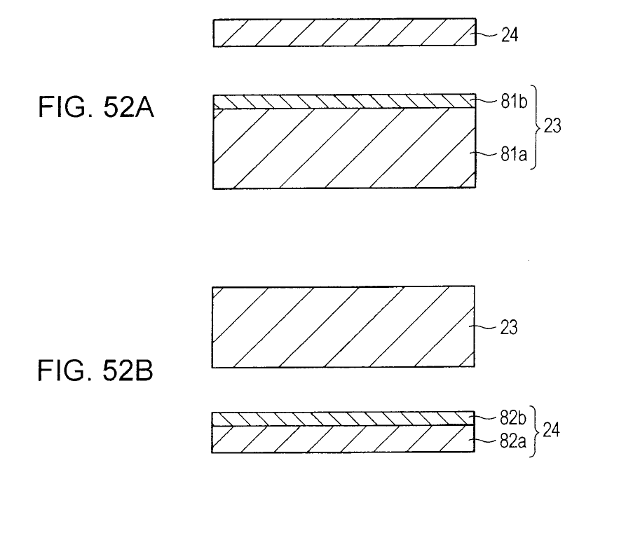

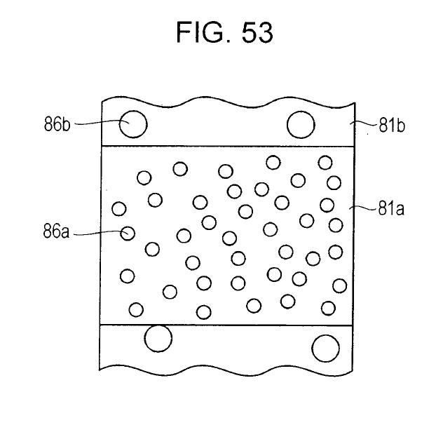

The optical element 24 preferably has a contractive property or a stretch property. The reason for this is that, by the above property, a tension can be applied to the optical element 24 bonded to the support member 23, and that the optical element 24 and the support member 23 can be placed in close contact with each other. In addition, when the optical element 24 has no contractive property or no stretch property, a tensile force may be mechanically applied as in the case of a method for manufacturing an optical element laminate (FIGS. 50 and 51) according to a fifteenth embodiment which will be described later. The optical element 24 is bonded to at least one of the emission surface and the end surface of the support member 23. When a rectangular optical element 24 is bonded to the emission surface of a rectangular support member 23, the optical element 24 is at least bonded to facing two sides of the periphery of the support member 23. In particular, the optical element 24 is bonded to facing two sides, three sides, or the four sides of the periphery of the support member 23.

A bonding mode is not particularly limited, and any one of point bonding, line bonding, and surface bonding may be used. In this embodiment, the bonding indicates adhesion, welding, or the like, and the adhesion also includes tacky adhesion. For the adhesion, for example, an adhesive layer primarily composed of an adhesive is used. In this case, a tacky agent is also included in the adhesive. In addition, besides direct welding between the end portions, the welding conceptionally includes the case in which the end portions are indirectly bonded to each other with another member (welding layer) interposed therebetween. As an adhesion method by an adhesive, for example, a hot-melt type adhesion method, a thermosetting type adhesion method, a pressure-sensitive (tacky) type adhesion method, an energy-ray curable type adhesion method, a hydration type adhesion method, or a moisture-absorbing•re-moisturizing type adhesion method may be mentioned. As an adhesion method by welding, for example, thermal welding, ultrasonic welding, or laser welding may be mentioned.

When the optical element 24 and the support member 23 are bonded to each other by welding, as materials for the optical element 24 and the support member 23, a material having superior weldability is preferably selected. For example, as the materials for the optical element 24 and the support member 23, similar type materials are preferably used. In addition, in order to suppress the degradation of display characteristics, the bond portion between the optical element 24 and the support member 23 preferably has transparent properties. As a combination of the support member 23/the optical element 24 having transparent properties, for example, a polycarbonate support member/a polycarbonate optical element, a polystyrene support member/a polystyrene optical element, a polyolefinic support member/a polyolefinic optical element may be mentioned.

When the optical element 24 and the support member 23 are formed of materials which cannot be bonded to each other by welding and adhesion, the optical element 24 and the support member 23 may be bonded to each other by a mechanical bonding method. As the mechanical bonding method, for example, a caulk, an insertion, and a sandwich bonding method may be used.

### [Tensile Force Acting on Optical Element]

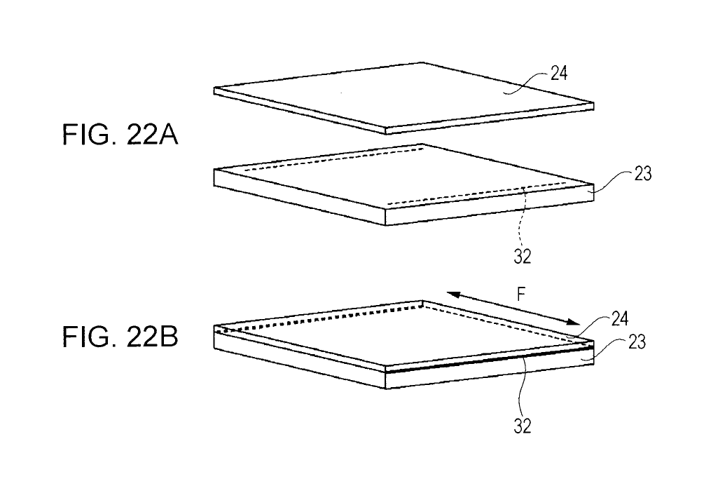

FIG. 21 is a schematic plan view showing the relationship between individual sides of the support member 23 and tensile forces F of the optical element 24 acting in directions perpendicular to the individual sides. The support member 23 has a rectangular primary surface. The rectangular primary surface is formed of first sides 23A and 23A facing each other and second sides 23B and 23B which are perpendicular to the first sides and which face each other. A thickness t of the support member 23, lengths L1 and L2 of the first side 23A and the second side 23B of the support member 23, and tensile forces F2 and F1 of the optical element 24 acting parallel to the first side 23A and second side 23B, respectively, satisfy the following relational expressions (2) and (3) at a temperature of 70° C.

0≦F1≦1.65×10⁴×t/L2 (2)

0≦F2≦1.65×10⁴×t/L1 (3)

When these relational expressions are satisfied, image quality defects and the like caused by warping of the optical element laminate 31 can be reduced.

### [Bonding Position of Optical Element]

### (First Example)

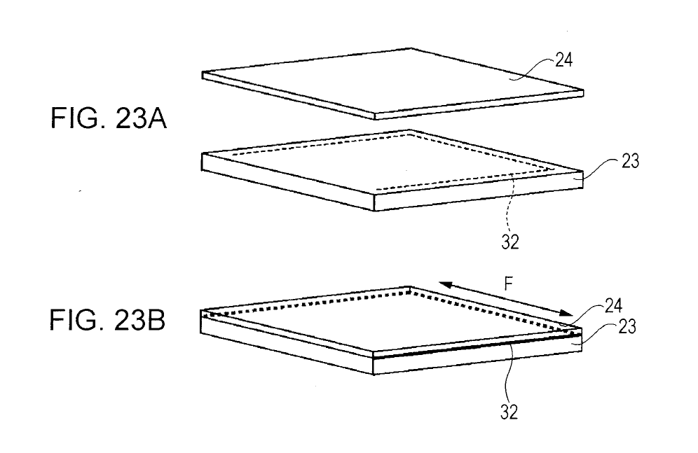

FIGS. 22A and 22B each show a first example of a bonding position of the optical element. In this first example, the periphery of the optical element 24 is bonded to facing two sides of the periphery of the emission surface (first primary surface) of the support member 23 having a rectangular shape. To the optical element 24, a tensile force F is applied in a direction perpendicular to the facing two sides of the support member 23 to which the optical element 24 is bonded.

### (Second Example)

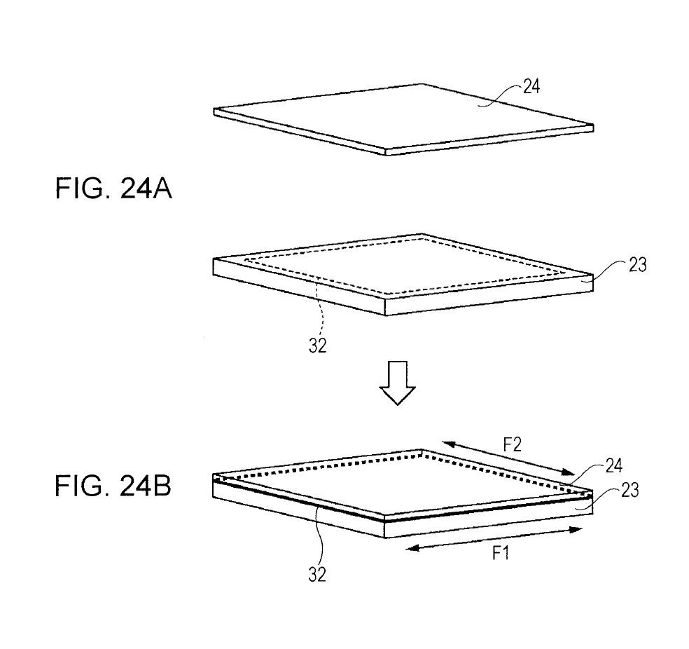

FIGS. 23A and 23B each show a second example of the bonding position of the optical element. In this second example, the periphery of the optical element 24 is bonded to three sides of the periphery of the emission surface (first primary surface) of the support member 23 having a rectangular shape. To the optical element 24, a tensile force F is applied in a direction perpendicular to the facing two sides of the support member 23 to which the optical element 24 is bonded.

### (Third Example)

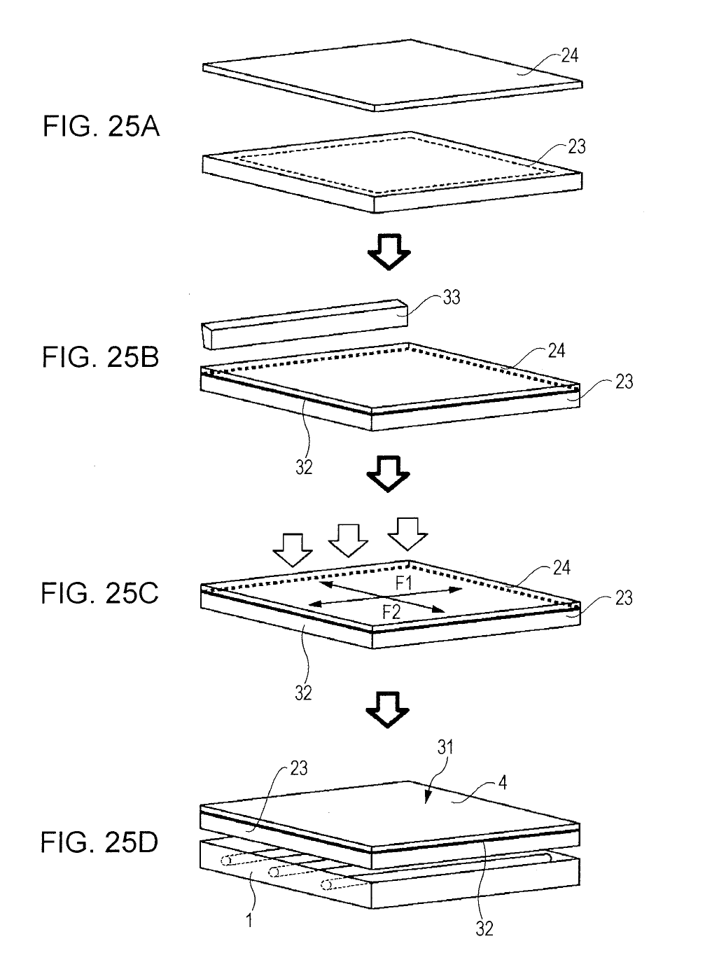

FIGS. 24A and 24B each show a third example of the bonding position of the optical element. In this third example, the periphery of the optical element 24 is bonded to all the four sides of the emission surface (first primary surface) of the support member 23 having a rectangular shape. To the optical element 24, the tensile forces F1 and F2 are applied in directions perpendicular to the respective facing two sides of the support member 23 to which the optical element 24 is bonded.

### (7-2) Method for Manufacturing Liquid Crystal Display Device

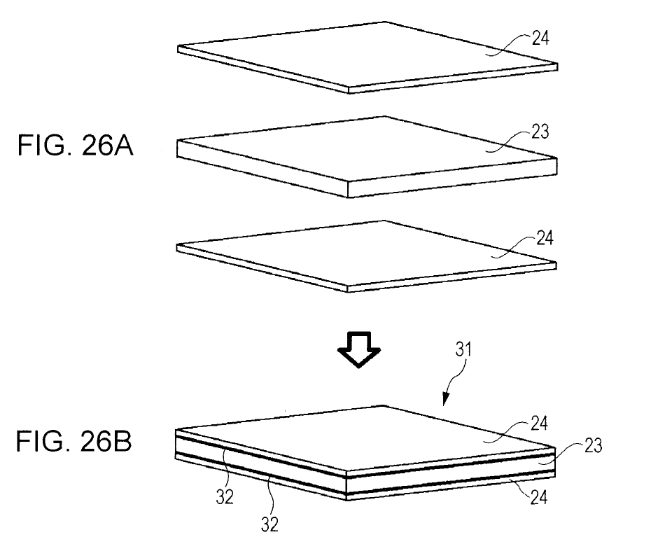

Next, with reference to FIGS. 25A to 25D, one example of a method for manufacturing a liquid crystal display device having the above-described structure will be described.

First, as shown in FIG. 25A, the support member 23 and the optical element 24, each having a rectangular shape, are prepared, and the optical element 24 is laminated on the support member 23. Next, as shown in FIG. 25B, a heater block formed of a metal, such as copper, is pressed to the optical element 24, so that the peripheral portion of the support member 23 and that of the optical element 24 are thermal-welded to each other. The positions of the thermal welding are facing two sides, three sides, or the four sides of each of the support member 23 and the optical element 24, each having a rectangular shape.

Next, as shown in FIG. 25C, a heat treatment is performed on the support member 23 and the optical element 24 bonded thereto by thermal welding, so that the optical element 24 is contracted. As a result, the tensile force F is applied to the optical element 24 in a direction perpendicular to the facing two sides among the sides bonded to the support member 23, and the support member 23 and the optical element 24 are brought into close contact with each other. Accordingly, the optical element laminate 31 can be obtained.

Next, the optical element laminate 31 and the liquid crystal panel are sequentially placed on the lighting device 1, and in addition, the placing positions are appropriately adjusted. Accordingly, as shown in FIG. 25D, the liquid crystal display device can be obtained. In addition, in this embodiment, although the optical element laminate 31 including the optical element 24 laminated at the emission surface (first primary surface) side of the support member 23 is described, the optical element 24 may be laminated only at the incident surface (second primary surface) side of the support member 23.

### (8) Eighth Embodiment

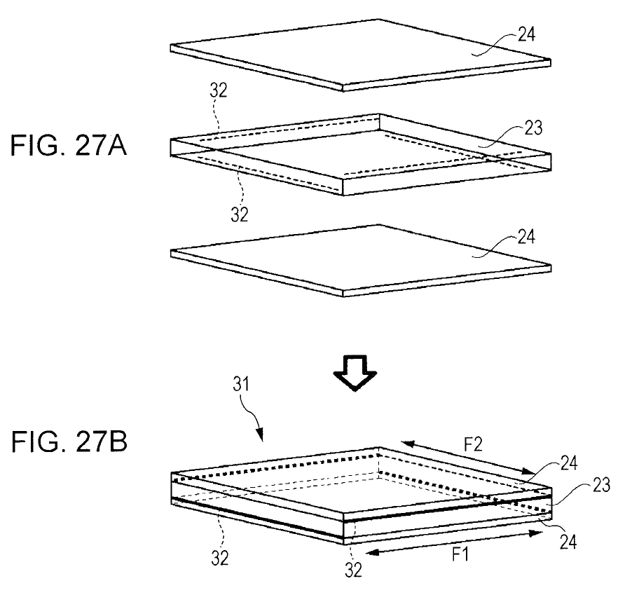

FIGS. 26A and 26B each show one structural example of an optical element laminate according to an eighth embodiment of the present invention. As shown in FIGS. 26A and 26B, this optical element laminate 31 includes the optical element 24 laminated on the incident surface (second primary surface) of the support member 23 as well as that laminated at the emission surface (first primary surface) side of the support member 23, and this is a point different from that of the seventh embodiment. In addition, portions similar to those in the above seventh embodiment are designated by the same symbols, and a description thereof is omitted.

The optical element 24 is bonded to at least one of the incident surface and the end surface of the support member 23. When being bonded to the incident surface of the rectangular support member 23, the rectangular optical element 24 is at least bonded to facing two sides of the periphery of the support member 23. In particular, the optical element 24 is bonded to facing two sides, three sides, or the four sides of the periphery of the support member 23. In order to suppress the degradation of image, the optical element 24 and the support member 23 are preferably placed in close contact with each other.

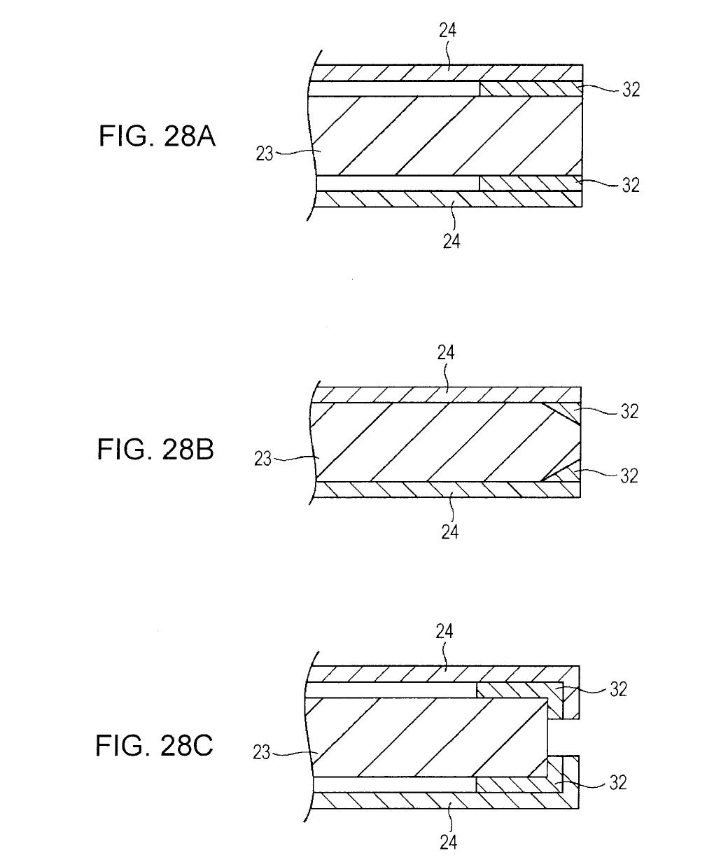

FIGS. 27A and 27B each show one example of bonding positions of the optical elements laminated on the respective two primary surfaces of the support member. As shown in FIGS. 27A and 27B, when the rectangular optical elements 24 are each bonded to facing two sides of the rectangular support member 23, for example, the optical elements 24 are bonded to different facing two sides at the two primary surfaces of the support member 23.

In this embodiment, in the optical element laminate 31 in which at least one layer film (optical element) is bonded to each of the two primary surfaces of the support member 23, a longitudinal/lateral ratio (MD/TD ratio) of a tension of the film on one surface and that of a tension of the film on the other surface are preferably orthogonal to each other. Accordingly, even when the thickness of the support member 23 is small and the rigidity thereof is low, by the front and rear tension balance, apparent rigidity can be increased, and hence this laminate can be used as the optical element laminate 31. In the case described above, the tension balance of MD/TD at one surface is preferably 5/95 to 49/51 or 51/49 to 95/5. In addition, the ratio of the TD tension at one surface to the MD tension at the other surface is preferably 30/70 to 70/30 and more preferably 40/60 to 60/40. As a result, the thickness of the support member 23 can be decreased, and for example, it can be decreased to 2 mm or less and preferably 1 mm or less.

### [Bond Portion of Packaging Member]

### (First Example)

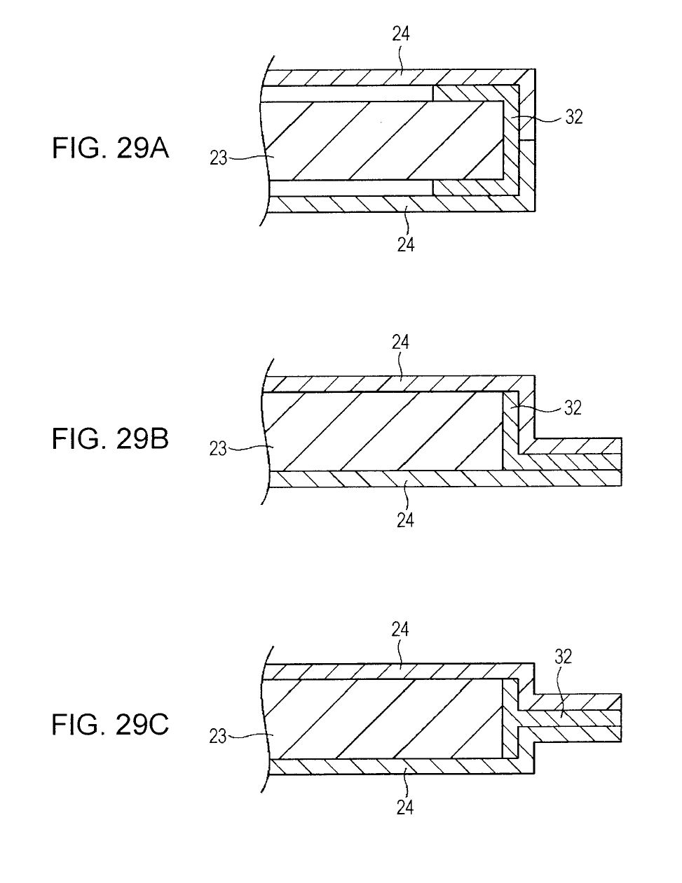

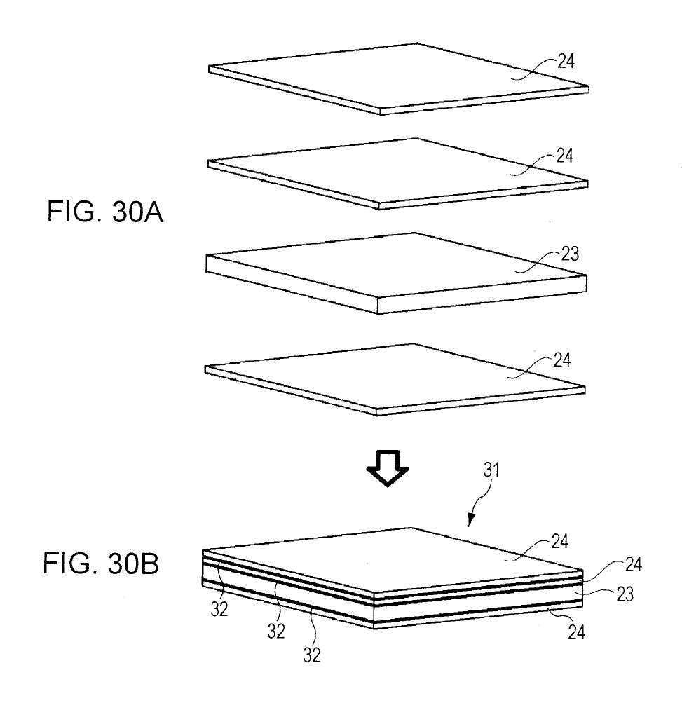

FIG. 28A shows one example of the bond portion of the optical element laminate. As shown in FIG. 28A, this optical element laminate 31 includes the support member 23, the optical element 24 laminated on the incident surface (second primary surface) of the support member 23, and the optical element 24 laminated on the emission surface (first primary surface) of the support member 23. The peripheries of the optical elements 24 laminated on the two surfaces are each bonded to the periphery of the support member 23. In addition, in FIGS. 28A to 28C and FIGS. 29A to 29C, reference symbol 32 indicates the bond portion.

### (Second Example)

FIG. 28B shows a second example of the bond portion of the optical element laminate. As shown in FIG. 28B, in this second example, the corners of the support member 23 are chamfered so that inclined surfaces are formed, and this is a point different from that of the first example. This chamfered inclined surface is, for example, a C surface or an R surface. An adhesive is filled between the inclined surfaces of this support member 23 and the optical elements 24 covering the incident surface and the emission surface of the support member 23. As a result, the periphery of the optical element 24 covering the incident surface of the support member 23 is bonded to the periphery of the support member 23.

### (Third Example)

FIG. 28C shows a third example of the bond portion of the optical element laminate. As shown in FIG. 28C, in this third example, the optical elements 24 laminated on the two primary surfaces of the support member 23 each have a sidewall portion at the periphery thereof, and this is a point different from that of the first example. This sidewall portion of the optical element 24 and the end surface of the support member 23 are preferably further bonded to each other. At the end surface of the support member 23, a space is formed between the sidewall portions of the optical elements 24 laminated on the respective two primary surfaces of the support member 23, and the end surface of the support member 23 is partly exposed.

### (Fourth Example)

FIG. 29A shows a fourth example of the bond portion of the optical element laminate. As shown in FIG. 29A, in this fourth example, at the end surface of the support member 23, the front ends of the sidewall portions of the optical elements 24 laminated respectively on the two primary surfaces of the support member 23 are brought into contact with each other so that the end surface of the support member 23 is not exposed, and this is a point different from that of the third example.

### (Fifth Example)

FIG. 29B shows a fifth example of the bond portion of the optical element laminate. As shown in FIG. 29B, the optical element 24 is bonded to the end surface of the support member 23, and this is a point different from that of the first example. The peripheries of the optical elements 24 laminated on the two primary surfaces of the support member 23 are bonded to each other. This bonding is, for example, a bonding between the inside surfaces of the optical elements 24. One of the optical elements 24 bonded to each other at the peripheral portions thereof is bonded to the end surface of the support member 23.

### (Sixth Example)

FIG. 29C shows a sixth example of the bond portion of the optical element laminate. As shown in FIG. 29C, the two optical elements 24 bonded at the peripheral portions thereof are bonded to the end surface of the support member 23, and this is a point different from that of the fifth example.

### (8) Ninth embodiment

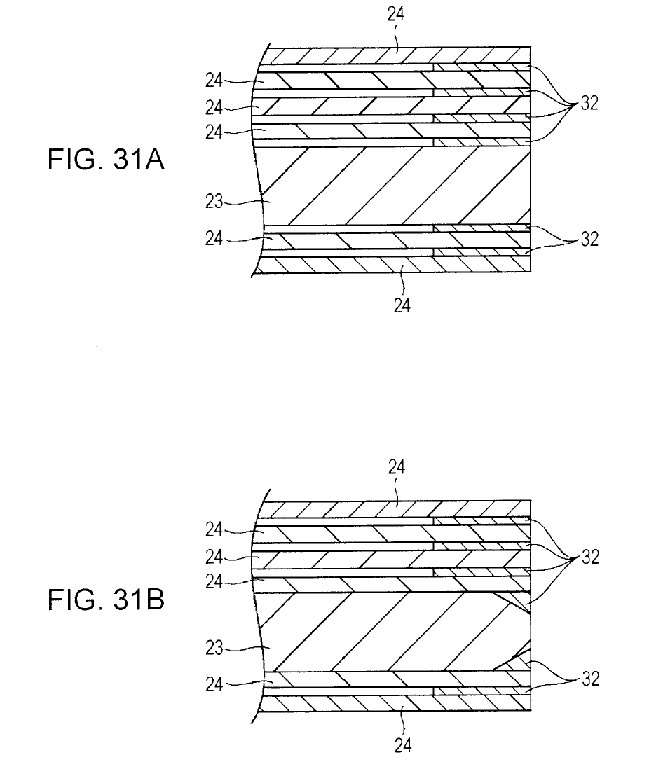

FIGS. 30A and 30B each show one structural example of an optical element laminate according to a ninth embodiment of the present invention. As shown in FIGS. 30A and 30B, in this optical element laminate 31, at least two optical elements 24 are laminated on at least one of the incident surface (second primary surface) and the emission surface (first primary surface) of the support member 23, and this is a point different form that of the eighth embodiment. In FIGS. 30A and 30B, an example in which at least two optical elements 24 are laminated on the emission surface (first primary surface) of the support member 23 and at least one optical element 24 is laminated on the incident surface (second primary surface) is shown.

The optical element 24 is bonded to the support member 23, for example, as described below. Among the at least two optical elements 24 thus laminated, the optical element 24 at the support member side is bonded to the support member 23. The at least two optical elements 24 thus laminated are bonded to each other at least at facing two sides thereof.

In addition, among the at least two optical elements 24 thus laminated, only the optical element 24 functioning as the topmost surface (front surface) may be bonded to the support member 23. In this case, in a receiving space formed between the optical element 24 functioning as the topmost surface and the support member 23, another optical element is disposed. In addition, when at least two optical elements 24 are provided on the incident surface, a method similar to that described above may also be used.

A thickness t of the support member 23, a side length L of the support member 23, and a total F of tensile forces acting respectively on the at least two optical elements 24 thus laminated preferably satisfy the following relational expression (1) in an environment at a temperature of 70° C.

0≦F≦1.65×10⁴×t/L (1)

(Where, in the expression (1), t, L, and F indicate the following.
t: a distance between the first primary surface and the second primary surface of the support member 23,
L: among sides forming a plane perpendicular to the thickness t, a length of the facing two sides to which the optical elements 24 are bonded, and
F: a total of the tensile forces of the optical elements acting in a direction parallel to a side having the length L.)

### [Bond Portion of Packaging Member]

### (First Example)

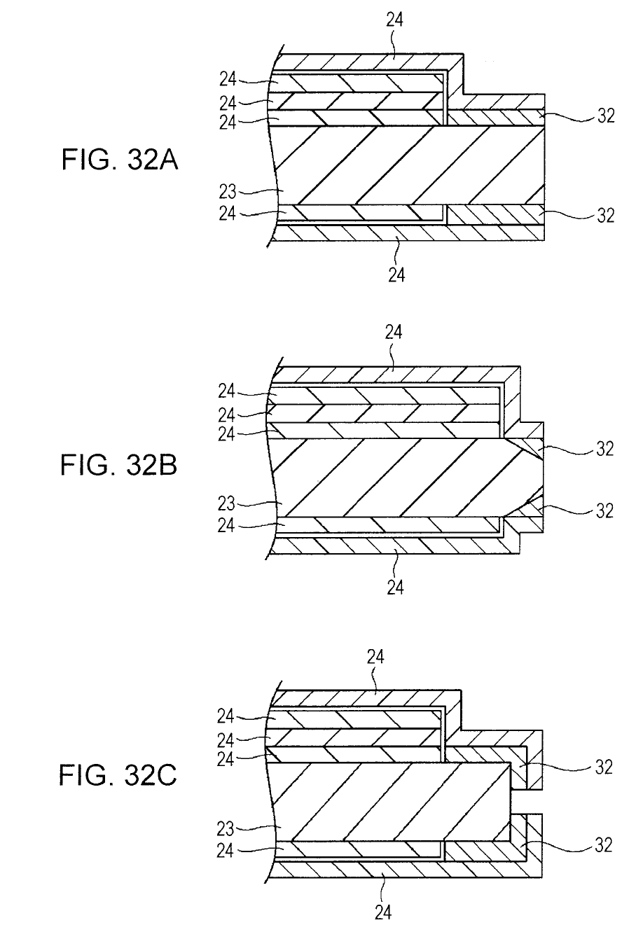

FIG. 31A shows one example of the bond portion of the optical element laminate. As shown in FIG. 31A, the optical elements 24 are bonded to the peripheries of the incident surface and the emission surface of the support member 23. The at least two optical elements 24 laminated on the incident surface and the emission surface of the support member 23 are bonded to each other at least at facing two sides thereof.

### (Second Example)

FIG. 31B shows a second example of the bond portion of the optical element laminate. As shown in FIG. 31B, in this second example, the corners of the support member 23 are chamfered so that inclined surfaces are formed, and this is a point different from that of the first example. This chamfered inclined surface is, for example, a C surface or an R surface. An adhesive is filled between the inclined surfaces of this support member 23 and the optical elements 24 covering the incident surface and the emission surface of the support member 23. As a result, the periphery of the optical element 24 covering the incident surface of the support member 23a is bonded to the periphery of the support member 23.

### (Third Example)

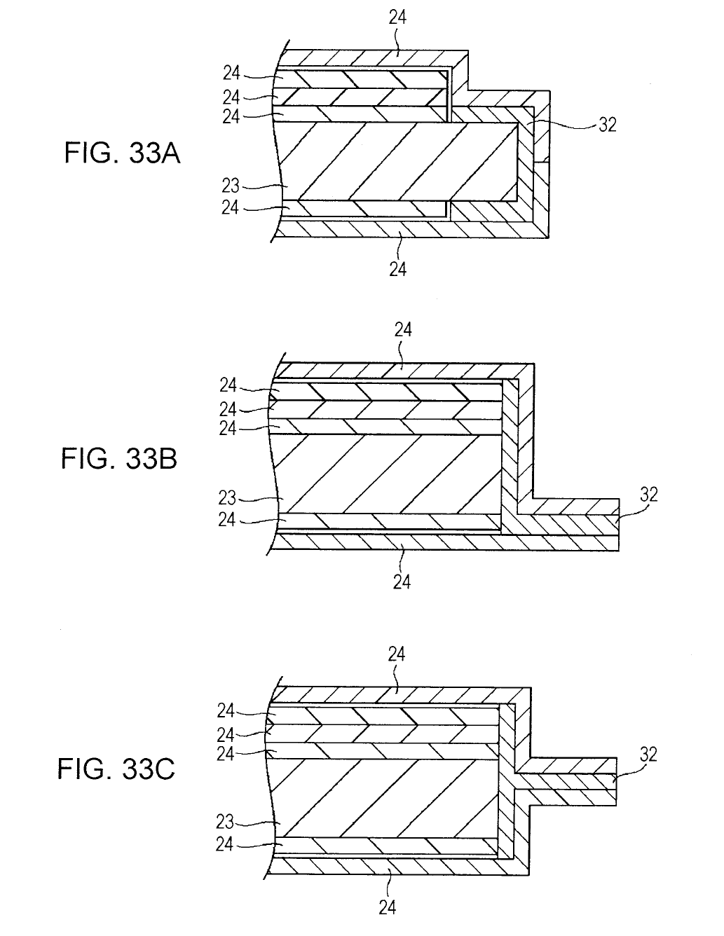

FIG. 32A shows a third example of the bond portion of the optical element laminate. As shown in FIG. 32A, in this third example, in receiving spaces formed between the optical elements 24 each functioning as the topmost surface and the incident surface and the emission surface of the support member 23, other optical elements are received, and this is a point different from that of the first example (FIG. 28A) of the eighth embodiment.

### (Fourth Example)

FIG. 32B shows a fourth example of the bond portion of the optical element laminate. As shown in FIG. 32B, in this fourth example, in receiving spaces formed between the optical elements 24 each functioning as the topmost surface and the incident surface and the emission surface of the support member 23, other optical elements are received, and this is a point different from that of the second example (FIG. 28B) of the eighth embodiment.

### (Fifth Example)

FIG. 32C shows a fifth example of the bond portion of the optical element laminate. As shown in FIG. 32C, in this fifth example, in receiving spaces formed between the optical elements 24 each functioning as the topmost surface and the incident surface and the emission surface of the support member 23, other optical elements are received, and this is a point different from that of the third example (FIG. 28C) of the eighth embodiment.

### (Sixth Example)

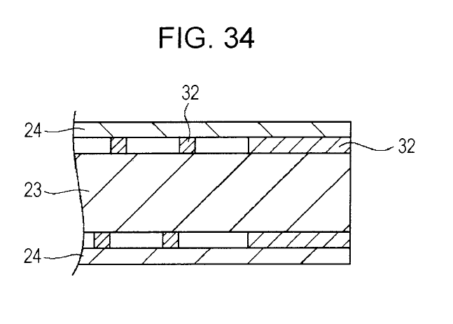

FIG. 33A shows a sixth example of the bond portion of the optical element laminate. As shown in FIG. 33A, in this sixth example, in receiving spaces formed between the optical elements 24 each functioning as the topmost surface and the incident surface and the emission surface of the support member 23, other optical elements are received, and this is a point different from that of the fourth example of the eighth embodiment.

### (Seventh Example)

FIG. 33B shows a seventh example of the bond portion of the optical element laminate. As shown in FIG. 33B, in this seventh example, in receiving spaces formed between the optical elements 24 each functioning as the topmost surface and the incident surface and the emission surface of the support member 23, other optical elements are received, and this is a point different from that of the fifth example of the eighth embodiment.

### (Eighth Example)

FIG. 33C shows an eighth example of the bond portion of the optical element laminate. As shown in FIG. 33C, in this eighth example, in receiving spaces formed between the optical elements 24 each functioning as the topmost surface and the incident surface and the emission surface of the support member 23, other optical elements are disposed, and this is a point different from that of the sixth example of the eighth embodiment.

### (10) Tenth Embodiment

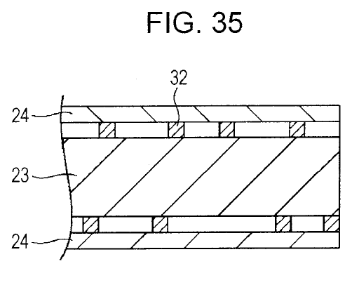

FIG. 34 shows one structural example of an optical element laminate according to a tenth embodiment of the present invention. As shown in FIG. 34, in this optical element laminate 31, the support member 23 is also bonded to the optical elements 24 at positions other than the peripheries thereof, and this is a point different from that of the eighth embodiment. In order to suppress the degradation of display characteristics, the bonding is preferably point bonding. In particular, the width of the bond portion is preferably less than 0.2 mm.

### (11) Eleventh Embodiment

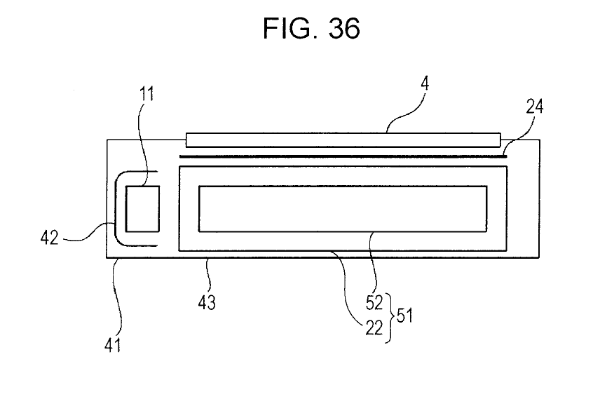

FIG. 35 shows one structural example of an optical element laminate according to an eleventh embodiment of the present invention. As shown in FIG. 35, in this optical element laminate 31, the optical elements 24 are point-bonded to the support member 23 in a region at least other than the display region, and this is a point different from that of the eighth embodiment. The optical element 24 may also be point-bonded to the support member 23 in all the regions of the incident surface and the emission surface thereof. In the case described above, a point bonding pattern may be any of a regular and an irregular pattern. In addition, the number of points for point bonding in the display region may be decreased as compared to that in a region other than the display region.

### (12) Twelfth Embodiment

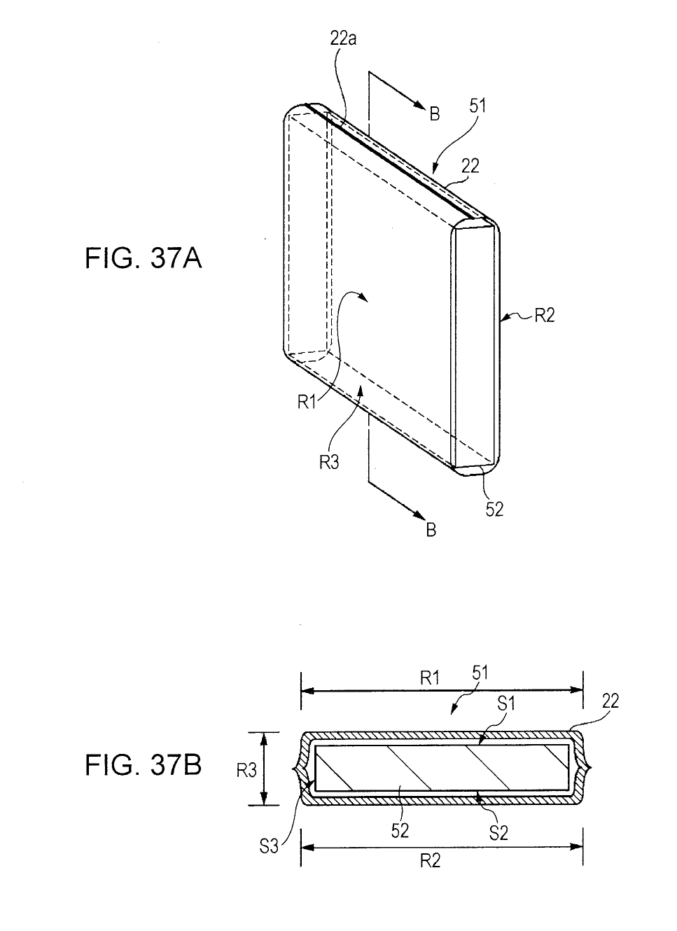

FIG. 36 shows one structural example of a liquid crystal display device according to a twelfth embodiment of the present invention. As shown in FIG. 36, this liquid crystal display device includes a side light type (also referred to as an edge light type) backlight 41, and this is a point different from that of the first embodiment. In addition, whenever necessary, at least one optical element 24 may be further provided between an optical element package 51 and the liquid crystal panel 4. Furthermore, whenever necessary, a reflector 42 covering the light source 11 may also be further provided.

### [Backlight]

The backlight 41 is a so-called side light type (also referred to as an edge light type) backlight unit and includes the optical element package 51, at least one light source 11 provided at one end of the optical element package 51, and a housing 43 receiving the optical element package 51 and the at least one light source 11.

### [Optical Element Package]

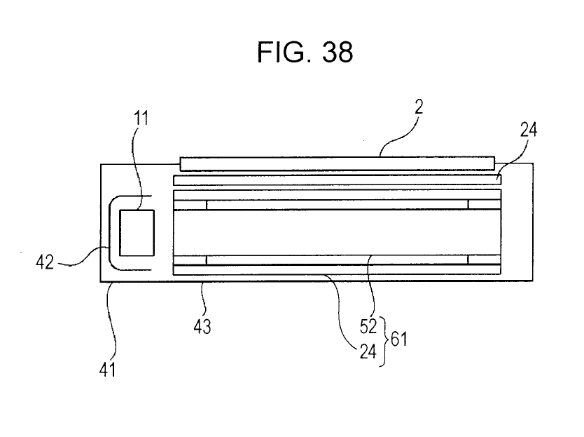

In FIGS. 37A and 37B, one structural example of the optical element package according to the twelfth embodiment of the present invention is shown. As shown in FIGS. 37A and 37b, the optical element package 51 includes, for example, a light guide plate 52 and the packaging member 22 wrapping this light guide plate 52. In order to suppress the degradation of image, the light guide plate 52 and the packaging member 22 are preferably placed in close contact with each other.

The optical element package 51 has a first primary surface facing the liquid crystal panel 4, a second primary surface opposite thereto, and end surfaces located between the first primary surface and the second primary surface. Light emitted from the light source 11 enters this optical element package 51 through one end thereof.

The light guide plate 52 has, for example, a flat plate shape, a tapered shape in which the thickness thereof is gradually decreased form one end at which the light source 11 is disposed to the other opposite end, or a wedge shape. As a material for the light guide plate 52, for example, a transparent plastic, such as a poly(methyl methacrylate) (PMMA), a polycarbonate (PC), a polystyrene (PS), a cycloolefinic resin (such as Zeonor (registered trade mark)) may be used.

The light guide plate 52 has a rectangular shape as a whole. That is, the light guide plate 52 includes a first primary surface S1 facing the liquid crystal panel 4, a second primary surface S2 opposite thereto, and end surfaces S3 located between the first primary surface S1 and the second primary surface S2. The packaging member 22 wraps, for example, the first primary surface S1, the second primary surface S2, and one pair of end surfaces S3 facing each other. For example, light emitted from the light source 11 enters through one of the pair of end surfaces S3. In addition, besides the structure in which light emitted from the light source 11 enters in a direction to the end surface S3, the structure may also be formed in which the light source 11 is embedded in the light guide plate 52 at the second primary surface S2 side, and light emitted from this light source 11 is propagated.

On the second primary surface S2 or the first primary surface S1 of the light guide plate 52, a dot pattern or an irregular structure, which functions to perform scatter reflection of light incident into the light guide plate, is formed. As a method for forming this dot-pattern, for example, a printing method in which reflective dots are printed using a white ink, a forming method in which irregularities are formed using a stamper or an ink jet, and a tacky dot method in which the light guide plate 52 and the packaging member 22 are adhered to each other by a dot-shaped tacky agent may be used. In addition, as a method for forming an irregular structure, for example, an injection molding method, a melt extrusion molding method, a thermal transfer forming method, or a method in which a sheet obtained by the aforementioned forming method is bonded to a rectangular base material may be used.

At least part of the packaging member 22 has a contractive property or a stretch property and also has an optical function. The packaging member 22 has a first region R1 covering the first primary surface S1 of the light guide plate 52, a second region R2 covering the second primary surface S2 of the light guide plate 52, and a third region R3 covering the end surfaces S3 of the light guide plate 52. The packaging member 22 has an optical function, for example, in at least one of the first region, the second region, and the third region, preferably in the first region and the second region, and more preferably in all the regions. As the optical function, for example, a light diffusion function, a light condensation function, a reflection type polarization function, a polarizer function, and a light division function may be mentioned. In addition, in each of the above-described regions, a plurality of optical functions may also be imparted. The packaging member 22 has an inside surface facing the light guide plate 52 and an outside surface opposite to this inside surface and is provided with an optical functional layer on at least one of the inside surface and the outside surface.

As the optical function of the first region R1, for example, at least one of a light diffusion function, a light condensation function, a polarization reflection function, a light conversion function, and the like may be used. As the optical function of the second region R2, for example, at least one of a diffusion function, a reflection function, a light source division function, a light conversion function, and the like may be used. As the optical function of the third region R3 on which light form the light source 11 is incident, for example, at least one of a diffusion function, an incidence assistant function, and the like may be used. As the optical function of the third region Rs other than the third region R3 on which light from the light source 11 is incident, for example, at least one of a diffusion function, a reflection function, and the like may be used. These optical functions may be obtained, for example, in such a way that a lens shape, an emboss shape, or the like is shape-transferred to a base material itself which forms the packaging member 22 or that fine particles or voids are contained in the base material itself. In addition, an optical functional layer may be formed on the base material which forms the packaging member 22. In particular, a surface layer having a lens shape or an emboss shape may be formed on the base material, or a surface layer containing fine particles or voids may be formed on the base material.

This twelfth embodiment is the same as the first embodiment except for that described above.

### (13) Thirteenth Embodiment

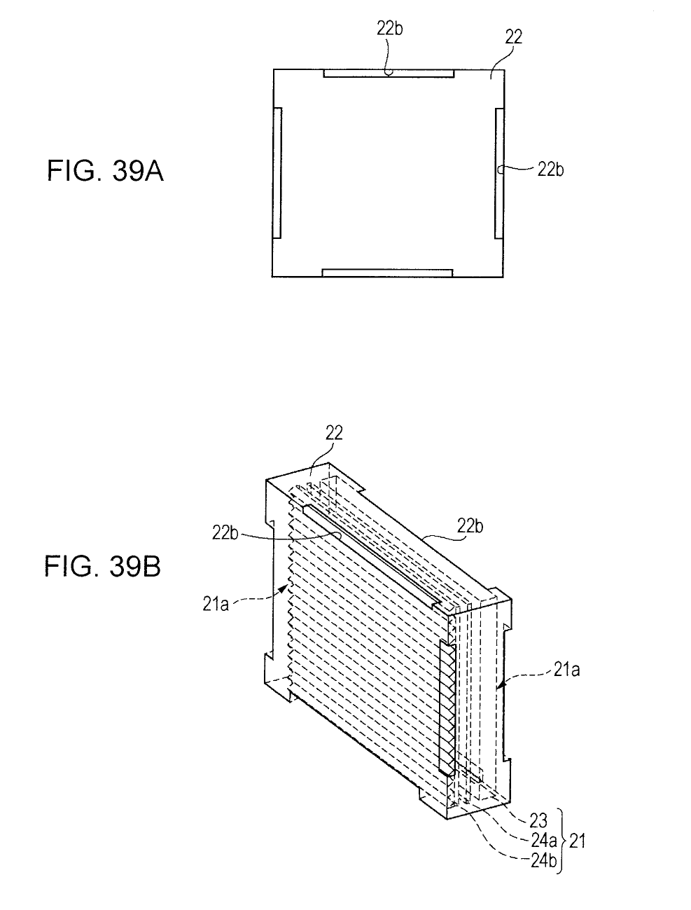

FIG. 38 shows one structural example of a liquid crystal display device according to a thirteenth embodiment of the present invention. As shown in FIG. 38, in this liquid crystal display device, instead of the optical element package, an optical element laminate 61 is included, and this is a point different from that of the twelfth embodiment.

The optical element laminate 61 is similar to that of one of the seventh to the eleventh embodiments except that the light guide plate 52 is used as the support member.

### (14) Fourteenth Embodiment

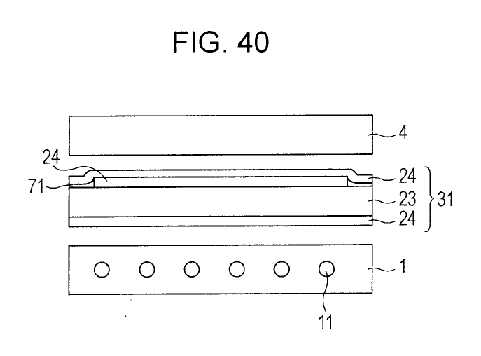

FIGS. 39A and 39B each show one structural example of an optical element package according to a fourteenth embodiment of the present invention. This optical element package 2 has opening portions 22b at positions corresponding to side portions 21a of the optical element laminate 21, and this is a point different from that of the first embodiment. As shown in FIGS. 39A and 39B, when the optical element laminate 21 has a rectangular shape as a whole, the opening portions 22b are preferably formed at positions corresponding to facing side portions 21a of the side portions 21a of the optical element laminate 21. In

FIGS. 39A and 39B, an example in which the opening portions 22b are formed at positions corresponding to all the side portions 21a of the optical element laminate 21 is shown. The size and the shape of the opening portion 22b are preferably selected in consideration of an air discharge performance in a process for forming the optical element package 2, the shape of the optical element laminate 21, the durability of the packaging member 22, and the like, and for example, a slit shape as shown in FIGS. 39A and 39B may be mentioned; however, the shape is not limited thereto, and the shape, such as a circular, an oval, a semicircular, a triangle, a square, or a diamond shape, may also be used.

### 15. Fifteenth Embodiment

### Structure of Optical Element Laminate

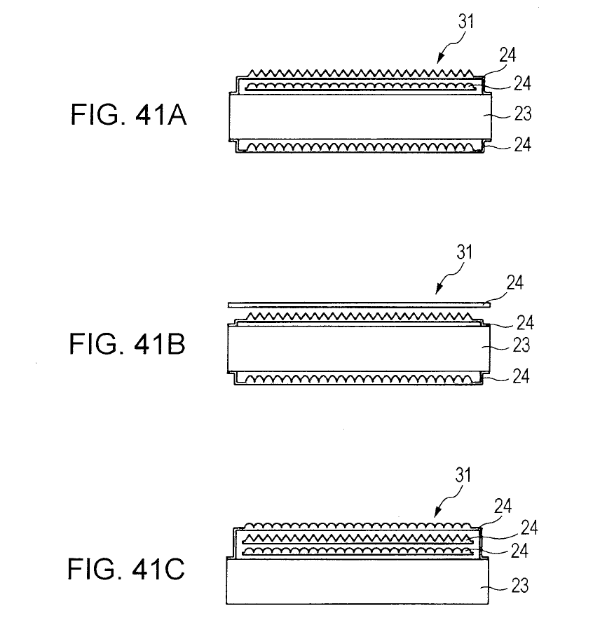

FIG. 40 shows one structural example of a liquid crystal display device according to a fifteenth embodiment of the present invention. In this liquid crystal display device, instead of the optical element package 2, the optical element laminate 31 is included, and this is a point different from that of the first embodiment. In addition, portions corresponding to those in the above first embodiment will be described by using the same symbols. In addition, since the structure other than the optical element laminate 31 is similar to that in the above first embodiment, a description thereof is omitted.

### [Optical Element Laminate]

The optical element laminate 31 includes the support member 23 and the optical element 24 laminated on the emission surface (first primary surface) or the incident surface (second primary surface) of the support member 23. The optical element 24 is bonded, for example, to at least one of the peripheral portion of the primary surface of the support member 23 and the end surfaces thereof and is placed in the state in which a tensile force is applied in an in-plane direction of the primary surface of the support member 23. However, in FIG. 40, an example in which the optical element 24 is bonded to the peripheral portion of the primary surface of the support member 23 is shown. The optical element laminate 31 includes a bonding layer 71 between the support member 23 and the optical element 24. A bonding optical element 24 is bonded to the peripheral portion of the primary surface of the support member 23 or the end surfaces thereof. In order to suppress the degradation of image, the tensile force is preferably applied to the optical element 24 so that the optical element 24 and the support member 23 are placed in close contact with each other. Whenever necessary, at least one optical element 24 may be further provided between the support member 23 and the optical element 24. In addition, whenever necessary, between the optical element laminate 31 and the liquid crystal panel 4 or the light source 11, at least one optical element 24 may be further provided.

In the following description of the embodiment, the optical element 24 bonded to the support member 23 is referred to as a bonding optical element 24. In addition, the optical element 24 provided between the support member 23 and the bonding optical element 24 is referred to as an internal addition optical element 24, and the optical element 24 provided between the optical element laminate 31 and the liquid crystal panel 4 or the light source 11 is referred to as an external addition optical element 24. In addition, when being collectively called without particularly discriminated from each other, the bonding optical element 24, the internal addition optical element 24, and the external addition optical element 24 are each simply referred to as the optical element 24.

When the rectangular bonding optical element 24 is bonded to the incident surface or the emission surface of the rectangular support member 23, the bonding optical element 24 is at least bonded to facing two side portions of the peripheral portion of the primary surface of the support member 23. In particular, among the four side portions of the primary surface of the support member 23, the bonding optical element 24 is bonded to facing two side portion sides, three side portions, or all the four side portions. When being bonded to the end surfaces of the rectangular support member 23, the rectangular bonding optical element 24 is at least bonded to facing two end surfaces among the end surfaces of the support member 23. In particular, among the end surfaces of the support member 23, the bonding optical element 24 is bonded to facing two end surfaces, three end surfaces, or all the four end surfaces.

When the bonding optical element 24 is bonded to all the four side portions, which are the peripheral portion of the primary surface of the support member 23, at least one opening portion is preferably provided in the bond portion at the peripheral portion. The reason for this is as follows. That is, when the bonding optical element 24 is bonded to all the four side portions, which are the peripheral portion of the primary surface of the support member 23, a shear tensile strength is maximized. However, when the bonding optical element 24 is bonded to all the four side portions of the support member 23, air trapped between the bonding optical element 24 and the support member 23 is placed in a closed state. When air is placed in a closed state as described above, problems in that for example, the optical element laminate 31 bursts under a reduced pressure, the adhesion portion is peeled away, and the bonding optical element 24 is fractured may arise. In order to avoid the situations as described above, at least one opening portion is preferably provided in the bond portion at the peripheral portion.

The tensile force F of the bonding optical element 24 bonded to the rectangular support member 23 preferably satisfies the following relational expression (1) in an environment at a temperature 70° C. When this relational expression (1) is satisfied, the generation of warping of the support member 23 can be suppressed while sags, wrinkles, and the like of the bonding optical element 24 are suppressed.

0≦F≦1.65×10⁴×t/L (1)

(Where, in the expression (1), t, L, and F indicate the following.
t: a distance between the first primary surface and the second primary surface of the support member,
L: a length of the facing two side portions to which the optical element is bonded or a length of a long side of the facing two end surfaces to which the optical element is bonded, and
F: a tensile force of the optical element acting in a direction parallel to a side portion having the length L or a tensile force of the optical element acting in a direction parallel to the long side of an end surface having the length L.)

When the bonding optical element 24 is bonded to all the side portions of the rectangular support member 23, tensile forces F1 and F2 acting on the bonding optical element 24 preferably satisfy the following relational expressions (2) and (3) at a temperature of 70° C. When the expressions (2) and (3) are satisfied, the generation of warping of the support member 23 can be suppressed while sags, wrinkles, and the like of the bonding optical element 24 are suppressed.

0≦F1≦1.65×10⁴×t/L2 (2)

0≦F2≦1.65×10⁴×t/L1 (3)

(Where, in the expressions (2) and (3), t, L1, L2, F1, and F2 indicate the following.
t: a distance between the first primary surface and the second primary surface of the support member,
L1 and L2: each indicating a length of facing two side portions to which the optical element is bonded or a length of a long side of facing two end surfaces to which the optical element is bonded,
F1: a tensile force of the optical element acting in a direction parallel to a side portion having the length L1 or a tensile force of the optical element acting in a direction parallel to the long side of an end surface having the length L1, and
F2: a tensile force of the optical element acting in a direction parallel to a side portion having the length L2 or a tensile force of the optical element acting in a direction parallel to the long side of an end surface having the length L2.)

The shear tensile strength between the support member 23 and the bonding optical element 24 is preferably 0.14 N/15 mm or more. When the shear tensile strength is less than 0.14 N/15 mm, the bonding optical element 24 may be peeled away from the support member 23, and the optical element laminate 31 may be fractured. In addition, when the peeling strength is more than 20 N/15 mm, if the bonding optical element 24 is peeled away from the support member 23, the cohesion failure of the bond portion is liable to occur. Accordingly, the bonding optical element 24 and the support member 23 are difficult to be recycled.

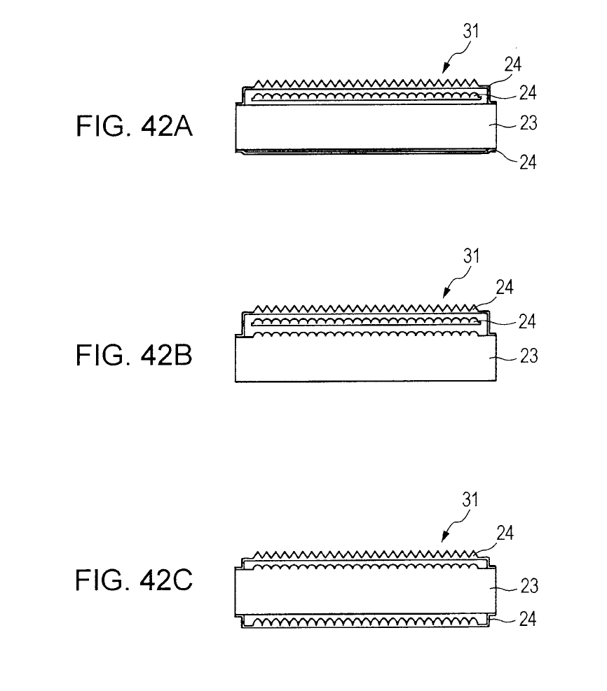

Hereinafter, with reference to FIGS. 41A to 41C, 42A to 42C, 43A to 43C, and 44A to 44C, structural examples of the optical element laminate 31 will be described. In accordance with desired characteristics of a liquid crystal display device or backlight, it is preferable that the following structures of the optical element laminate 31 are appropriately selected and used. However, the structure of the optical element laminate 31 is not particularly limited to the following examples.

### (First Example)

FIG. 41A shows a first example of the optical element laminate. As shown in FIG. 41A, this optical element laminate 31 includes the support member 23, the bonding optical element 24 bonded to the peripheral portion of the emission surface (first primary surface) of this support member 23, and the internal addition optical element 24 disposed between this bonding optical element 24 and the support member 23. In addition, the optical element laminate 31 further includes the bonding optical element 24 bonded to the peripheral portion of the incident surface (second primary surface) of the support member 23. A tensile force is applied to the bonding optical element 24 in the in-plane direction of the primary surface of the support member 23. Accordingly, the bonding optical elements 24, the internal addition optical element 24, and the support member 23 are integrated.

In addition, to the optical element 24 provided on the primary surface of the support member 23, a surface shape, such as a prism lens shape or an aspheric lens shape, may be imparted. In the optical element laminate 31, when a plurality of the optical elements 24 is provided on one primary surface of the support member 23, the surface shape imparted to the optical elements 24 may be variously changed for the individual optical elements 24 thus disposed.

In FIG. 41A, an example of the optical element laminate 31 is shown in which a lens film (1)/a diffusion plate/a diffusion sheet/a lens film (2) are sequentially laminated from the incident surface side to the emission surface side of the optical element laminate 31. However, the lens film (1) is a lens film in which lens lines extending in one direction are disposed on one primary surface, and in addition, in which the cross-sectional shape of the lens is set to have a semicircular or an approximately semicircular shape. The lens film (2) is a lens film in which lens lines extending in one direction are disposed on one primary surface, and in addition, in which the cross-sectional shape of the lens is set to have a triangle or an approximately triangle shape. The diffusion sheet is a film in which for example, a semispherical shape is imparted to the emission surface side. In addition, in the following description, the lens film (1) and the lens film (2) indicate films similar to those described above. However, the cross-sectional shapes of the lens film (1) and the lens film (2) may be appropriately changed, and for example, a shape, such as a triangle or an approximately triangle shape, a semicircular or an approximately semicircular shape, or an aspheric shape, may be used.

### (Second Example)

FIG. 41B shows a second example of the optical element laminate. As shown in FIG. 41B, the external addition optical element 24 which is not integrated with this optical element laminate 31 may be further disposed on at least one of the incident surface and the emission surface of the optical element laminate 31.

In FIG. 41B, an example of the optical element laminate 31 is shown in which the lens film (1)/a diffusion plate/the lens film (2) are sequentially laminated from the incident surface side to the emission surface side of the optical element laminate 31.

### (Third Example)

FIG. 41C shows a third example of the optical element laminate. As shown in FIG. 41C, at least two internal addition optical elements 24 may be further disposed between the emission surface of the support member 23 and the bonding optical element 24. In addition, the optical element 24 may not be disposed on the incident surface.

In FIG. 41C, an example of the optical element laminate 31 is shown in which a diffusion plate/a diffusion sheet/the lens film (2)/a diffusion sheet are sequentially laminated from the incident surface side to the emission surface side of the optical element laminate 31.

### (Fourth Example)

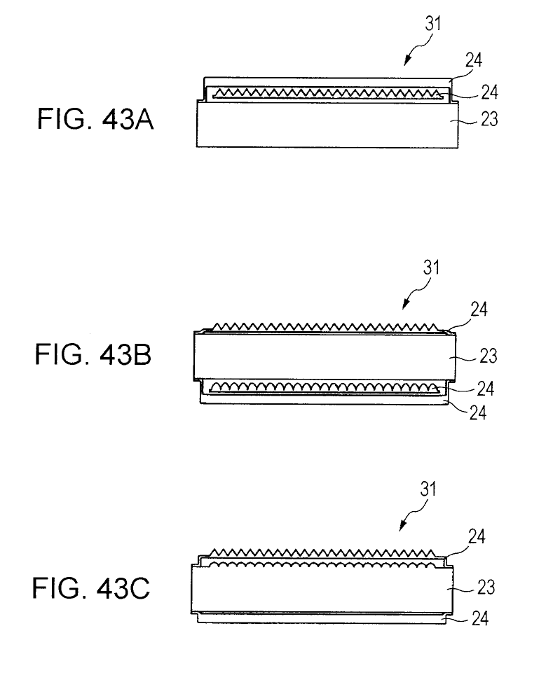

FIG. 42A shows a fourth example of the optical element laminate. As shown in FIG. 42A, as the bonding optical element 24, a bonding optical element 24 in which a shape is not imparted to the surface thereof may be provided. In FIG. 42A, an example is shown in which the bonding optical element 24 bonded to the incident surface (second primary surface) of the support member 23 is the bonding optical element 24 in which no shape is imparted to the surface thereof. In addition, in order to suppress the warping of the support member 23, it is preferable that the bonding optical elements 24 are bonded to the two primary surfaces of the support member 23 and that the same tensile force or tensile forces having a predetermined ratio are applied to maintain the balance.

For example, the longitudinal/lateral ratio (MD/TD ratio) of a tension of the film (optical element) on one surface and that of a tension of the film (optical element) on the other surface are preferably orthogonal to each other. Accordingly, even if the support member 23 has a small thickness and a low rigidity, when an apparent rigidity is increased by the tension balance between the front and the rear sides, this laminate can be used as the optical element laminate 31. In this case, the tension balance of MD/TD on the one surface is preferably 5/95 to 49/51 or 51/49 to 95/5. In addition, the ratio of the TD tension on the one surface to the MD tension on the other surface is preferably 30/70 to 70/30 and more preferably 40/60 to 60/40. Accordingly, the thickness of the support member 23 can be decreased and, for example, can be decreased to 2 mm or less and more preferably 1 mm or less.

In FIG. 42A, an example of the optical element laminate 31 is shown in which a PC sheet having a smooth surface/a diffusion plate/a diffusion sheet/the lens film (2) are sequentially laminated from the incident surface side to the emission surface side of the optical element laminate 31.

### (Fifth Example)

FIG. 42B shows a fifth example of the optical element laminate. As shown in FIG. 42B, a shape may be imparted to at least one of the two primary surfaces of the support member 23.

In FIG. 42B, an example of the optical element laminate 31 is shown in which a shape-imparted diffusion plate/a diffusion sheet/the lens film (2) are sequentially laminated from the incident surface side to the emission surface side of the optical element laminate 31. In this example, the shape-imparted diffusion plate indicates a diffusion plate in which an irregular shape is formed by shape transfer on the surface thereof in a one-dimensional or a two-dimensional manner.

### (Sixth Example)

FIG. 42C shows a sixth example of the optical element laminate. As shown in FIG. 42C, a shape may be imparted to the two bonding optical elements 24 bonded to the respective primary surfaces of the support member 23. The reason for this is that performance of resolving irregularities of the light source can be improved thereby.

In FIG. 42C, an example of the optical element laminate 31 is shown in which the lens film (1)/a shape-imparted diffusion plate/the lens film (2) are sequentially laminated from the incident surface side to the emission surface side of the optical element laminate 31.

### (Seventh Example)

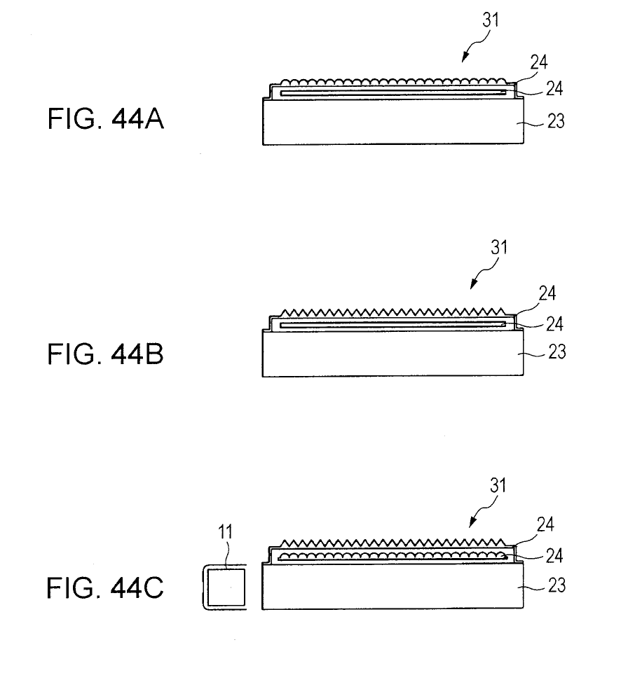

FIG. 43A shows a seventh example of the optical element laminate. As shown in FIG. 43A, two optical elements 24 in which lens lines extending in one direction are formed are disposed on the emission surface of the support member 23, and the directions of the lens lines of the optical elements 24 may be adjusted so that the extending directions of the lens lines of the optical elements 24 are orthogonal to each other. Accordingly, the luminance can be improved, and a function of resolving irregularities of the light source can be improved.

In FIG. 43A, an example of the optical element laminate 31 is shown in which a diffusion plate/the lens film (2)/the lens film (2) are sequentially laminated from the incident surface side to the emission surface side of the optical element laminate 31. However, the two lens films (2) sequentially laminated at the emission surface side are disposed so that the extending directions of the lenses thereof are orthogonal to each other.

### (Eighth Example)

FIG. 43B shows an eighth example of the optical element laminate. As shown in FIG. 43B, two optical elements 24 in which lens lines extending in one direction are formed are disposed on the incident surface of the support member 23, and the directions of the lens lines of the optical elements 24 may be adjusted so that the extending directions of the lens lines of the optical elements 24 are orthogonal to each other. When the light source is a point light source, the optical element laminate of this eighth example is preferably used. The reason for this is that superior irregularity resolving performance can be obtained.

In FIG. 43B, an example of the optical element laminate 31 is shown in which the lens film (1)/the lens film (1)/a diffusion plate/a diffusion sheet/the lens film (2) are sequentially laminated from the incident surface side to the emission surface side of the optical element laminate 31. However, the two lens films (1) sequentially laminated at the incident surface side are disposed so that the extending directions of the lens lines thereof are orthogonal to each other.

### (Ninth Example)

FIG. 43C shows a ninth example of the optical element laminate. As shown in FIG. 43C, lens lines extending in one direction are formed on each of the primary surfaces of the support member 23 and the bonding optical element 24, and the extending direction of the lens lines of the support member 23 and that of the bonding optical element 24 may be set to be orthogonal to each other. The lens of the support member 23 and that of the bonding optical element 24 each have a cross-sectional shape, such as an approximately triangle, noncircular, or semicircular shape. When the light source is a point light source, the optical element laminate of this ninth example is preferably used. The reason for this is that superior irregularity resolving performance can be obtained.

In FIG. 43C, an example of the optical element laminate 31 is shown in which the lens film (1)/a shape-imparted diffusion plate/the lens film (2) are sequentially laminated from the incident surface side to the emission surface side of the optical element laminate 31. The shape-imparted diffusion plate shown in FIG. 43C is a diffusion plate in which lens lines extending in one direction are disposed on one primary surface thereof, and the cross-sectional shape of the lens is set, for example, to have a circular or an approximately semicircular shape. In this example, the shape-imparted diffusion plate and the lens film (1) disposed at the incident surface side of the shape-imparted diffusion plate are disposed so that the extending directions of the lens lines thereof are orthogonal to each other.

### (Tenth and Eleventh Examples)

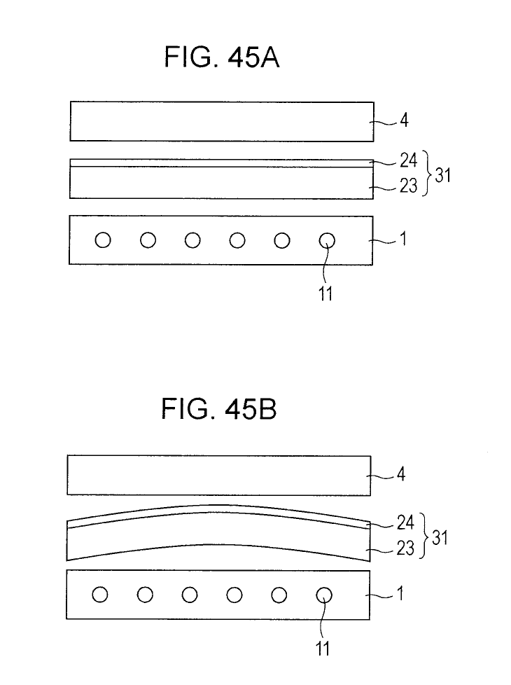

FIGS. 44A and 44B show a tenth and an eleventh example of the optical element laminate. As shown in FIGS. 44A and 44B, as the internal addition optical element 24 and/or the bonding optical element 24 disposed at the emission surface side of the support member 23, a reflection type polarizer may also be used. When the reflection type polarizer is disposed at the emission surface side of the support member 23 as described above, the optical element 24 such as a lens sheet is preferably disposed between this reflection type polarizer and the liquid crystal panel. The reason for this is that by the optical element 24 such as this lens sheet, the surface of the reflection type polarizer having an inferior scratch resistance can be protected. In addition, when the optical element 24 is disposed between the reflection type polarizer and the liquid crystal panel, the refractive index anisotropy of the optical element 24 to be disposed is preferably small.

In FIG. 44A, an example of the optical element laminate 31 is shown in which a diffusion plate/a reflection type polarizer/a diffusion sheet are sequentially laminated from the incident surface side to the emission surface side of the optical element laminate 31. In FIG. 44B, an example of the optical element laminate 31 is shown in which a diffusion plate/a reflection type polarizer/the lens film (2) are sequentially laminated from the incident surface side to the emission surface side of the optical element laminate 31.

### (Twelfth Example)

FIG. 44C shows a twelfth example of the optical element laminate. As the backlight, when a side light system type backlight is used in which the light source 11 is disposed at one end of the support member 23, and light enters the support member 23 through one end surface thereof, as the support member 23, a light guide plate is preferably used as shown in FIG. 44C. As the light guide plate, a light guide plate which is a transparent plate having an irregular shape imparted to the primary surface thereof is preferably used.

In FIG. 44C, an example of the optical element laminate 31 in which a light guide plate/a diffusion sheet/the lens film (2) are sequentially laminated is shown.

Hereinafter, with reference to FIG. 40 and the like, the support member 23, the optical element 24, and the bonding layer 71, which form the optical element laminate, according to the fifteenth embodiment of the present invention will be sequentially described.

### (Support Member)

The support member 23 is, for example, a transparent plate which transmits light emitted from the lighting device 1 or an optical plate changing characteristics of light by performing a treatment, such as diffusion or condensation, on light emitted from the lighting device 1. As the optical plate, for example, a diffusion plate, a light guide plate, a retardation plate, or a prism plate may be used, and a diffusion plate, a light guide plate, or the like is preferably used.

The diffusion plate is a plate which contains a filler having a different refractive index in a plastic to have light diffusion characteristics and which has a function to resolve light source irregularities of light emitted from a lighting device. As the filler, for example, a silicon filler having a particle diameter of approximately several micrometers may be used.

In order to resolve the light source irregularities, the transmittance of the diffusion plate is preferably approximately 30 to 90%. In addition, a shape may be imparted to the front surface, the rear surface, or the above two surfaces of the diffusion plate functioning as the support member 23 so as to resolve the light source irregularities.

The shape to be imparted to the surface of the diffusion plate is preferably selected appropriately in accordance with the type of light source of the lighting device, the placement position of the light source, and other structures of the lighting device. For example, a triangle prism shape, an aspheric shape, a lenticular shape, or the like is preferably disposed parallel to the light source. In addition, a three-dimensional dot-shape, an irregular shape, or the like may also be disposed on the front or the rear surface of the support member 23. The density of dots is set so as to correspond to the positions of the light sources, and the dots are preferably disposed so that the denseness and sparseness thereof changes periodically. The reason for this is that by the placement described above, a high irregularity resolving effect can be obtained.

As a method for forming irregularities, for example, an injection molding method using a mold having an irregular pattern, a mechanical machining method using an NC machine tool or the like, a laser machining method for carving irregularities by laser rays, and the like may be used. Furthermore, for example, an ink jet method in which a resin material is ejected on the surface to print irregularities or an ink print method in which a mold is pressed to a resin to transfer irregularities may also be used.

Depending on the type, the position, and the like of the light source, as the support member 23, a transparent support member having irregularities to reflect or diffuse light may be used. In addition, a reflective paint may be applied to the surface of the support member 23. The application position, application area, thickness, and the like of the reflective paint may be preferably selected appropriately in accordance with the position of the light source. The thickness of the reflective paint is preferably 10 to 600 μm. The application area is preferably 30% or more in terms of a covering rate, and the covering rate is preferably increased as the distance from the light source is increased.

In addition, it is preferable that the surface of the support member 23 is appropriately roughened. The reason for this is that generation of scratches can be suppressed, and that scratches can be made inconspicuous. In particular, the arithmetic average roughness Ra of the surface of the support member 23 is preferably 0.01 to 50 μm. When the roughness is less than 0.01 μm, a surface-roughing effect is liable to be degraded. On the other hand, when the roughness is more than 50 μm, since the degree of surface roughness is excessively high, bonding between the support member 23 and the bonding optical element 24 is liable to be disturbed.

The length of the support member 23 is preferably 500 to 100,000 μm and more preferably 1,000 to 50,000 μm. The thickness, cross-sectional width, length, and rigidity (elastic modulus) of the support member 23 are preferably selected appropriately in consideration of the tensile force of the optical element 24. As a material for the support member 23, for example, there may be mentioned a poly(methyl methacrylate) (PMMA), a polystyrene (PS), a copolymer (MS) of methyl methacrylate (MMA) and styrene (St), a polycarbonate (PC), a cycloolefin polymer, a polypropylene, a polyethylene, a poly(ethylene terephthalate), a poly(ethylene naphthalate), an acrylonitrile.butadiene.styrene resin (ABS), a styrene.butadiene copolymer (SBC), a glass, or the like. In addition, whenever necessary, in the material for the support member 23, for example, a particle filler having a refractive index different from that thereof, an ultraviolet absorber, or an ultraviolet fluorescent agent may be mixed. In addition, irregularities may also be formed on the front or the rear surface of the support member 23.

Among the materials for the support member 23 described above, PS, PMMA, and PC are particularly preferable. When the light source is located immediately under the support member 23, PS is particularly preferable. The reason for this is that since PS has a low saturated water absorption rate, the generation of warping of the support member 23 is suppressed, and the degradation of display characteristics of the liquid crystal display device can be suppressed. In addition, PS also has an advantage of low material cost.

### (Generation Principle of Warping)

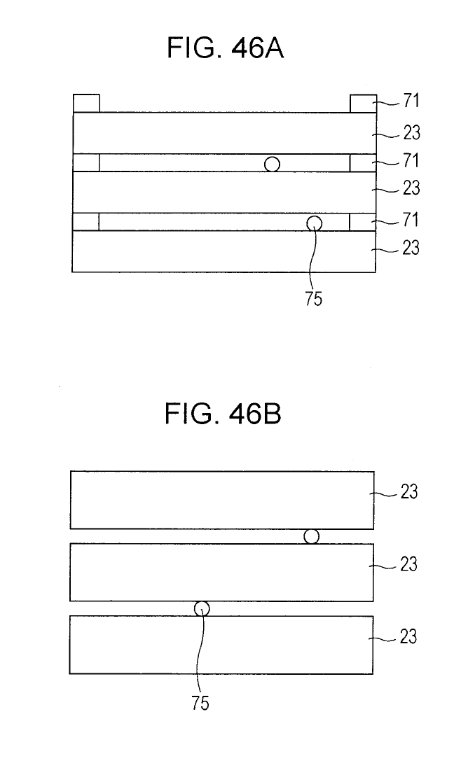

Hereinafter, with reference to FIGS. 45A and 45B, the principle of the degradation of display characteristics which is caused by the generation of warping of the support member 23 will be described in detail. In this explanation, as an example, as shown in FIG. 45A, the principle of the generation of warping will be described when a liquid crystal display device in which the support member 23 is not warped is stored under high humidity conditions.

After the liquid crystal display device shown in FIG. 45A is stored under high humidity conditions, when the lighting device 1 is turned on, if the saturated water absorption rate of the support member 23 is high, as shown in FIG. 45B, by heat at the lighting device side, the support member 23 is dried from the side of the lighting device 1, and the length of the surface at the lighting device side is decreased. Hence, the support member 23 is unfavorably warped in a direction toward the liquid crystal panel 4 and is brought into contact therewith. Accordingly, since the orientation condition of liquid crystal at the contact portion is damaged, and the polarized condition is changed, white portions are generated thereby as irregularities on the oval, and as a result, the display characteristics are degraded. In particular, since a material, such as PMMA, has a high saturated water absorption rate, when the material as mentioned above is used as a primary component to form the support member 23, the above-described irregularities are liable to be generated.

When the points described above are taken into consideration, in order to suppress the degradation of display characteristics of a liquid crystal display device, the support member 23 is preferably formed using PS as a primary component which has a low saturated water absorption rate and which is inexpensive. However, when the light source is provided at the side of the support member 23, since the irregularities as described above are not generated, the support member 23 is preferably formed using a transparent resin material, such as PMMA or a cycloolefin polymer.

### (Optical Element)

As the optical element 24, for example, a lens film, a diffusion sheet, or a reflection type polarizer may be used. The reflection type polarizer allows only one of orthogonal polarized components to pass therethrough and reflects the other component. As the reflection type polarizer, for example, a laminate, such as an organic multilayer film, an inorganic multilayer film, or a liquid crystal multilayer film, may be used. In addition, a material having a different refractive index may also be contained in the reflection type polarizer. In addition, in order to improve color irregularities which occur when viewed in an oblique angle, a diffusion layer, a lens, or an irregular shape may be further provided on the surface of the reflection type polarizer.

As a material for the optical element 24, for example, PC, PS, PMMA, MS, a cycloolefin polymer, a polypropylene, polyethylene, a poly(ethylene terephthalate), a poly(ethylene naphthalate), an acrylonitrile.butadiene.styrene resin, or the like may be mentioned, and for example, a mixture or a derivative thereof may also be used. As the optical element 24, when a material having a structure including a base material and an optical layer formed on the surface thereof is used, the aforementioned material may also be used as a material for the base material of the optical element 24. In addition, the optical layer of the optical element 24 is formed by applying a painting which contains an ultraviolet curable resin and an organic or an inorganic filler on the surface of the base material, followed by curing.

In order to avoid warping caused by the change in temperature or peeling at the bond portion, the optical element 24 preferably has a coefficient of thermal expansion approximately equivalent to that of the support member 23. For example, the difference in coefficient of thermal expansion is preferably set to 2×10⁻⁵ or less. In addition, as described later, since the optical element 24 is bonded to the support member 23 while a tensile force is applied to the optical element 24, the optical element 24 preferably has a high fracture strength. In addition, since bonding between the support member 23 and the optical element 24 is performed by thermal welding, the optical element 24 preferably has a high heat resistance. In addition, in order to improve optical characteristics of incident light, the optical element 24 preferably has a refractive index anisotropy or has a fine irregular shape on at least one of the front or the rear surface thereof. In consideration of the above preferable characteristics as the optical element 24, as a material for the optical element 24, for example, PC, a poly(ethylene terephthalate), or a poly(ethylene naphthalate) is preferable, and in particular, PC is preferable.

When a bond surface of the bonding optical element 24 includes PC, and the emission surface, the incident surface, or the end surface of the support member 23 to which the bonding optical element 24 is bonded includes at least one of a copolymer of MMA and St (in which the content of MMA is less than 50 mass percent), a mixture of PMMA and PSt (in which the content of PMMA is less than 50 mass percent), and PSt, the two described above are difficult to be bonded by direct welding. Hence, in this first embodiment, as described above, the bonding layer 71 is provided between the bonding optical element 24 and the support member 23, and the above two are bonded to each other by welding or the like with this bonding layer 71 interposed therebetween.

As the bonding layer 71, a high molecular weight resin layer containing at least one of PMMA, ABS, SBC, a copolymer of MMA and St (in which the content of MMA is 50 mass percent or more), a mixture of PMMA and PSt (in which the content of PMMA is 50 mass percent or more), and a derivative thereof is preferably used. The reason for this is that when the high molecular weight resin layer as described above is used, an appropriate bonding strength can be obtained.

In addition, as the bonding layer 71, an adhesive layer containing at least one of an acryl-based adhesive, a butadiene-based adhesive, an acrylonitrile.butadiene-based adhesive, and a chloroprene-based adhesive is preferably used. That is, as the adhesive layer, for example, an adhesive layer containing at least one of an acrylic and a derivative thereof, a butadiene and a derivative thereof, an acrylonitrile.butadiene-based adhesive, and a chloroprene-based adhesive and a derivative thereof is preferably used. The reason for this is that when the adhesive layer as described above is used, an appropriate bonding strength can be obtained.

A shape is preferably imparted to the surface of the optical element 24. The reason for this is that, for example, by reflecting, refracting, and scattering light from a lighting device, effects, such as light condensation of the lighting device and resolution of light source irregularities, can be improved. For example, in order to improve the directivity of illumination light and the like, lines of fine prisms or lenses are preferably provided on the emission surface of the optical element 24. The cross section of the prism or the lens line in the line direction has an approximately triangle shape, and the peak thereof is preferably formed to have a round shape. The reasons for this are that the cut-off can be improved and that a wide viewing angle can be realized.

On the other hand, when an improvement in luminance is set as a primary object, a lens film in which the cross section of a prism or a lens has a perfect triangle shape (such as a rectangular equilateral triangle) or an approximately perfect triangle shape my be used. The lens film as described above can be formed, for example, by a method in which using a laminating machine, a press machine, or the like, a master having triangle irregularities is pressed to a film so that an irregular shape is transferred to the film.

In addition, in order to enhance the directivity, instead of using the lens line, a structure having a simple triangle shape, a semispherical shape, a semioval shape, or the like may also be used. In addition, inside the shape, such as the prism shape, or inside the base material, the refractive index anisotropy is preferably imparted. The reason for this is that a light component passing through a polarizer disposed in the liquid crystal display device can be selectively enhanced.

In addition, in order to resolve light source irregularities of various light sources, such as a point light source and a line light source, disposed in the lighting device, an irregular shape may be provided on at least one of the incident surface and the emission surface. As the irregular shape, for example, a continuous shape of prisms, circular arcs, hyperboloids or paraboloids; a single triangle shape; or a shape in combination therebetween may be used, and depending on the case, a structure having a flat surface may also be used. In addition, the irregular structure may be changed in accordance with the positional relation with the light source.

In addition, in order to resolve the directivity and light source irregularities of the light source, there may also be used a material which includes a surface having an irregular structure for diffusing light, a material including fine particles or the like having a refractive index different from that of a primary constituent material of the optical element 24, a material including hollow fine particles, or a material in which at least two of the above irregular structure, fine particles, and hollow fine particles are used in combination. As the fine particles, for example, at least one type of organic fillers and inorganic fillers may be used. In addition, the irregular structure, the fine particles, and the hollow fine particles are provided, for example, on the emission surface of the optical element.

As described above, between the support member 23 and the bonding optical element 24 bonded to the peripheral portion of the primary surface of the support member 23 or the end surfaces thereof, the internal addition optical element 24 may be further provided. In addition, as described above, the external addition optical elements 24 may be further provided at the incident surface side and the emission surface side of the optical element laminate 31. The internal addition optical element 24 and the external addition optical element 24 are disposed to improve the luminance, irregularities, polarization characteristics, and the like of the liquid crystal display device. As the type of internal addition optical element 24 and that of external addition optical element 24, an optical element similar to the bonding optical element 24 may be used. In particular, for example, there may be used a film having prisms, lens lines, single triangle shapes, semispherical shapes, semioval shapes, or the like on the primary surface thereof to enhance the directivity, a light control film having a continuous shape of prisms, circular arcs, hyperboloids, or paraboloids; a diffusion film; or a reflection type polarizer.

### (Bonding Layer)

When the primary surface of the bonding optical element 24 functioning as a bond surface contains, for example, PC as a primary component, and the primary surface or the end surface of the support member 23 functioning as a bond surface contains, for example, a PS or an MS resin as a primary component, the bond surfaces described above are difficult to be bonded to each other by simple welding. However, the above MS resin is a resin containing less than 50 mass percent of an MMA component. Accordingly, in this fifteenth embodiment, when the bonding optical element 24 and the support member 23 as described above are used in combination, the bonding layer 71 is provided between the bonding optical element 24 and the support member 23, and pressure bonding, thermal welding, or the like is performed, so that the bonding optical element 24 and the support member 23 are bonded to each other.

As a material for the bonding layer 71, a material containing at least one of PMMA, SBC, and ABS is preferable. In addition, as a material for the bonding layer 71, a material containing at least one of an acryl-based adhesive and a rubber-based adhesive is preferable. As the rubber-based adhesive, a material containing a butadiene-based adhesive, an acrylonitrile.butadiene-based adhesive, or a chloroprene-based adhesive is preferable. Although the form of the bonding layer 71 is not particularly limited as long as being capable of bonding the bonding optical element 24 and the support member 23, for example, a sheet form, a powder form, a filament form, a gel form, or a liquid form may be mentioned.

A bonding method is preferably selected appropriately in accordance with the type of material for the bonding layer 71. For example, when the bonding layer 71 is a plastic sheet, as the bonding method, welding, such as thermal welding, ultrasonic welding, or solvent welding, is preferable. In addition, when the bonding layer 71 is a gelled resin, as the bonding method, pressure bonding is preferable.

The bonding layer 71 is formed, for example, at the entire primary surface of the support member 23 or the bonding optical element 24 or at a portion only corresponding to the peripheral portion of the primary surface of the support member 23 or the end surfaces thereof. However, the bonding layer 71 may be provided at a position at which the bonding optical element 24 can be bonded to the peripheral portion of the primary surface of the support member 23 or the end surfaces thereof, and the forming position of the bonding layer 71 is not particularly limited.

The bonding width between the support member 23 and the bonding optical element 24 is preferably 0.1 mm or more to 10 mm or more. When the bonding width is less than 0.1 mm, the bonding width is too small, and the bonding strength is decreased. Hence, it is difficult to increase a tensile force applied to the bonding optical element 24, and the bonding optical element 24 is liable to be warped. On the other hand, when the bonding width is more than 10 mm, the bonding width is too large, and the bonding strength is excessively increased. As a result, since the bonding optical element 24 is difficult to be peeled away from the support member 23, the support member 23 and the bonding optical element 24 are difficult to be recycled. In addition, when the bonding width is too large, the display characteristics are liable to be influenced by the difference in optical characteristics between the bond portion and a non-bond portion. As the influence on the display characteristics, for example, a phenomenon in which only the peripheral portion of the bond portion is brightly viewed may arise. In order to suppress the influence of the bond portion on the display characteristics, for example, the bonding width is preferably 10 mm or less which is a standard size obtained by subtracting the size of the liquid crystal panel from the size of the outside periphery of the diffusion plate.

As a structural example of the bonding layer 71, the structure may be roughly classified into the following three examples. A first structural example is that when the support member 23 is formed, the bonding layer 71 is formed in advance on the primary surface of the support member 23. A second structural example is that when the bonding optical element 24 is formed, the bonding layer 71 is formed in advance on the primary surface of the bonding optical element 24. A third structural example is that after the support member 23 and the bonding optical element 24 are formed, the bonding layer 71 is separately formed on the primary surface of the support member 23 or the bonding optical element 24 or that when the support member 23 and the bonding optical element 24 are bonded to each other, an adhesion layer 71 is separately disposed between the support member 23 and the bonding optical element 24.

In order to simplify the process before and after the bonding, as the bonding layer 71, the first and the second structural examples are preferably used. In addition, in order to easily form the bonding layer 71 only on the peripheral portion or the end surfaces, the third structural example is preferably used. In addition, instead of forming the bonding layer 71 on the peripheral portion of the primary surface of the support member 23, a projection portion may be formed in advance on the peripheral portion of the primary surface of the support member 23.

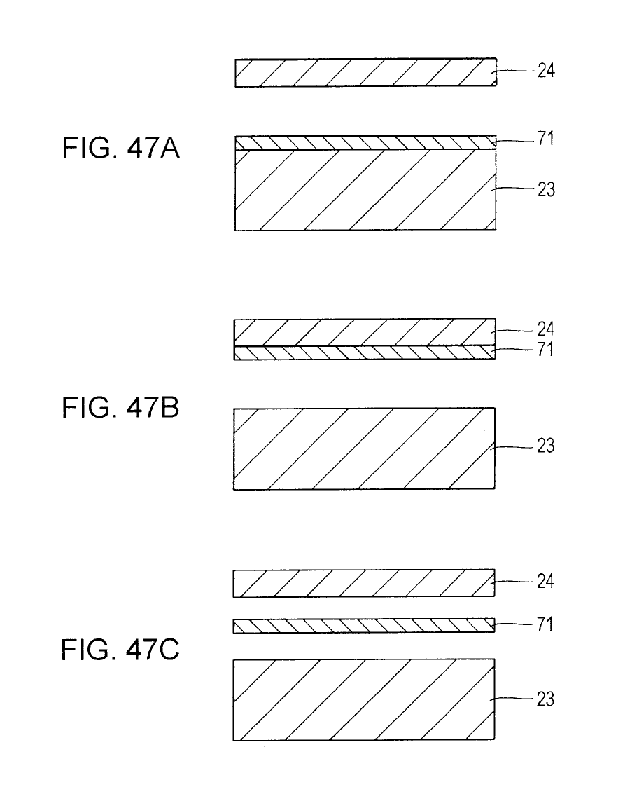

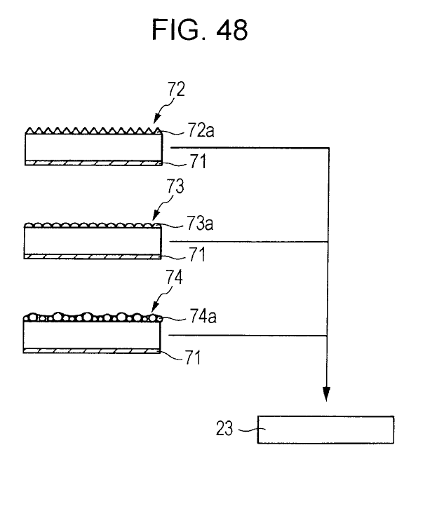

FIG. 46A shows one structural example of the support member 23 on which the bonding layer 71 is formed at the peripheral portion thereof. FIG. 46B shows one structural example of the support member 23 on which no bonding layer 71 is formed at the peripheral portion thereof. As shown in FIG. 46A, when the bonding layer 71 is formed only on the peripheral portion, if a plurality of the support members 23 is stacked to each other, spaces can be formed between the support members. Hence, even when a plurality of the support members 23 is stacked, the generation of scratches caused by foreign materials 75 and the like can be suppressed. On the other hand, as shown in FIG. 46B, when no bonding layer 71 is formed on the peripheral portion, if a plurality of the support members 23 is stacked to each other, the foreign materials 75 and the like are sandwiched between the support members. Hence, scratches are generated in the primary surface of the support member 23 due to the foreign materials 75 and the like.

### (Structural Example of Bonding Layer)

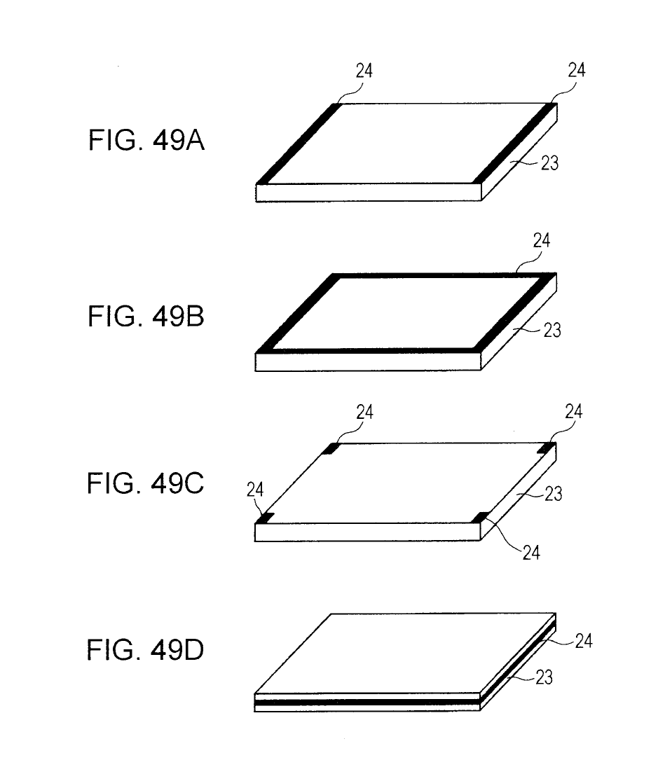

Hereinafter, with reference to FIGS. 47A to 47C, a first to a third structural example of the bonding layer 71 will be sequentially described.

### (First Example)

FIG. 47A shows a first structural example of the bonding layer 71. As shown in FIG. 47A, the bonding layer 71 is formed in advance on the incident surface or the emission surface of the support member 23. The bonding optical element 24 is bonded to the peripheral portion of the incident surface or the emission surface of the support member 23 or the end surfaces thereof with this bonding layer 71 interposed therebetween.

### (Second Example)

FIG. 47B shows a second structural example of the bonding layer 71. As shown in FIG. 47B, the bonding layer 71 is formed in advance on one primary surface of the bonding optical element 24. The bonding optical element 24 is bonded to the peripheral portion of the incident surface or the emission surface of the support member 23 or the end surfaces thereof with this bonding layer 71 interposed therebetween.

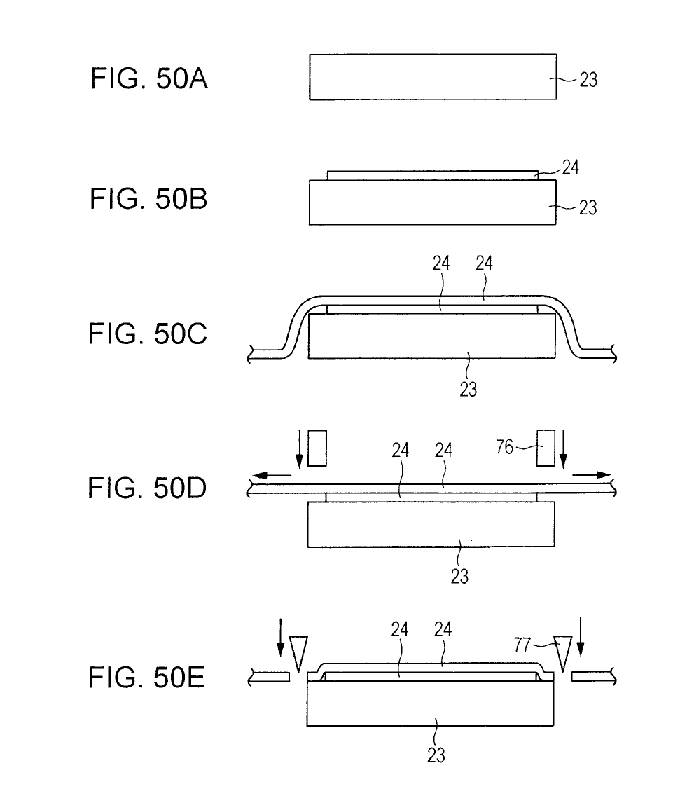

FIG. 48 shows examples of the bonding optical element bonded to the emission surface (first primary surface) of the support member. As the bonding optical element 24 bonded to the emission surface of the support member 23, for example, a lens film 72, a lens film 73, a diffusion sheet 74, and the like may be mentioned. On one primary surface of the lens film 72, lines of prism lenses 72a extending in one direction are formed, and on the other primary surface, the bonding layer 71 is formed. On one primary surface of the lens film 73, lines of lenses 73a, each of which has a noncircular cross section, extending in one direction are formed, and on the other primary surface, the bonding layer 71 is formed. On one primary surface of the diffusion sheet 74, a diffusion layer 74a is formed, and on the other primary surface, the bonding layer 71 is formed. The diffusion layer 74a contains, for example, fine particles and a binder, and the fine particles protrude from the surface of the diffusion layer 74a.

### (Third Example)

FIG. 47C shows a third structural example of the bonding layer 71. As shown in FIG. 47C, for example, when the bonding optical element 24 is bonded to the peripheral portion of the primary surface of the support member 23, the bonding layer 71 is sandwiched between the support member 23 and the bonding optical element 24.

### (Bonding Position)

As the bonding position, for example, there may be mentioned all four side portions, which are the peripheral portion of the primary surface of the support member 23, facing two side portions of the peripheral portion of the primary surface of the support member 23, four corner portions of the peripheral portion of the support member 23, all four end surfaces of the support member 23, and facing two end surfaces among the four end surfaces of the support member 23. The procedure for bonding the bonding optical element 24 to the support member 23 is not particularly limited, and bonding of all the bonding positions may be simultaneously performed or may be separately performed at least twice.

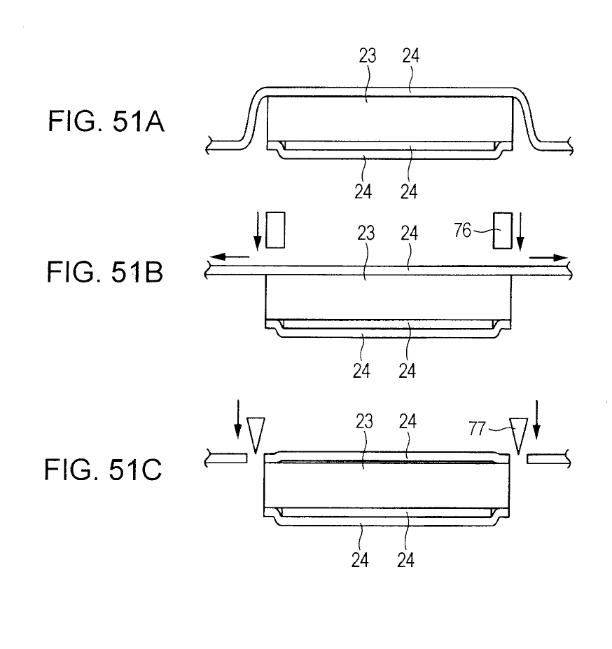

Hereinafter, with reference to FIGS. 49A to 49D, examples of the bonding position will be described. In addition, in FIGS. 49A to 49D, a region shown by a solid black color is the bonding position.

### (First Example)

FIG. 49A shows a first example of the bonding position. As shown in FIG. 49A, in this first example, the bonding optical element 24 is bonded to facing two side portions of the peripheral portion of the primary surface of the support member 23 having a rectangular shape.

### (Second Example)

FIG. 49B shows a second example of the bonding position. As shown in FIG. 49B, in this second example, the bonding optical element 24 is bonded to all the four side portions of the peripheral portion of the primary surface of the support member 23 having a rectangular shape.

### (Third Example)

FIG. 49C shows a third example of the bonding position. As shown in FIG. 49C, in this third example, the bonding optical element 24 is bonded to the four corner portions of the peripheral portion of the primary surface of the support member 23 having a rectangular shape.

### (Fourth Example)

FIG. 49D shows a fourth example of the bonding position. As shown in FIG. 49D, in this fourth example, the bonding optical element 24 is bonded to all the four end surfaces of the support member 23 having a rectangular shape.

### [Method for Manufacturing Optical Element Laminate]

Next, with reference to FIGS. 50A to 50E and 51A to 51C, one example of a method for manufacturing an optical element laminate having the above structure will be described. This method for manufacturing an optical element laminate is characterized by a process for bonding the bonding optical element 24 to the peripheral portion of the primary surface of the support member 23 while a tensile force is applied to the bonding optical element 24.

First, as shown in FIG. 50A, the support member 23 is prepared. The support member 23 preferably has a rectangular shape. The reason for this is that when the rectangular shape is used, a process for bonding the bonding optical element 24 and the support member 23 can be easily performed.

Next, as shown in FIG. 50B, whenever necessary, the internal addition optical element 24 is placed on the emission surface (first primary surface) of the support member 23. The size of the internal addition optical element 24 is preferably smaller than that of the support member 23. For example, the size obtained by subtracting the bond portion and the dimensional tolerance from the size of the support member 23 is the size of the internal addition optical element 24.

Next, as shown in FIG. 50C, for example, the bonding optical element 24 is placed on the emission surface of the support member 23 so that the bonding optical element 24 covers at least facing two side portions of the peripheral portion of the emission surface of the support member 23. The size of the bonding optical element 24 is preferably larger than that of the support member 23. The reason for this is that, by using the above size, in a subsequent step of mechanically applying a tensile force to the bonding optical element 24, margin portions used for holding the bonding optical element 24 can be ensured as described later.

Next, as shown in FIG. 50D, while a tensile force is applied to the bonding optical element 24, the bonding optical element 24 is bonded to the peripheral portion of the primary surface of the support member 23. Since the bonding is performed while a tensile force is applied to the bonding optical element 24 as described above, the generation of warping and undulation of the bonding optical element 24 can be suppressed. Hence, the thickness of the bonding optical element 24 can also be further decreased. As a method for applying a tensile force, for example, a method in which pulling is mechanically performed in at least one of the short-side and the longitudinal directions of the rectangular support member 23 may be mentioned.

The directions of the tensile force are preferably in the in-plane direction of the emission surface of the support member 23 and are also preferably in two directions opposite to each other. In particular, at least one tensile force is preferably applied from at lest one of the width direction (or the short-side direction) of the rectangular support member 23 and the longitudinal direction thereof and is more preferably applied from both the width and the longitudinal directions. The reason for this is that when the tensile forces are applied from the two directions, warping and undulation are not generated even if high tensile forces are applied, and the thickness of the bonding optical element 24 can be further decreased.

As a bonding method, for example, a bonding method by welding and a bonding method by an adhesive may be mentioned. As the bonding method by welding, for example, thermal welding, ultrasonic welding, laser welding, or welding using a solvent may be mentioned. As an adhesion method by an adhesive, for example, a hot-melt type adhesion method, a thermosetting type adhesion method, a pressure-sensitive (tacky) type adhesion method, an energy-ray curable type adhesion method, a hydration type adhesion method, or a moisture-absorbing•re-moisturizing type adhesion method may be mentioned. In addition, in FIG. 49D, an example is shown in which a heater blade (heating portion) 76 is pressed to the bonding optical element 24 from the above, so that the bonding optical element 24 is bonded to the peripheral portion of the primary surface of the support member 23 by thermal welding.

By performing alignment between the central position of the internal addition optical element 24 and the central position of the support member 23 so that the peripheral portion of the primary surface of the internal addition optical element 24 is not sandwiched between the support member 23 and the bonding optical element 24 at the bond portion, the peripheral portion of the primary surface of the support member 23 is preferably exposed from the peripheral portion of the primary surface of the internal addition optical element 24. In addition, from the above process to the bonding process, it is preferable that the internal addition optical element 24 is temporarily bonded to the support member 23. This temporary bonding strength may be enough if the internal addition optical element 24 is maintained at a predetermined position of the support member 23 until the bonding optical element 24 is bonded thereto. As a temporary bonding method, for example, a welding method, such as ultrasonic welding or spot thermal welding, an adhesion method using an adhesive or a tacky agent, or a bonding method by static electricity may be used.

Next, as shown in FIG. 50E, the margin portions of the bonding optical element 24 are appropriately cut away by a cutting tool 77 such as a cutter. When the margin portions are cut away and removed, the size of the entire optical element laminate can be decreased without degrading optical functions. In addition, a space of the liquid crystal display device receiving the optical element laminate can also be decreased.

Next, whenever necessary, the bonding optical element 24 is bonded to the peripheral portion of the incident surface (second primary surface) of the support member 23 as described below. First, as shown in FIG. 51A, for example, the bonding optical element 24 is placed on the incident surface of the support member 23 so that the bonding optical element 24 covers at least facing two side portions of the peripheral portion of the incident surface of the support member 23. Next, as shown in FIG. 51B, for example, while a tensile force is applied to the bonding optical element 24, the heater blade (heating portion) 76 is pressed to the bonding optical element 24 from the above, so that the bonding optical element 24 is bonded to the peripheral portion of the primary surface of the support member 23 by thermal welding. Next, as shown in FIG. 51C, by the cutting tool 77 such as a cutter, the margin portions of the bonding optical element 24 are appropriately cut away and removed.

Accordingly, a targeted optical element laminate 31 can be obtained.

In addition, in the above manufacturing method, the bonding optical element 24 at the emission surface side and the bonding optical element 24 at the incident surface side are independently bonded to the support member 23 in separate steps; however, the top and the bottom optical elements 24 may be simultaneously bonded thereto by simultaneously pressing the heater blades (heating portions) 76 from the top and the bottom sides.

In addition, instead of using the above heat blade (heating portion) 76, ultrasonic welding or laser welding may be performed using an ultrasonic oscillator or a laser oscillator. In particular, in the case of ultrasonic welding, since heat generation can be suppressed, a thermal damage done to the film can be reduced.

In addition, in the above manufacturing method, after being bonded to the support member 23, the bonding optical element 24 is cut; however, after being cut, the bonding optical element 24 may be bonded to the support member 23 (not shown in the figure). For example, after the bonding optical element 24 is cut into a desired size, the optical element 24 and the support member 23, which are to be bonded to each other, are temporarily fixed by a jig made of SUS (stainless steel) or the like from the top and the bottom, and by using a U-shaped heat block, all or parts of the peripheral portions and the end surfaces of the optical element 24 and the support member 23 are simultaneously bonded to each other. When the temporary fixing is performed using a jig, whenever necessary, a tensile force may be applied to the bonding optical element 24. Alternatively, while a tensile force is applied to a film which is to be formed into the bonding optical element 24, the jig is temporarily fixed, the bonding optical element 24 is then cut, and bonding may be performed by using a heat block. In addition, in the cases described above, a bonding method, such as ultrasonic welding or laser welding, may also be used.

### 16. Sixteenth Embodiment

In a sixteenth embodiment of the present invention, a surface layer having a function, such as diffusion or condensation, is used as the bonding layer, and this is a point different from that of the fifteenth embodiment.

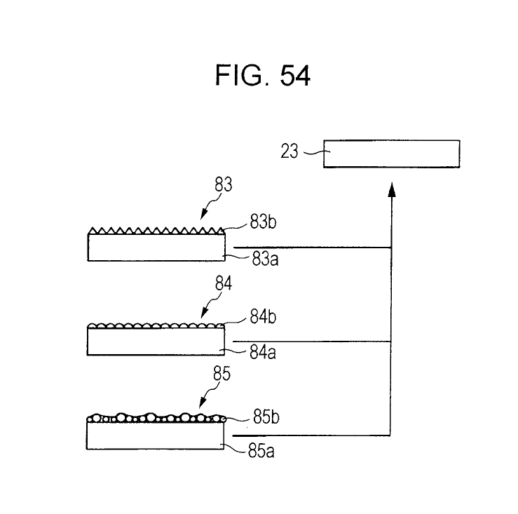

Hereinafter, with reference to FIGS. 52A and 52B, a structural example of an optical element laminate in which the surface layer of the support member 23 or the bonding optical element 24 is used as the bonding layer will be described.

### (First Example)

FIG. 52A is an exploded cross-sectional view showing one example of the optical element laminate. This optical element laminate includes the support member 23, and the bonding optical element 24 bonded to the peripheral portion of the emission surface of the support member 23. The support member 23 includes a base material layer (core layer) 81a and a surface layer (skin layer) 81b formed on at least one of the two primary surfaces of the base material layer 81a. The bonding optical element 24 is bonded to the peripheral portion of the emission surface of the support member 23 with the bonding layer interposed therebetween. The surface layer 81b is an optical functional layer having a function, such as diffusion or condensation. As the optical functional layer, for example, there may be mentioned a diffusion layer in which fine particles and a binder are contained and the fine particles protrude from the surface thereof, or a lens layer in which lenses are arranged on the primary surface in a one-dimensional manner or a two-dimensional manner. In addition, this surface layer 81b has a function as the bonding layer as described above.

In the optical element laminate 31 of this first example, when the support member 23 is formed, the surface layer 81b primarily composed of a desired resin can be formed on the surface of the base material layer 81a. In addition, a material for the base material layer 81a is not particularly limited. In addition, since an intermediate layer such as a new bonding layer is not further required in the optical element laminate 31, a process for forming the optical element laminate 31 can be simplified. In particular, the support member (such as a diffusion plate) 23 is preferably formed from the base material layer 81a primarily composed of PS and the surface layer 81b primarily composed of MS. The reasons for this are that the support member 23 can be formed at a low cost and that the adhesion between the base material layer 81a and the surface layer 81b can be improved. In addition, the support member (such as a light guide plate) 23 is preferably formed from the base material layer 81a and the surface layer 81b each of which is primarily composed of PMMA.

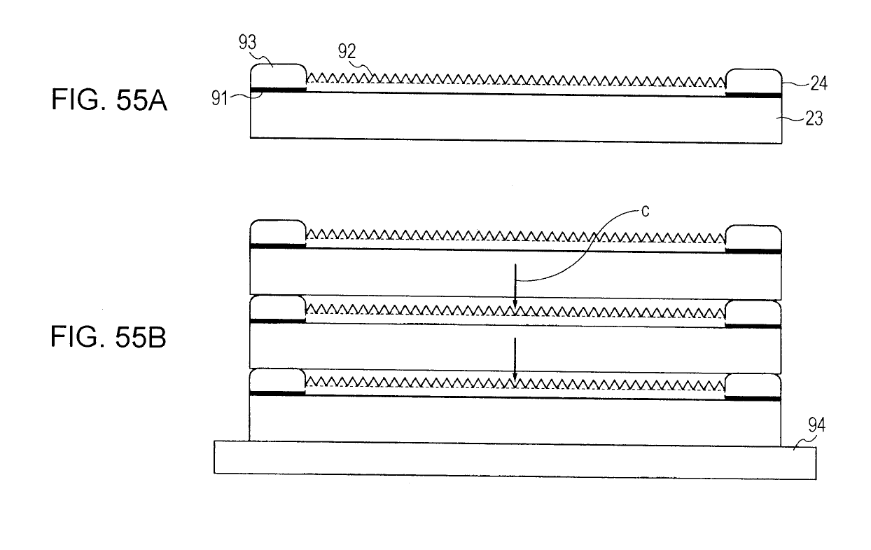

FIG. 53 is an enlarged cross-sectional view showing a structural example of the support member. As shown in FIG. 53, the support member 23 includes the base material (core layer) layer 81a functioning as a primary portion and the thin surface layers (skin layer) 81b formed on the two primary surfaces of this base material layer. As the base material layer 81a, a layer primarily composed of a material which is inexpensive and which has a low saturated water absorption rate capable of suppressing the above generation of irregularities is preferable. In particular, for example, PS, PC, or a cycloolefin polymer is preferable. In addition, in order to impart a diffusion property, a filler 86a is preferably contained in the base material layer 81a.

In addition, an ultraviolet absorber or a fluorescent agent emitting fluorescent visible light from ultraviolet rays is preferably contained since the support member is prevented from being embrittled and yellowed by ultraviolet rays emitted from a lighting device. In addition, the above ultraviolet absorber or fluorescent agent is preferably contained only in the surface layer 81b. The reason for this is that when the above agent is contained only in the surface layer 81b, the cost can be reduced, and in addition, optical characteristics can also be improved. Since an ultraviolet absorber absorbs visible light having a short wavelength together with ultraviolet rays, when an ultraviolet absorber is contained in the base material layer 81a, the optical characteristics may be degraded.

In order to obtain an ultraviolet prevention effect, the thickness of the surface layer 81b is preferably 10 to 500 μm. For the base material layer (core layer) 81a, a high molecular weight material having a low saturated water absorption rate, such as PS, PC, or a cycloolefin polymer, is preferable. On the other hand, since the surface layer 81b has a small ratio to the thickness of the whole support member, the saturated water absorption rate may not be low. In addition, as a material for the surface layer 81b, in consideration that this layer is directly irradiated by ultraviolet rays, for example, PMMA, MS, or a cycloolefin polymer, which can suppress embrittlement caused by ultraviolet rays, is preferable. In addition, in order to impart a diffusion property, a filler 86b is preferably contained in the surface layer 81b.

### (Second Example)

FIG. 52B is an exploded cross-sectional view showing a second example of the optical element laminate. This optical element laminate 31 includes the support member 23 and the bonding optical element 24 bonded to the peripheral portion of the incident surface of the support member 23. The bonding optical element 24 includes a base material layer 82a and a surface layer 82b formed on the base material layer 82a. The bonding optical element 24 is bonded to the support member 23 with the surface layer 82b. The surface layer 82b is an optical functional layer having a function, such as diffusion or condensation. As the optical functional layer, for example, there may be mentioned a diffusion layer in which fine particles and a binder are contained and the fine particles protrude from the surface thereof, or a lens layer in which lenses are arranged on the primary surface in a one-dimensional manner or a two-dimensional manner. In addition, this surface layer 82b has a function as the bonding layer as described above.

In the optical element laminate 31 of this second example, when the bonding optical element 24 is formed, the surface layer 82b which is a bonding layer can be formed on the base material layer 82a. In addition, by applying a melted resin or the like on the base material layer 82a, and also by imparting a shape to this melted resin or the like, the bonding optical element 24 having an optical function may also be formed.

As the bonding optical element 24 as described above, for example, a lens film or a light control film may be mentioned. These films may be formed, for example, in such a way that after an acrylic resin or the like is applied on a poly(ethylene terephthalate) substrate, the acrylic resin or the like is formed to have triangle prism shapes or aspheric shapes, and curing is then performed by energy rays, such as heat or ultraviolet rays. In this process, a curing step may be performed either before or after the bonding to the support member 23.

In addition, as the bonding optical element 24, for example, a diffusion sheet may also be used. As the diffusion sheet, for example, a sheet may be used which is formed in such a way that after a paint containing bead particles, an acryl binder, and the like is applied to a poly(ethylene terephthalate) substrate, curing is performed to form an irregular shape on the surface. In addition, a diffusion layer may be further provided on the bonding optical element 24 such as a lens film or a light control film.

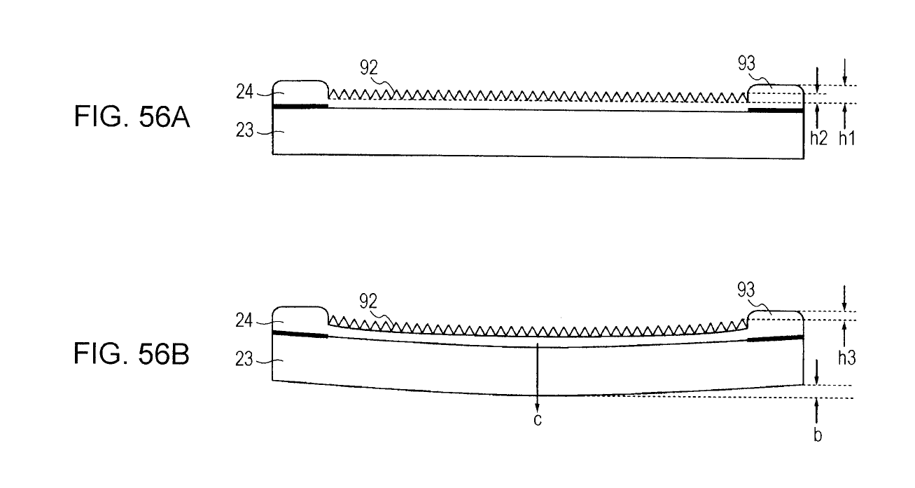

FIG. 54 shows examples of the bonding optical element 24 bonded to the peripheral portion of the incident surface of the support member 23. A bonding optical element 83 is a lens film including a base material layer 83a and a lens layer 83b formed on one primary surface of the base material layer 83a. As the lens layer 83b, lines of lenses extending in one direction are disposed on one primary surface of the base material layer 83a, and the cross-sectional shape of the lens is set to have an approximately triangle shape. A bonding optical element 84 is a lens film including a base material layer 84a and a lens layer 84b formed on one primary surface of the base material layer 84a. As the lens layer 84b, lines of lenses extending in one direction are disposed on one primary surface of the base material layer 84a, and the cross-sectional shape of the lens is set to have a semicircular or an approximately semicircular shape. A bonding optical element 85 is a diffusion sheet including a base material layer 85a and a diffusion layer 85b formed on one primary surface of the base material layer 85a. The diffusion layer 85b includes, for example, fine particles and a binder, and the fine particles protrude from the surface of the diffusion layer 85b. In addition, in FIG. 54, the lens layers 83b and 84b and the diffusion layer 85b are each function as a bonding layer to the support member 23.

### 17. Seventeenth Embodiment

The weight of an optical element laminate formed by laminating a plurality of optical elements and a support member is increased. Hence, when optical element laminates are stacked for storage, transportation, or the like, by their own weights, the optical element laminates are brought into contact or rubbed with each other, and as a result, the optical element laminates may be damaged or fractured in some cases. In particular, when the surface of the optical element laminate is an optical element, such as a lens film, to which a certain shape is imparted, its lens portion is damaged by contact, friction, and the like, and as a result, desired optical characteristics may not be obtained.

Hence, according to a seventeenth embodiment of the present invention, in order to suppress contact, friction, and the like between optical element laminates which occur when the optical element laminates are stacked for storage, transportation, or the like, a protrusion is provided at the peripheral portion of the optical element laminate.

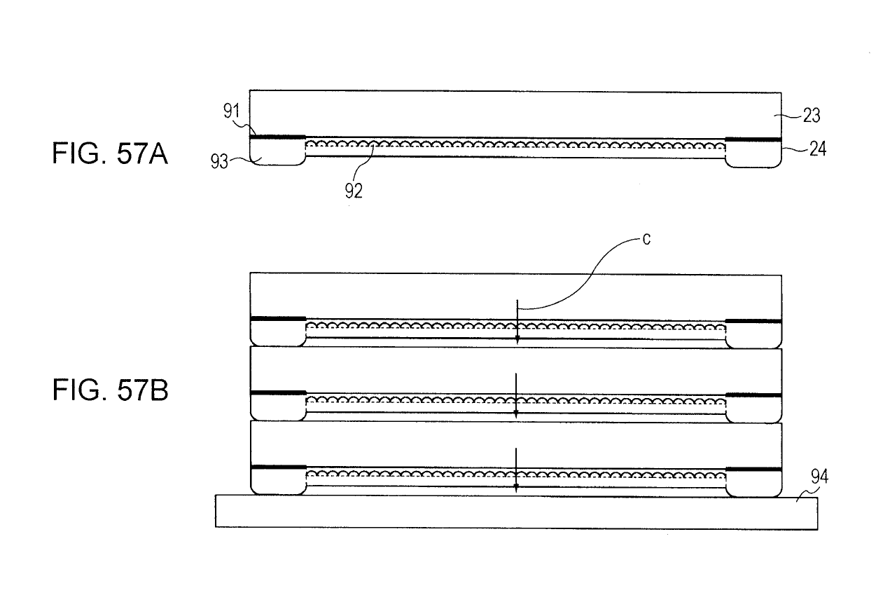

Hereinafter, with reference to FIGS. 55A and 55B to FIGS. 60A and 60B, structural examples of the optical element laminate according to the seventeenth embodiment in which a protrusion is provided on the optical element will be described. In addition, portions corresponding to those in the above first embodiment will be described by using the same symbols.

### [Structure of Optical Element Laminate]

### (First Example)

FIG. 55A shows a first example of the optical element laminate. This optical element laminate includes the support member 23 and the optical element 24 bonded to the peripheral portion of at least one of the emission surface (first primary surface) and the incident surface (second primary surface) of the support member 23. In addition, in the following description, when the first and the second primary surfaces of the support member 23 are not necessarily discriminated from each other, they are each simply called the “primary surface”.

As the support member 23, for example, a plate, a sheet, or a film material may be used. In particular, for example, as the support member 23, the diffusion plate 23a may be used. In this case, a material may be used in which for example, a lens having an irregular shape or a textured pattern formed by a filler or fine irregularities is provided on at least one of the first and the second primary surfaces of the diffusion plate 23a. In addition, besides that mentioned above, as the support member 23, for example, an optical member, such as a prism sheet, a lenticular lens sheet, a diffusion sheet, a light guide plate, or a reflection plate, may also be used. In addition, the optical member used in the first example as the support member 23 may also be used in the following second to seventh examples in a manner similar to that described above.

The optical element 24 is formed, for example, of a material including at least one of a styrene-butadiene copolymer, a polypropylene, and a polycarbonate. In the optical element 24, on at least one of the incident surface and the emission surface thereof, structures 92 each having a prism lens shape, an aspheric lens shape, or the like are formed. In the example shown in FIG. 55A, the case is shown in which as the optical element 24, a lens film, such as a prism sheet, is used in which the structures 92 are each formed to have a triangle cross-sectional shape. In addition, as the optical element 24, besides this example, for example, a lens film in which the structures 92 are each formed to have a cross section of a polygonal-prism other than a triangle shape (such as a pentagonal-prism) or a diffusion sheet in which the structures 92 are each formed to have a semispherical cross-sectional shape may be used. However, as well as those described above, for example, a film or a sheet may be used which has at least one optical function among a light division function, a light diffusion function, a light reflection function, a reflection polarization function, a polarization separation function, a light guide function, and the like.

The optical element 24 is bonded to the peripheral portion of the primary surface of the support member 23, for example, so that the structures 92 face the side opposite to the support member 23. A bond portion 91 is a portion at which the above two are actually bonded to each other. The bonding between the optical element 24 and the support member 23 may be performed, for example, by thermal welding, laser welding, ultrasonic welding, or a sealing method using a tacky agent. When the optical element 24 is bonded to the support member 23, the bonding is preferably performed while a tension is applied. The reasons for this are that, by the above bonding, since the state in which a tensile force is applied in the in-plane direction of the primary surface of the support member 23 is maintained, the generation of wrinkles, sags, and the like is suppressed, and in addition, the optical element 24 and the support member 23 can be brought into close contact with each other.

In a region corresponding to the peripheral portion of the optical element 24, a protrusion portion 93 protruding to the side opposite to the support member 23 is provided. The protrusion portion 93 may be provided simultaneously when the bond portion 91 is formed or may be provided in the same step, or after the bond portion 91 is formed, the protrusion portion 93 may be provided. In addition, after the protrusion portion 93 is provided in advance for the optical element 24, the optical element 24 and the support member 23 may be bonded to each other. As a method for forming the protrusion portion 93, for example, lamination or welding of a resin may be used. In addition, as the method for forming the protrusion portion 93, for example, an emboss process or a printing method may also be used.

FIG. 55B shows an example in which a plurality of optical element laminates each having the above structure is stacked on a pallet 94 used for storage, transportation, or the like. When the optical element laminates are stacked, for example, stacking is performed so that the protrusion portion 93 is located at an upper side. In this case, for example, when the diffusion plate 23a is used as the support member 23, although the weight of each optical element laminate changes depending on the size thereof, it is expected that the weight is in the range of several hundreds of grams to approximately 1 kg. In this first example, since the protrusion portion 93 is provided for the optical element 24, a space can be provided between adjacent optical element laminates. That is, even if the optical element laminates are warped by stacking, the contact between the optical element laminates can be prevented or suppressed.

On the other hand, in the case in which the protrusion portion 93 is not provided, when a plurality of optical element laminates is stacked, the optical element laminates are warped by the gravity in a direction indicated by an arrow c, and the optical element laminates are brought into contact with each other, so that the surface of the optical element laminate (particularly, the surface of the structures 92 of the optical element 24) may be damaged in some cases.

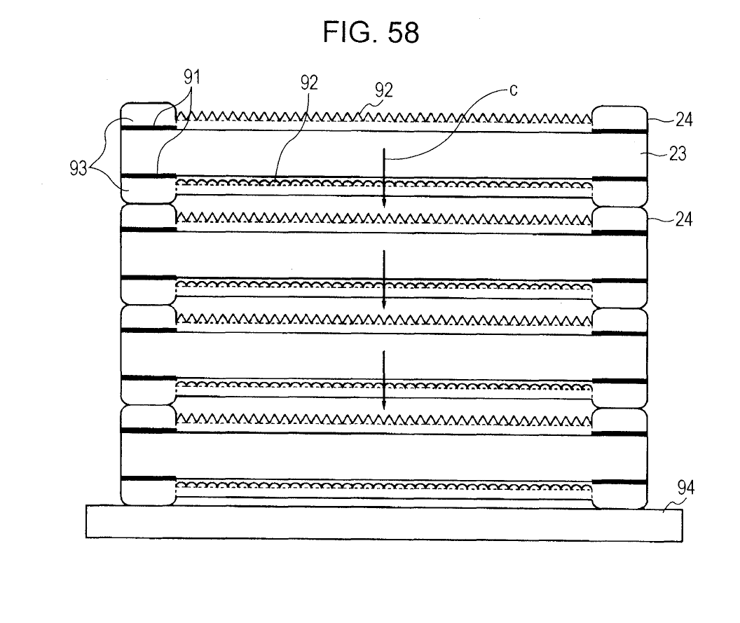

As shown in FIG. 56A, when the height of the protrusion portion 93 based on the rear surface of the optical element 24 is represented by h1, and the height of the structure 92 based on the rear surface of the optical element 24 is represented by h2, the heights are set to satisfy “h1≧1.5h2” and are more preferably set to satisfy “h1≧2h2”. Accordingly, when a plurality of the optical element laminates is stacked, the contact between the optical element laminates can be more effectively prevented or suppressed.

In addition, as shown in FIG. 56B, when the difference in height between the protrusion portion 93 and the structure 92 is represented by h3 (=h1−h2), and a warping distance caused by the gravity when the optical element laminates are stacked is represented by b, the height of the protrusion portion 93 is set so as to satisfy “h3b”, preferably “h3≧1.5b, and more preferably “h3≧2b”. Accordingly, when a plurality of optical element laminates is stacked, even if the optical element laminates are warped, the contact therebetween can be more effectively prevented or suppressed.

### (Second Example)

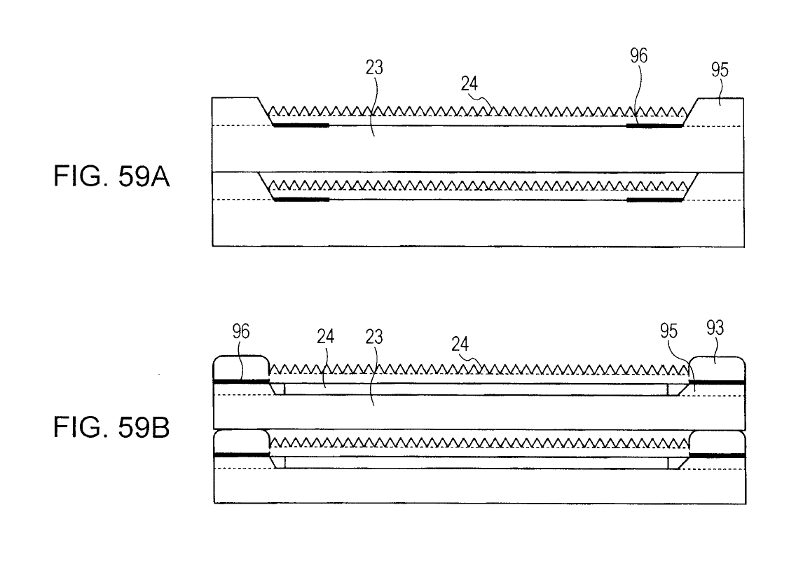

FIG. 57A shows a second example of the optical element laminate. This optical element laminate includes the support member 23 and the optical element 24 at least bonded to the peripheral portion of the second primary surface of the support member 23. As the support member 23, for example, as in the above first example, the diffusion plate 23a may be used.

In the optical element 24, by using a material similar to that in the above first example, the structures 92 are formed at least one of the incident surface and the emission surface. In the example shown in FIG. 57A, the case is shown in which as the optical element 24, a lenticular lens film is used in which the structures 92 are each formed to have a semispherical cross-sectional shape.

The optical element 24 is bonded to the peripheral portion of the primary surface of the support member 23 at the bond portion 91 so that the structures 92 face the support member 23 side. The bonding between the optical element 24 and the support member 23 is performed, for example, in a manner similar to that in the above-described first example.

In a region corresponding to the peripheral portion of the optical element 24, the protrusion portion 93 protruding to the side opposite to the support member 23 is provided. The protrusion portion 93 may be provided simultaneously when the bond portion 91 is formed or may be provided in the same step, or after the bond portion 91 is formed, the protrusion 93 may be provided. In addition, after the protrusion portion 93 is provided in advance for the optical element 24, the optical element 24 and the support member 23 may then be bonded to each other. As a method for forming the protrusion portion 93, for example, lamination or welding of a resin may be used. In addition, as the method for forming the protrusion portion 93, for example, an emboss process or a printing method may also be used.

FIG. 57B shows an example in which optical element laminates each having the above structure are stacked to each other, for example, on the pallet 94. When the optical element laminates are stacked, for example, stacking is performed so that protrusion portions 93 are located at the lower side. As described above, in this second example, since the protrusion portion 93 is provided for the optical element 24, a space can be provided between adjacent optical element laminates. That is, even if the optical element laminates are warped by stacking, the contact between the optical element laminates can be prevented or suppressed.

### (Third Example)

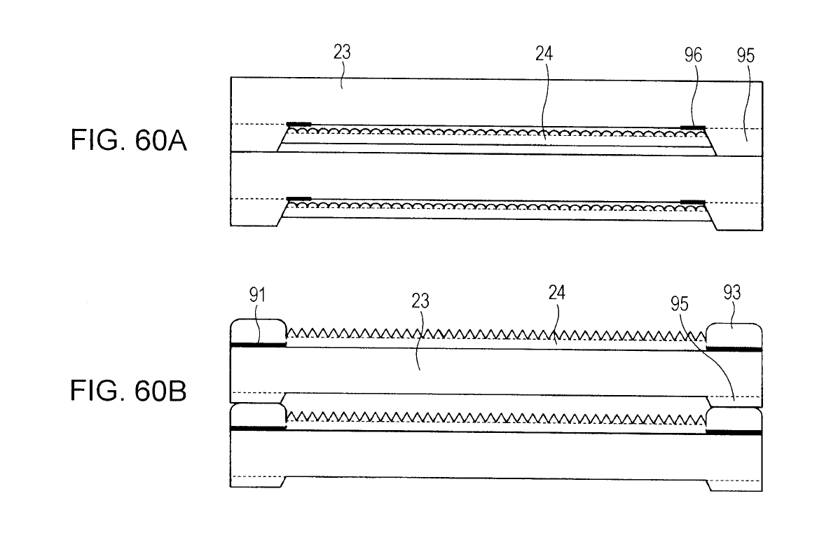

FIG. 58 shows a third example of the optical element laminate. This optical element laminate includes the support member 23, and a first and a second optical element 24 bonded to respective peripheral portions of the two primary surfaces of the support member 23. As the support member 23, for example, the diffusion plate 23a may be used as in the above first example.

In the first optical element 24, by using a material similar to that in the above first example, the structures 92 are formed at least one of the incident surface and the emission surface. In the example shown in FIG. 58, the case is shown in which as the optical element 24, a lens film, such as a prism sheet in which the structures 92 are each formed to have a triangle cross-sectional shape, is used.

In the second optical element 24, by using a material similar to that in the above first example, the structures 92 are formed at least one of the incident surface and the emission surface. In the example shown in FIG. 58, the case is shown in which as the optical element 24, a lens film in which the structures 92 are each formed to have a triangle cross-sectional shape is used at an upper side, and a lenticular lens film in which the structures 92 are each formed to have a semispherical shape is used at a lower side.

The first optical element 24 (upper side) is bonded to the peripheral portion of the primary surface of the support member 23 at the bond portion 91, for example, so that the structures 92 face the side opposite to the support member 23. In addition, the second optical element 24 (lower side) is bonded to the peripheral portion of the primary surface, which is different from the primary surface to which the first optical element 24 is bonded, of the support member 23 at the bond portion 91, for example, so that the structures 92 face the support member 23 side. The bonding between the first and the second optical elements 24 and the support member 23 is performed, for example, in a manner similar to that of the above first example.

In a region corresponding to the peripheral portion of the first optical element 24, the protrusion portion 93 protruding to the side opposite to the support member 23 is provided. In addition, in a region corresponding to the peripheral portion of the second optical element 24, the protrusion portion 93 protruding to the side opposite to the support member 23 is provided. The protrusion portion 93 may be provided simultaneously when the bond portion 91 is formed or may be provided in the same step, or after the bond portion 91 is formed, the protrusion 93 may be provided. In addition, after the protrusion portions 93 are provided in advance for the first and the second optical elements 24, the first and the second optical elements 24 may be bonded to the support member 23. As a method for forming the protrusion portion 93, for example, lamination or welding of a resin may be used. In addition, as the method for forming the protrusion portion 93, for example, an emboss process, a printing method, or the like may also be used.

As described above, in this third example, the protrusion portion 93 is provided for the first optical element 24, and in addition, the protrusion portion 93 is also provided for the second optical element 24. Hence, when the optical element laminates are stacked, compared to the above first and second examples, the space between adjacent optical element laminates can be increased. That is, even if the optical element laminates are warped by stacking, the contact between the optical element laminates can be more effectively prevented or suppressed.

In this third example, although it is described that the first optical element 24 and the second optical element 24 are bonded to the respective peripheral portions of the support member 23, the bonding is not limited to this example. For example, at the end surfaces of the support member 23, the first optical element 24 and the second optical element 24 may be bonded to each other. When the primary surface of the support member 23 has a rectangular shape, bonding is preferably performed at the end surfaces corresponding to facing two sides, three sides, or the four sides, which form the primary surface.

In addition, for example, after the first optical element 24 and the second optical element 24 are integrally formed in advance, the bonding may be performed at least one end surface corresponding to one side, two sides, or three sides of the support member 23. In this case, the structures 92 formed for the first and the second optical elements 24 may have different shapes at the first and the second primary surface sides or may have the same shape.

Furthermore, after sidewall portions are provided for the peripheries of the first and the second optical elements 24, the sidewall portions of the respective optical elements 24 may be bonded to the end surfaces of the support member 23. In addition, for example, the sidewall portion of the first optical element 24 and the sidewall portion of the second optical element 24 are bonded to each other, and further the bonded sidewall portions may be bonded to the end surfaces of the support member 23.

In addition, it is more preferable that a contraction step is added after the bonding step of bonding the support member 23 and the optical elements 24 so as to contract the optical elements 24. The reason for this is that, by the above step, since a predetermined tensile force is applied to each optical element 24, wrinkles, sags, and the like are suppressed, and in addition, the optical elements 24 and the support member 23 can be brought into close contact with each other.

### (Fourth Example)

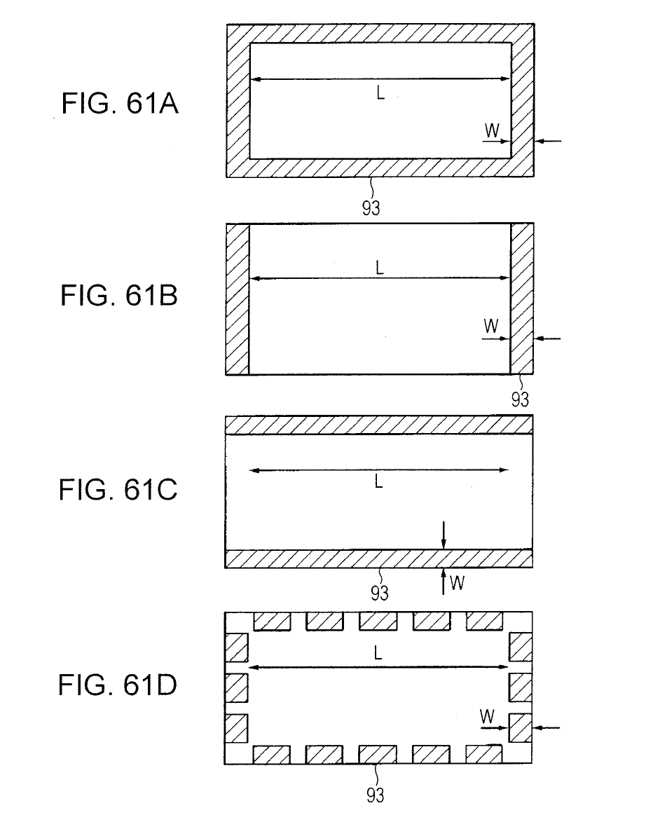

FIG. 59A shows a fourth example of the optical element laminate. This optical element laminate includes the support member 23 and the optical element 24 bonded to the primary surface of the support member 23. In a region corresponding to the peripheral portion of the primary surface of the support member 23 to which the optical element 24 is bonded, a protrusion portion 95 is provided.

The protrusion portion 95 is formed, for example, by providing a recess portion in a region other than the peripheral portion of the support member 23 by an etching, a polishing method, or the like. In addition, as a method for forming the protrusion portion 95, besides the method described above, for example, lamination or welding of a resin may be performed on the peripheral portion of the support member 23 having an approximately flat primary surface to form the protrusion portion 95. In this case, as a material for the protrusion portion 95, the same material as that for the support member 23 may be used, or a different material may also be used. In addition, when a different material is used, a reflection function or a light shielding function, such as a black matrix, may be imparted to the protrusion portion 95.

The optical element 24 is bonded to the recess portion provided in the support member 23 at a bond portion 96 so that the structures 92 face the side opposite to the support member 23. In the example shown in FIG. 59A, the case is shown in which as the optical element 24, a lens film, such as a prism sheet in which the structures 92 are each formed to have a triangle cross-sectional shape, is used. In addition, besides the case described above, for example, a lens film in which the cross-sectional shape of the structure is formed to have a polygonal shape or a diffusion sheet in which the cross-sectional shape is formed to have a semispherical shape may be used. In addition, as the type of optical element 24 and the bonding method thereof, a similar type and method to those in the above first to third examples may be used.

When the optical element 24 is bonded to the recess portion of the support member 23, the protrusion portion 95 is formed so that the height thereof is larger than the height of the optical element 24. Accordingly, even when a plurality of the optical element laminates is stacked, the contact therebetween can be prevented and suppressed.

### (Fifth Example)

FIG. 59B shows a fifth example of the optical element laminate. This optical element laminate includes the support member 23, the bonding optical element 24 bonded to the primary surface of the support member 23, and the internal addition optical element 24 located between the support member 23 and the bonding optical element 24. In a region corresponding to the peripheral portion of the primary surface of the support member 23 to which the bonding optical element 24 is bonded, the protrusion portion 95 is provided, and in a region other than the peripheral portion of this primary surface, a recess portion is formed.

The internal addition optical element 24 is disposed to the recess portion of the support member 23, and at the bond portion 96 provided in a region corresponding to the protrusion portion 95 of the support member 23, the support member 23 and the bonding optical element 24 are bonded to each other. In the example shown in FIG. 59B, the case is shown in which as the bonding optical element 24, a lens film, such as a prism sheet in which the structures are each formed to have a triangle cross-section shape, is used. In addition, besides the case described above, for example, a lens film in which the cross-sectional shape of the structure is formed to have a polygonal shape or a diffusion sheet in which the cross-sectional shape is formed to have a semispherical shape may be used. In addition, as the type of optical element 24 and the bonding method thereof, a similar type and method to those in the above first to third examples may be used.

As the internal addition optical element 24, for example, an optical element, such as a diffusion sheet, a reflection type polarization sheet, or a polarization separation sheet, having a function different from that of the bonding optical element 24 may be used, or an optical element having the same function as that of the bonding optical element 24 may be used. In this example, although the internal addition optical element 24 is not bonded to the bonding optical element 24, bonding may be performed to one of the support member 23 and the bonding optical element 24 or may be performed to both of them.

In a region corresponding to the peripheral portion of the bonding optical element 24, the protrusion portion 93 protruding to the side opposite to the support member 23 is provided. The protrusion portion 93 is formed so that the height thereof is larger than the height of the bonding optical element 24. Accordingly, even when the optical element laminates are stacked, the contact therebetween can be prevented or suppressed.

### (Sixth Example)

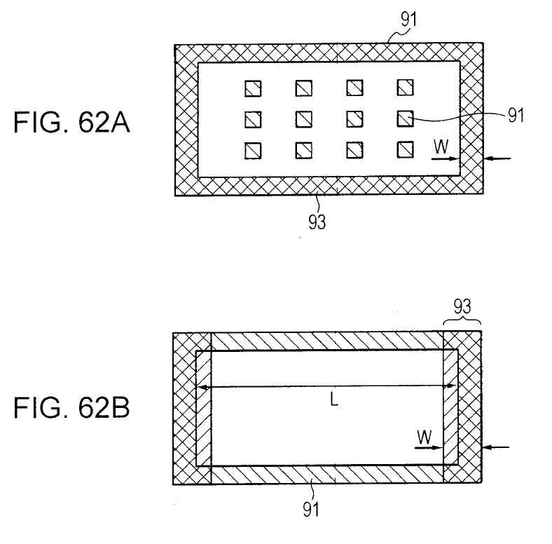

FIG. 60A shows a sixth example of the optical element laminate. This optical element laminate includes the support member 23 and the optical element 24 bonded to the primary surface of the support member 23. In a region corresponding to the peripheral portion of the primary surface of the support member 23 to which the optical element 24 is bonded, the protrusion portion 95 is provided, and a recess portion is formed in a region other than the peripheral portion of this primary surface.

The optical element 24 is bonded to the recess portion formed in the support member 23 with the bond portion 96 interposed therebetween so that the structures 92 face the support member 23 side. In the example shown in FIG. 60A, the case is shown in which as the optical element 24, a lenticular lens film is used in which the structures are each formed to have a semispherical cross-sectional shape. In addition, besides the case described above, for example, a lens film may be used in which the cross-sectional shape of the structure is formed to have a triangle, a polygonal, or an aspheric lens shape. In addition, as the type of optical element 24 and the bonding method thereof, a similar type and method to those in the above first to third examples may be used.

When the optical element 24 is bonded to the recess portion of the support member 23, the protrusion portion 95 is formed so that the height thereof is larger than the height of the optical element 24. Accordingly, even when the optical element laminates are stacked, the contact therebetween can be prevented or suppressed.

### (Seventh Example)

In FIG. 60B shows a seventh example of the optical element laminate. This optical element laminate includes the support member 23 and the optical element 24 bonded to the primary surface of the support member 23. In a region corresponding to the peripheral portion of the primary surface, which is different from the primary surface to which the optical element 24 is bonded, of the support member 23, the protrusion portion 95 is provided, and in the region other than the peripheral portion of this primary surface, a recess portion is formed.

The optical element 24 is bonded to the peripheral portion of the primary surface of the support member 23 at the bond portion 91 so that the structures 92 face the side opposite to the support member 23. In the example shown in FIG. 60B, the case is shown in which as the optical element 24, a lens film, such as a prism sheet in which the structures are each formed to have a triangle cross-sectional shape, is used. In addition, besides the case described above, for example, a lens film in which the cross-sectional shape of the structure is formed to have a polygonal shape or a diffusion sheet in which the cross-sectional shape is formed to have a semispherical shape may be used. In addition, as the type of optical element 24 and the bonding method thereof, a similar type and method to those in the above first to third examples may be used.

In a region corresponding to the peripheral portion of the optical element 24, the protrusion portion 93 protruding to the side opposite to the support member 23 is provided. Since this protrusion portion 93 and the protrusion portion 95 of the support member 23 are provided, when the optical element laminates are stacked, compared to the above fourth to sixth examples, the space between adjacent optical element laminates can be increased. That is, even when the optical element laminates are stacked, the contact therebetween can be more effectively prevented or suppressed.

In addition, although not being shown in the figure, as in the sixth example, it is needless to say that the optical element 24 may be bonded to the recess portion formed in the support member 23.

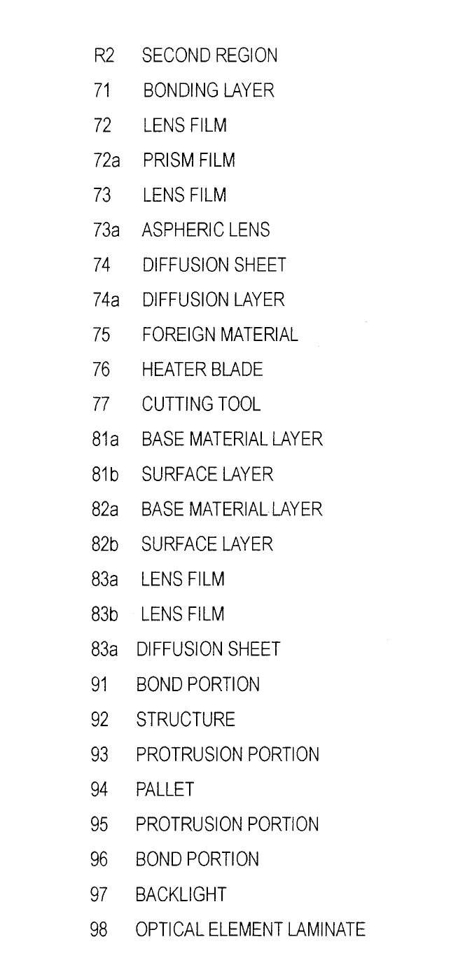

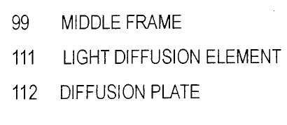

In addition, another example in which the protrusion portion 95 is directly provided on the support member 23 will be shown in FIGS. 67A and 67B. FIG. 67A shows an example in which cylindrical protrusion portions 95a are provided in the vicinity of at least one pair of facing sides of the rectangular support member 23. In the bonding optical element 24, opening portions 100 are provided so as to correspond to the protrusion portions 95a, and when the protrusion portions 95a are fixed to the opening portions 100 by insertion, an optical element laminate in which the bonding optical element 24 is bonded to the support member 23 can be obtained. The height of the protrusion portion 95a is larger than the thickness of the bonding optical element 24, and even when the optical element laminates thus formed are stacked to each other, the contact therebetween can be prevented or suppressed. In addition, the shape and the position of each of the protrusion portions 95a are not limited to those shown in the figure. For example, the protrusion portions 95a may be provided in the vicinity of at least one pair of adjacent sides of the rectangular support member 23.

FIG. 67B shows an example in which wedge-shaped protrusion portions 95b are provided in the vicinity of at least one pair of facing sides of the rectangular support member 23. The protrusion portions 95b are provided in a line along the pair of sides, and the structure is formed such that when the bonding optical element 24 is fitted therein while being slightly warped, the optical element 24 is fixed by the wedge shapes and is not easily disengaged. Furthermore, on the upper side protrusion portions 95b shown in FIG. 67B, cylindrical protrusion portions 95a corresponding to those in FIG. 67A are provided, and another bonding optical element 24 is engaged with the protrusion portions 95a in a manner similar to that described above. In addition, between the two bonding optical elements 24 at the upper side, since the space is present, another optical element 24 may also be disposed in this region (not shown in the figure).

An example in which a plurality of the optical element laminates 31 thus formed is stacked on the pallet 94 is shown in FIG. 67C. Since the protrusion portions 95a and the protrusion portions 95b are provided on the top and the bottom of each of the optical element laminates 31, the contact between the optical element laminates 31 can be more effectively prevented or suppressed. In addition, in the examples shown in FIGS. 67A to 67C, the support member 23, the protrusion portions 95a, and the protrusion portions 95b may be integrally formed or may be separately formed.

### [Placement of Protrusion Portion]

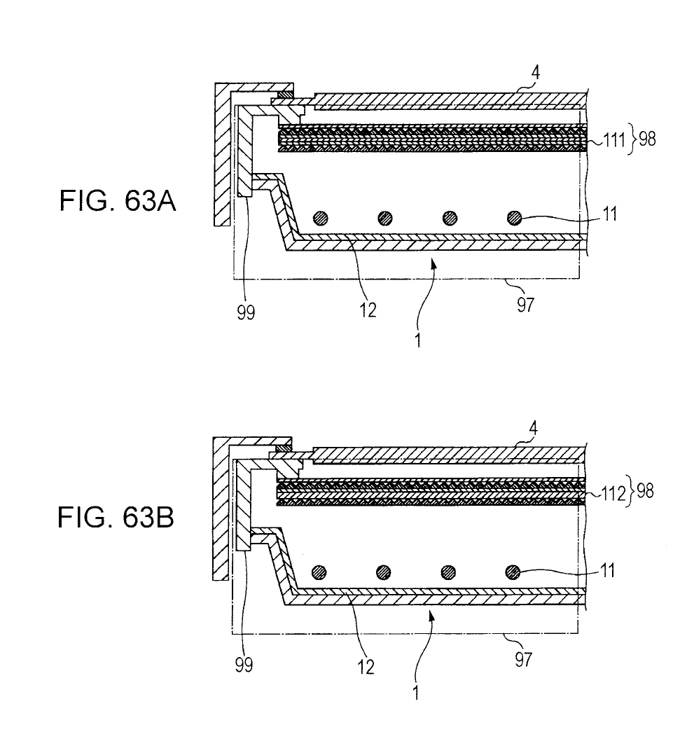

A position at which the protrusion portion 93 and/or the protrusion portion 95 is disposed will be described with reference to FIGS. 61A to 61D. FIG. 61A to 61D show examples in which the optical element laminate has a rectangular shape, and a portion shown by oblique lines indicates the protrusion portion 93 and/or the protrusion portion 95 provided for the optical element 24 and/or the support member 23.

### (First Example)

FIG. 61A shows a first example of the placement of the protrusion portion 93 and/or 95. In this first example, the protrusion portion 93 and/or 95 is provided along the four sides of the peripheral portion of the optical element 24 and/or the support member 23.

### (Second Example)

FIG. 61B shows a second example of the placement of the protrusion portion 93 and/or 95. In this second example, the protrusion portion 93 and/or 95 is provided along the facing two short sides of the four sides of the peripheral portion of the optical element 24 and/or the support member 23.

### (Third Example)

FIG. 61C shows a third example of the placement of the protrusion portion 93 and/or 95. In this third example, the protrusion portion 93 and/or 95 is provided along the facing two long sides of the four sides of the peripheral portion of the optical element 24 and/or the support member 23.

### (Fourth Example)

FIG. 61D shows a fourth example of the placement of the protrusion portion 93 and/or 95. In this fourth example, as the protrusion portion 93 and/or 95, a plurality of protrusion portions is intermittently provided along the four sides of the peripheral portion of the optical element 24 and/or the support member 23.

### [Positional Relationship Between Protrusion Portion and Bond Portion]

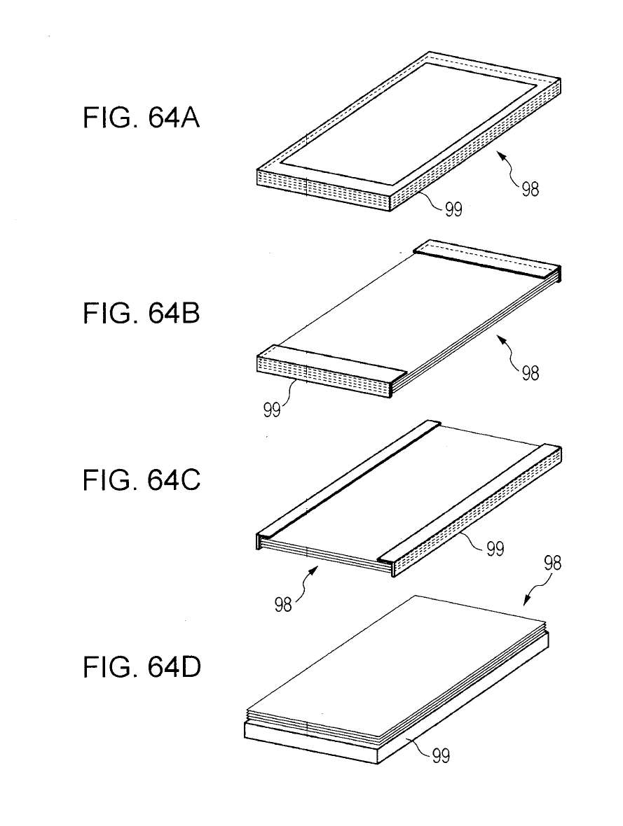

FIG. 62A shows one example of the positional relationship between the protrusion portion 93 and the bond portion 91. As shown in FIG. 62A, the bond portion 91 is formed in a region corresponding to the peripheral portion of the support member 23 (that is, a region corresponding to the protrusion portion 95). Furthermore, in the inside region surrounded by the peripheral portion of the support member 23, dot-shaped bond portions 91 may also be intermittently provided.

Since the bond portions 91 are provided along the peripheral portion and the inside of the support member 23, the bonding strength between the optical element 24 and the support member 23 can be increased. In addition, the position of the bond portion 91 along the peripheral portion is not limited to the four sides and may be provided, for example, along facing two long or short sides.

FIG. 62B shows another example of the positional relationship between the protrusion portion 93 and the bond portion 91. In the example shown in FIG. 62B, the width of the bond portion 91 is made different from that of the protrusion portion 93, and the width of the protrusion portion 93 is set larger than the width of the bond portion 91. Accordingly, when a plurality of optical element laminates is stacked, the stability can be further improved, and the contact between the optical element laminates can be more effectively prevented or suppressed.

In particular, when the width of the protrusion portion 93 is represented by W, and the width of the region in which the structures of the optical element 24 are provided in a long side direction is represented by L, the protrusion portion 93 is preferably set so as to satisfy the relation of “W≧L/100”. Accordingly, the width of the protrusion portion 93 can be sufficiently ensured, and even when a plurality of optical element laminates is stacked, stability can be further improved, and the contact between the optical element laminates can be more effectively prevented or suppressed.

### 18. Eighteenth Embodiment

As described above, if the saturated water absorption rate of the support member is high, when a lighting device (backlight) is turned on after being stored under high humid conditions, the support member is dried from the lighting device side by heat emitted therefrom and is warped in a direction toward a liquid crystal panel. By this warping, when part of the support member is brought into contact with the liquid crystal panel, the orientation condition of liquid crystal at the contact portion is damaged, and the polarized condition is changed; hence, oval-shaped white portions are generated as irregularities, and as a result, the display characteristics are degraded. In particular, concomitant with an increase in size and a decrease in thickness of a liquid crystal display device, this problem of oval-shaped irregularities is liable to occur.

In order to solve the problem as described above, in the above embodiments, when the optical element is laminated, the support member is used to maintain the strength of the optical element laminate; however, since the support member is also required to have a certain thickness, there is a limit to decrease the thickness of the optical element laminate. Hence, in an eighteenth embodiment, a middle frame is provided for holding by applying a predetermined tensile force to the optical element laminate so as to prevent oval-shaped irregularities.

### [Structure of Liquid Crystal Display Device]

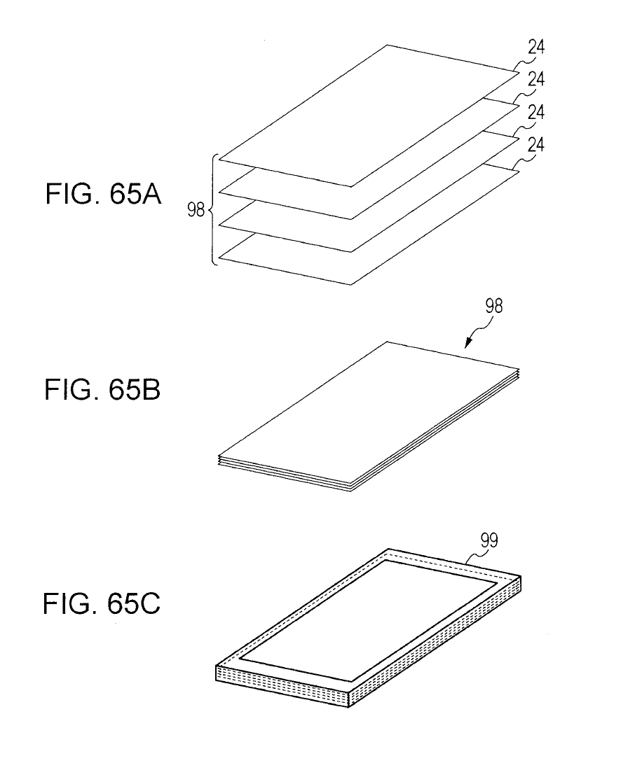

FIG. 63A shows one structural example of a liquid crystal display device according to the eighteenth embodiment of the present invention. In addition, portions corresponding to those in the above first embodiment will be described by using the same symbols. As shown in FIG. 63A, this liquid crystal display device includes a backlight 97 emitting light and the liquid crystal panel 4 displaying an image based on light emitted from the backlight 97. The backlight 97 includes the lighting device 1 emitting light, an optical element laminate 98 which improves characteristics of light emitted from the lighting device 1 and which emits light toward the liquid crystal panel 4, and a middle frame 99 supporting the optical element laminate 98 at the peripheral portion thereof.

### [Lighting Device]

The lighting device 1 is, for example, a direct type lighting device and includes at least one light source 11 emitting light and the reflection plate 12 which reflects light emitted from the light source 11 in a direction toward the liquid crystal panel 4. As the light source 11, for example, a cold cathode fluorescent lamp (CCFL), a hot cathode fluorescent lamp (HCFL), organic electroluminescence (OEL), inorganic electroluminescence (IEL), a light emitting diode (LED), or the like may be used. The reflection plate 12 is provided, for example, so as to cover the bottom and the side portions of the at least one light source 11 and is configured to reflect light in a direction toward the liquid crystal panel 4 which is emitted from the at least one light source 11, for example, to the bottom and the side portions.

### [Optical Element Laminate]

The optical element laminate 98 is a laminate formed by laminating at least one optical element 24, and instead of the diffusion plate 23a (support member 23) of the optical element laminate 21 of the first embodiment, a light diffusion element 111 in the form of a sheet or a film is used. Since the light diffusion element 111 is used instead of the diffusion plate 23a having a certain thickness and weight as described above, the thickness and the weight of the optical element laminate 98 can be reduced, and in addition, the manufacturing cost thereof can also be reduced.

The number and the type of optical elements 24 are not particularly limited and can be appropriately selected in accordance with characteristics of a desired liquid crystal display device. As the optical element 24, for example, a material composed at least one functional layer can be used. The optical element 24 is formed of a resin, such as a polycarbonate (PC), a poly(methyl methacrylate) (PMMA), a poly(ethylene terephthalate) (PET), a poly(ethylene naphthalate) (PEN), a polypropylene (PP), or a styrene.butadiene.copolymer (SBC). As the optical element 24, for example, a prism film, a diffusion film, a lenticular lens film, an aspheric lens film, or a reflection polarization film may be used.

In addition, the optical element laminate 98 is not limited to the example described above, and for example, as shown in FIG. 63B, instead of the light diffusion element 111, a diffusion plate 112 having a thickness smaller than that of the conventional diffusion plate 23a may also be used.

In addition, between the optical element laminate 98 and the liquid crystal panel 4, another optical element 24 may be further provided. As this optical element 24, for example, a prism film, a diffusion film, a lenticular lens film, an aspheric lens film, or a reflection polarization film may be used.

### [Middle Frame]

The middle frame 99 is formed of a resin, such as a polycarbonate (PC), an acrylonitrile.butadiene.styrene (ABS), a glass fiber, or carbon. The middle frame 99 is preferably formed of a resin having light shielding properties. The reason for this is that since the middle frame 99 has light shielding properties, light leakage from the lighting device 1 can be prevented.

The middle frame 99 is bonded to the optical element laminate 98 at least at facing side portions of the periphery of the optical element laminate 98 and functions as a support body supporting the optical element laminate 98. As a bonding method, for example, thermal welding, ultrasonic welding, laser welding, pressure bonding, an adhesive, or adhesion using an adhesive tape or the like may be mentioned. The optical element laminate 98 is preferably supported in the state in which a predetermined tensile force is applied in the in-plane direction of the optical element laminate 98 and also in directions opposite to each other. In particular, the bonding is preferably performed by a tensile force, for example, of 9.2 N or more and more preferably 23 N or more.

In addition, in the above example, the case is described in which the optical element laminate 98 formed of a plurality of optical elements 24 is used; however, instead of using the optical element laminate 98, one optical element 24 may also be used. In addition, when one optical element 24 is used, at least one another optical element may also be provided thereunder. The another optical element provided in this case is bonded at least at the end portion thereof to the optical element 24 or the middle frame 99.

### [Bonding Position of Optical Element Laminate and Middle Frame]

### (First Example)

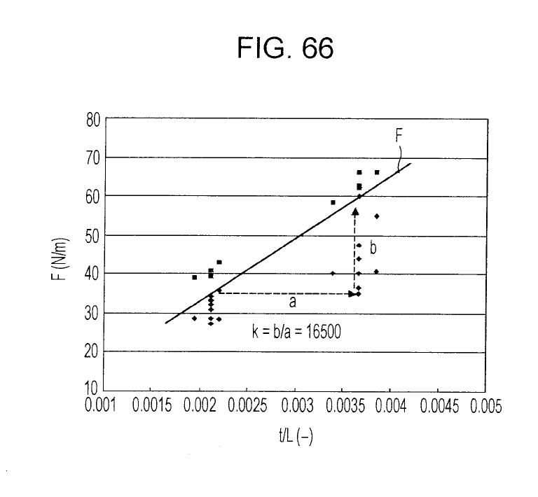

FIG. 64A shows a first example of the bonding position of the optical element laminate 98 and the middle frame 99. In this first example, the middle frame 99 is bonded to all the four sides of the emission surface (first primary surface) of the optical element laminate 98 having a rectangular shape.

### (Second Example)

FIG. 64B shows a second example of the bonding position of the optical element laminate 98 and the middle frame 99. In this second example, the middle frame 99 is bonded to the facing two short sides of the periphery of the emission surface (first primary surface) of the optical element laminate 98 having a rectangular shape.

### (Third Example)

FIG. 64C shows a third example of the bonding position of the optical element laminate 98 and the middle frame 99. In this third example, the middle frame 99 is bonded to the facing two long sides of the periphery of the emission surface (first primary surface) of the optical element laminate 98 having a rectangular shape.

The bonding position of the optical element laminate 98 and the middle frame 99 is not limited to the first to the third examples, and for example, the middle frame 99 may be bonded to three sides of the periphery of the emission surface (first primary surface) of the optical element laminate 98 having a rectangular shape.

In addition, for example, as shown in FIG. 64D, the periphery of the incident surface (second primary surface) of the optical element laminate 98 may be bonded to the upper side of the middle frame 99.

### [Method for Forming Liquid Crystal Display Device]

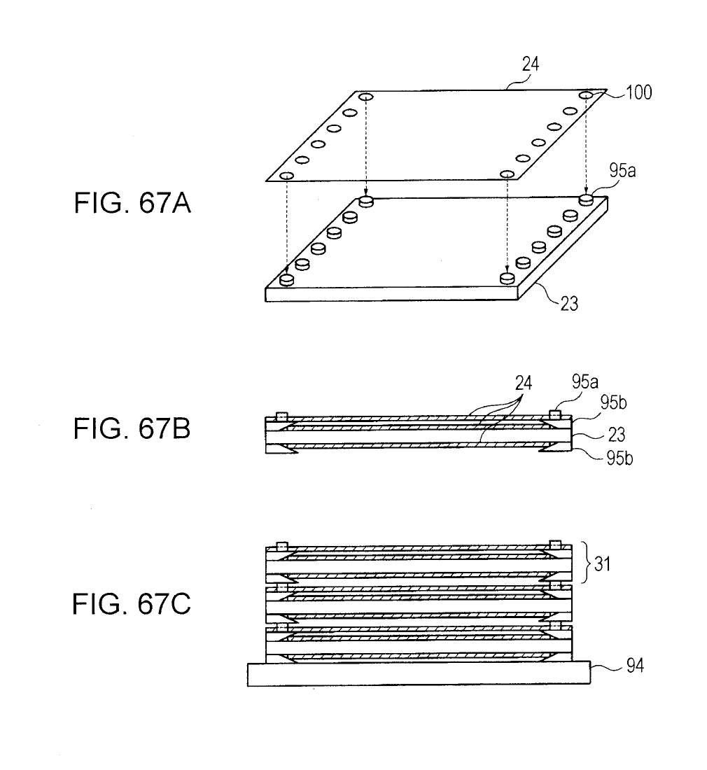

FIGS. 65A to 65C show one example of a method for forming a liquid crystal display device. When a liquid crystal display device is formed, as shown in FIG. 65A, a plurality of optical elements 24 is overlapped with and bonded to each other, so that as shown in FIG. 65B, the optical element laminate 98 is formed. While a predetermined tensile force is applied to the optical element laminate 98 thus formed in the in-plane direction and also in directions opposite to each other, as shown in FIG. 65C, the peripheral portion of the optical element laminate 98 and the middle frame 99 are bonded to each other. As a result, the liquid crystal display device is formed. In addition, the middle frame 99 may be integrated with a housing of the backlight 97 or may be provided separately therefrom.

In the case described above, the distance between the liquid crystal panel 4 and the surface of the optical element laminate 98 at the emission surface (first primary surface) side which is bonded to the middle frame 99 is set to, for example, 6 mm or less and preferably set to, for example, 1 to 2 mm. Accordingly, the thickness of the liquid crystal display device can be further decreased.

When the middle frame 99 is separately formed from the housing of the backlight 97, for example, the middle frame 99 is disassembled therefrom in advance, and the optical element laminate 98 is bonded to facing two sides thereof. Next, while a tensile force is applied to the middle frame 99 to which the optical element laminate 98 is bonded, the middle frame 99 is fitted in the housing of the backlight 97.

In addition, for example, the optical element laminate 98 may be bonded to the middle frame 99 while a tensile force is applied to the optical element laminate 98, and while a tensile force is applied to the optical element laminate 98, the middle frame 99 may be fitted in the housing of the backlight 97.

As described above, in the eighteenth embodiment of the present invention, since the peripheral portion of the optical element laminate 98 is supported by the middle frame 99 while the tensile force is applied, the optical element laminate can be prevented from being brought into contact with the liquid crystal panel, and hence oval-shaped irregularities can be reduced.

In addition, since the optical element laminate 98 is bonded to the middle frame 99, the support member 23 having a certain thickness and weight can be omitted; hence, the thickness and the weight of the liquid crystal display device can be reduced, and the manufacturing cost thereof can also be reduced.

### EXAMPLES

Hereinafter, although the present invention will be particularly described with reference to the examples, the present invention is not limited only to those examples.

### <1. Investigation of Optical Element Package>

### <1-1. Relationship Between Tensile Force of Packaging Member and Warpage of Optical Element Package>

First, the relationship between the tensile force of a packaging member and the warpage of an optical element package was investigated.

### (Sample 1)

First, optical elements and a support member shown below were prepared. In addition, the optical elements and the support member were for a 32-inch size television and had a size of 410 mm×710 mm.

Reflection type polarizer (DBEFD, manufactured by 3M Corp. (thickness: 400 μm))
Lens sheet (Lens, hyperboloid shape by PC melt extrusion molding, pitch 200 μm, manufactured by SONY Corp. (thickness: 500 μm))
Diffusion sheet (BS-912, manufactured by Keiwa Inc. (205 WO)
Diffusion plate (polycarbonate, manufactured by Teijin Chemicals Ltd. (thickness: 1,500 μm)
Light control film (irregularity resolving film, hyperboloid shape by PC melt extrusion molding, pitch 200 μm, thickness: 200 μm)

Next, on the light control film, the diffusion plate, the diffusion sheet, the lens sheet, and the reflection type polarizer were placed in that order, so that an optical element laminate was obtained. Next, an original polyethylene film having a heat contractive property was prepared, and two rectangular films were cut out of this original film. In this step, the long side of the rectangular film and the orientation axis thereof were made to form an angle of 1°.

Next, the two films were overlapped with each other so that the angle between their orientation axes was 2°, and three sides except one long side were thermal-welded, so that a bag-shaped packaging member was obtained. Next, the above optical element laminate was inserted form the opened long side. Next, the opened long side was thermal-welded to seal the packaging member, so that the optical element package was obtained. In addition, the thermal welding was performed by heating the periphery of the packaging member at 220° C. for 2 seconds. Subsequently, openings were formed at positions corresponding to corner portions of the packaging member. Next, the optical element package was transported to an oven, and the packaging member was contracted in an environment at a temperature of 105° C. Accordingly, the optical element laminate and the packaging member were brought into close contact with each other, and in addition, corner portions of the optical element laminate were exposed through the openings provided at the corner portions of the packaging member.

As a result, a targeted optical element package could be obtained.

### (Samples 2 to 7)

Except that a packaging member formed of films of a polyolefin A (PP/PE base) and a polyolefin B (PP/PE base) was used as shown in the following Table 1 and that a contraction margin of the packaging member was set to the value shown in the following Table 1, an optical element package was obtained in a manner similar to that of Sample 1.

### (Samples 8 to 10)

Except that a packaging member formed of films of a polyolefin (PE base) and the polyolefin A (PP/PE base) was used as shown in the following Table 1 and that the size of the diffusion plate was changed to have a thickness of 0.002 m, a long side of 0.91 m, and a short side of 0.52 m, an optical element package was obtained in a manner similar to that of Sample 1.

### (Samples 11 and 12)

Except that a packaging member formed of films of the polyolefin A (PP/PE base) and the polyolefin B (PP/PE base) was used as shown in the following Table 1 and that the size of the diffusion plate was changed to have a thickness of 0.002 m, a long side of 1.03 m, and a short side of 0.59 m, an optical element package was obtained in a manner similar to that of Sample 1.

### (Samples 13 to 16)

Except that a packaging member formed of films of the polyolefin A (PP/PE base) and the polyolefin B (PP/PE base) was used as shown in the following Table 1, that no opening portions were provided at the corner portions of the packaging member, and that corner portions of the support member each had an R1 shape, an optical element package was obtained in a manner similar to that of Sample 1.

### (Temperature Measurement in Actual TV)

The temperature on the optical element package at the light source side in an actual TV was measured by a thermocouple. According to the results obtained by measuring 9 points in the plane, when lighting was performed at an ordinary temperature of 25° C., the temperature was increased up to approximately 67° C. and was then maintained, and even when lighting was performed in an environment at a temperature of 50° C., the temperature was increased up to approximately 70° C. and was then maintained. At a temperature of 50° C., it was designed that the temperature did not exceed 70° C. by operation of circuit security, and by evaluation of the packaging member at a temperature of 70° C., measurements of the tensile force and the like were carried out.

### (Measurement of Tensile Force of Packaging Member)

By using a TMA (heat•stress•strain measurement apparatus EXSTAR6000 TMA/SS) manufactured by Seiko Inc., the tensile force of the packaging member was measured as described below.

First, in the state in which a tensile force was applied to the packaging member, a test piece having a size of 5 mm×50 mm was cut out by a rectangular die from the central portion of the optical element package. In this step, the test piece was cut out so that the long side and the short side thereof were parallel to the long side and the short side, respectively, of the diffusion plate used as the support member. Next, after the test piece was sandwiched by glass plates so as not to sag, the length was measured by a toolmaker's microscope manufactured by Topcon Corp. Since the test piece thus cut out was placed in a state free from the tensile force, the test piece was in a contracted state smaller than a length of 50 mm. Dimensional conversion was performed so that this contracted state was returned to the original state of a length of 50 mm, and a test piece was again cut out for a TMA and was then set therein. Next, the tensile force at an initial temperature of 25° C. was measured, and the temperature was increased to 100° C., so that the tensile force at 70° C. was measured. In this step, the temperature of 70° C. was an air temperature in the vicinity of the test piece. The results are shown in Table 2 and FIG. 66.

In addition, in FIG. 66, a linear line F indicates a linear line represented by F=1.65×10⁴×t/L. The amount of change a indicates the amount of change of t/L (where, t: the thickness of the side of the support member, L: the length of the side of the support member), and the amount of change b indicates the amount of change of the tensile force F with respect to this amount of change a. The value k indicates the ratio b/a, that is, the slope of the above linear line. In addition, a mark “▪” indicates an actual measurement value F (tensile force) which does not satisfy the relationships of the expressions (2) and (3), and a mark “♦” indicates an actual measurement value F (tensile force) which satisfies the relationships of the expressions (2) and (3).

### (Method for Calculating Tensile Force of Packaging Member)

The tensile forces of Samples 1 to 16 were calculated by using the above expressions (2) and (3) as described below. The results are shown in Table 2.

### Samples 1 to 7, Samples 13 to 16 (32 Inches)

F1=1.65×10⁴×0.0015/0.71=34.9

F2=1.65×10⁴×0.0015/0.41=60.4

Samples 8 to 10 (40 inches)

F1=1.65×10⁴×0.002/0.91=36.3

F2=1.65×10⁴×0.002/0.52=63.5

Samples 11 and 12 (46 inches)

F1=1.65×10⁴×0.002/1.03=32.0

F2=1.65×10⁴×0.002/0.59=55.9

### (Measurement of Tensile Force of Packaging Member)

First, a test piece was cut out by a die having a size of 5×50 mm so as to cross a sealed portion of the optical element package, and a test piece for the above TMA was again cut out and was set therein. Next, after the tensile force of the test piece at an initial and ordinary temperature of 25° C. was measured, the temperature was increased to 70° C., and the tensile force of the test piece at a temperature of 70° C. was measured.

### (Measurement of Warpage of Packaging Member)

A sample thus formed was placed on a bottom plate, and the maximum warpage was obtained by measuring warpage at each of four corners using a metal ruler. The results are shown in Table 2.

### (Mounting Test Evaluation)

As a mounting evaluation apparatus, a 32-inch liquid crystal television (manufactured by Sony Corp., trade name: LCDTV-J3000), a 40-inch liquid crystal television (manufactured by Sony Corp., trade name: LCDTV-J3000), and a 46-inch liquid crystal television (manufactured by Sony Corp., trade name: LCDTV-V2500) were prepared. Next, after a diffusion plate, a diffusion sheet, a prism sheet, and a reflection type polarization sheet, which were optical elements of a backlight unit of the above liquid crystal television, were removed, the optical element package of each of Samples 1 to 16 was again mounted, and the appearance evaluation of the panel display was performed in accordance with the following criteria. The results are shown in Table 2.

5: No luminance irregularities at a front side and at a viewing angle of 60°.
4: No luminance irregularities at a front side, and extremely slight irregularities at a viewing angle of 60°.
3: Extremely slight luminance irregularities at a front side, and slight irregularities at a viewing angle of 60°.
2: Slight irregularities at a front side, and irregularities at a viewing angle of 60°.
1: Apparent luminance irregularities at a front side and at a viewing angle of 60°.
In addition, at a level of “3” or above, characteristics which cause no practical problems can be obtained.

### (Evaluation of Creaking Noises)

After a TV in which the optical element package was mounted was turned on and was stored for 2 hours in an environment at a temperature of 25° C., the generation of creaking noises was evaluated for 1 hour after the TV was turned off. In particular, the measurement environment was set to 25 dB or less, and a maximum noise of 40 dB or more and a maximum noise of less than 40 dB were evaluated as “generation of creaking noises” and “generation of creaking noises”, respectively. In addition, for the measurement, NL-32 manufactured by Rion Co., Ltd. was used. The results are shown in Table 2.

TABLE 1

| | | Packaging member | | | | | | | | |
|---|---|---|---|---|---|---|---|---|---|---|
| | | | Support | | | | Support member | | Size of support | |
| | | | member | | Contraction margin | | | Corner | member | |
| | | | Corner | Thickness | Long side | Short side | Thickness | portion | Long side | Short side |
| Sample | Material | Entire Shape | portion | (μm) | (mm) | (mm) | (m) | shape | (m) | (m) |
| Sample 1 | Polyolefin (PE base) | 6-surface bag | C6 open | 30 | 70 | 76 | 0.0015 | R6 | 0.71 | 0.41 |
| Sample 2 | Polyolefin A (PP/PE base) | 6-surface bag | C6 open | 30 | 40 | 23 | 0.0015 | R6 | 0.71 | 0.41 |
| Sample 3 | Polyolefin A (PP/PE base) | 6-surface bag | C6 open | 30 | 43 | 25 | 0.0015 | R6 | 0.71 | 0.41 |
| Sample 4 | Polyolefin A (PP/PE base) | 6-surface bag | C6 open | 30 | 38 | 9 | 0.0015 | R6 | 0.71 | 0.41 |
| Sample 5 | Polyolefin A (PP/PE base) | 6-surface bag | C6 open | 30 | 32 | 8 | 0.0015 | R6 | 0.71 | 0.41 |
| Sample 6 | Polyolefin A (PP/PE base) | 6-surface bag | C6 open | 30 | 32 | 5 | 0.0015 | R6 | 0.71 | 0.41 |
| Sample 7 | Polyolefin B (PP/PE base) | 6-surface bag | C6 open | 50 | 67 | 33 | 0.0015 | R6 | 0.71 | 0.41 |
| Sample 8 | Polyolefin (PE base) | 6-surface bag | C6 open | 30 | 81 | 85 | 0.002 | R6 | 0.91 | 0.52 |
| Sample 9 | Polyolefin A (PP/PE base) | 6-surface bag | C6 open | 30 | 46 | 16 | 0.002 | R6 | 0.91 | 0.52 |
| Sample 10 | Polyolefin A (PP/PE base) | 6-surface bag | C6 open | 30 | 37 | 6 | 0.002 | R6 | 0.91 | 0.52 |
| Sample 11 | Polyolefin A (PP/PE base) | 6-surface bag | C6 open | 30 | 63 | 33 | 0.002 | R6 | 1.03 | 0.59 |
| Sample 12 | Polyolefin B (PP/PE base) | 6-surface bag | C6 open | 50 | 62 | 56 | 0.002 | R6 | 1.03 | 0.59 |
| Sample 13 | Polyolefin A (PP/PE base) | 6-surface bag | C6 open | 30 | 39 | 18 | 0.0015 | R1 | 0.71 | 0.41 |
| Sample 14 | Polyolefin A (PP/PE base) | 6-surface bag | C6 open | 30 | 32 | 5 | 0.0015 | R1 | 0.71 | 0.41 |
| Sample 15 | Polyolefin A (PP/PE base) | 6-surface bag | No open | 30 | 41 | 20 | 0.0015 | R1 | 0.71 | 0.41 |
| Sample 16 | Polyolefin A (PP/PE base) | 6-surface bag | No open | 30 | 31 | 8 | 0.0015 | R1 | 0.71 | 0.41 |

TABLE 2

| | Warping suppression | | Actual measurement value of | | Warpage of | Mounting | |
|---|---|---|---|---|---|---|---|
| | calculated value | | tensile force at 70° C. | | optical element | appearance of | Generation of |
| | Long side | Short side | Long side | Short side | package | liquid crystal | creaking noises |
| Sample | direction (N/m) | direction (N/m) | direction (N/m) | direction (N/m) | Warpage (mm) | display device | (40 dB or more) |
| Sample 1 | 34.9 | 60.4 | 27.3 | 35.1 | 9 | 5 | No |
| Sample 2 | 34.9 | 60.4 | 32.2 | 40.3 | 11 | 5 | No |
| Sample 3 | 34.9 | 60.4 | 28.7 | 36.6 | 6 | 5 | No |
| Sample 4 | 34.9 | 60.4 | 34.4 | 60.1 | 16 | 4 | No |
| Sample 5 | 34.9 | 60.4 | 39.4 | 62.8 | 22 | 2 | No |
| Sample 6 | 34.9 | 60.4 | 39.4 | 66 | 24 | 2 | No |
| Sample 7 | 34.9 | 60.4 | 33.3 | 62.4 | 27 | 2 | Yes |
| Sample 8 | 36.3 | 63.5 | 28.5 | 40.8 | 13 | 5 | No |
| Sample 9 | 36.3 | 63.5 | 35.8 | 55 | 17 | 4 | No |
| Sample 10 | 36.3 | 63.5 | 43 | 66 | 27 | 2 | Yes |
| Sample 11 | 32.0 | 55.9 | 28.7 | 40.3 | 11 | 5 | No |
| Sample 12 | 32.0 | 55.9 | 38.9 | 58.3 | 24 | 2 | Yes |
| Sample 13 | 34.9 | 60.4 | 33 | 47.6 | 12 | 5 | No |
| Sample 14 | 34.9 | 60.4 | 39.4 | 66 | 21 | 2 | No |
| Sample 15 | 34.9 | 60.4 | 30.8 | 44 | 7 | 5 | No |
| Sample 16 | 34.9 | 60.4 | 40.8 | 62.3 | 23 | 2 | No |

In Table 1, “Polyolefin A”, “Polyolefin B”, “C6 open”, and “Contraction margin” indicate as follows.

Polyolefin A: a heat contractive film of a multilayer structure of polypropylene/(polypropylene+polyethylene)/polypropylene having a thickness of 30 μm.

Polyolefin B: a heat contractive film of a multilayer structure of polypropylene/(polypropylene+polyethylene)/polypropylene having a thickness of 50 μm.

“C6 open”: a chamfered corner portion of the packaging member having a surface chamfered between two points each 6 mm apart from the corner.

“Contraction margin”: a numerical value indicating the difference in size between the support member and the packaging member and including no welded portion.

From Tables 1 and 2, the following can be understood.

First, as for Samples 1 to 7 and 13 to 16 for the 32-inch size, when the surface tensions F1 and F2 of the packaging member at a temperature of 70° C. result in F1>34.9 and F2>60.4, the warpage increases, and in the mounting test evaluation, the image quality is liable to be degraded.

Next, as for Samples 8 to 10 for the 40-inch size, when the surface tensions F1 and F2 of the packaging member at a temperature of 70° C. result in F1>36.3 and F2>63.5, the warpage increases, and in the mounting test evaluation, the image quality is liable to be degraded.

Next, as for Samples 11 and 12 for the 46-inch size, when the surface tensions F1 and F2 of the packaging member at a temperature of 70° C. result in F1>32.0 and F2>55.9, the warpage increases, and in the mounting test evaluation, the image quality is liable to be degraded.

Accordingly, when the tensile forces at 70° C. are more than the numerical values defined by the above expressions (2) and (3), the warpage increases, and in the TV mounting test, the image quality is liable to be degraded. In addition, also in the case in which evaluation is performed by changing the size of TV, when the above numerical values are exceeded, the warping is liable to occur, and the TV image quality is liable to be degraded.

The reason for this is estimated that in the state in which the diffusion plate used as the support member is liable to be softened at a high temperature of 70° C., the tensile force of the packaging member has an effect of applying a stress to the support member in the contraction direction, and the warping is generated thereby.

### <1-2. Relationship Between Crystal Axis of Packaging Member and Warpage of Optical Element Package>

Next, the relationship between the crystal axis of the packaging member and the warpage of the optical element package was investigated.

### (Sample 17)

An optical element package was obtained in a manner similar to that of Sample 1.

### (Samples 18 to 20)

Except that when rectangular films were each cut out of the original film, the angle formed between the long side and the orientation axis of this rectangular film was set to 3.5°, 8°, or 12°, an optical element package was obtained in a manner similar to that of Sample 1.

### (Samples 21 to 24)

Except that as a film forming the optical element package, a film of the polyolefin A was used, and that when rectangular films were each cut out of the original film, the angle formed between the long side and the orientation axis of this rectangular film was set to 1.2°, 3°, 7°, or 10°, an optical element package was obtained in a manner similar to that of Sample 1.

### (Measurement of Orientation Axis)

The orientation axes of the packaging members of Samples 17 to 24 obtained as described above were measured as follows. First, a square shape having a size of 100 mm×100 mm was cut out of the packaging member parallel to the support member of the optical element package, so that a test piece was obtained. Next, by using a retardation measurement device manufactured by Otsuka Electronics Co., Ltd., the oblique angle of the orientation axis with respect to the end portion of the test piece was measured. The results are shown in Table 3.

### (Evaluation of Warpage of Optical Element Package)

After the optical element package formed for each of the 32-inch size (Samples 1 to 7, and 13 to 16), the 40-inch size (Samples 8 to 10), and the 46-inch size (Samples 11 and 12) was mounted on a backlight used for a television manufactured by Sony Corp., and the backlight was turned on for 1 hour, the warpage of the optical element package was measured using a metal ruler. In addition, the warpage thus measured was evaluated in accordance with the following 3 stages. The results are shown in Table 3.

3: Warpage of less than 10 mm.
2: Slight warpage (10 mm to less than 20 mm).
1: Warpage of 20 mm or more.
In addition, at a level of “2” or above, characteristics which cause no practical problems can be obtained.

### (Evaluation of Appearance)

As in the above Sample 1, the appearance of the optical element package was evaluated. The results are shown in Table 3.

TABLE 3

| | | Gap of crystal axis | | | | Mounting |
|---|---|---|---|---|---|---|
| | | (orientation axis) of | Warpage of | Appearance of | | appearance of |
| | | packaging member | optical element | optical element package | | liquid crystal |
| Sample | Material | to inclusions | package (mm) | (—) | | display device |
| Sample 17 | Polyolefin (PE base) | 1 | 0.5 | 3 | Good | 5 |
| Sample 18 | Polyolefin (PE base) | 3.5 | 1 | 3 | Good | 5 |
| Sample 19 | Polyolefin (PE base) | 8 | 2 | 2 | Slight slack at corner portions | 4 |
| Sample 20 | Polyolefin (PE base) | 12 | 4 | 1 | Sag at corner portions | 2 |
| Sample 21 | Polyolefin A (PP/PE base) | 1.2 | 0.5 | 3 | Good | 5 |
| Sample 22 | Polyolefin A (PP/PE base) | 3 | 1 | 3 | Good | 5 |
| Sample 23 | Polyolefin A (PP/PE base) | 7 | 1 | 2 | Slight slack at corner portions | 4 |
| Sample 24 | Polyolefin A (PP/PE base) | 10 | 2 | 1 | Sag at corner portions | 2 |

From Table 3, the following can be understood.

When the angles formed between the crystal axes in the first region and the second region of the packaging member and the side surface of the support member are set in the range of 1° to 8°, the warping of the optical element package can be suppressed, and in addition, generation of sags, irregularities, and wrinkles caused by the packaging member can be performed.

### 1-3. Relationship Between Tensile Force of Sealed Portion and Tensile Force of Packaging Member

Next, the relationship between the tensile force of a sealed portion and the tensile force of the packaging member was investigated.

### (Sample 25)

An optical element package was obtained in a manner similar to that of Sample 2.

### (Sample 26)

Except that thermal welding was performed by heating the periphery of the packaging member at 220° C. for 1 second, an optical element package was obtained in a manner similar to that of Sample 25.

### (Sample 27)

Except that thermal welding was performed by heating the periphery of the packaging member at 220° C. for 0.5 seconds, an optical element package was obtained in a manner similar to that of Sample 25.

### (Measurement of Seal Tensile Stress)

First, a test piece was cut out by a die having a size of 5×50 mm so as to cross the sealed portion of the optical element package, and a test piece for the above TMA was again cut out and was set therein. Next, after the tensile force of the test piece at an initial and ordinary temperature of 25° C. was measured, the temperature was increased to 70° C., and the tensile force of the test piece at a temperature of 70° C. was measured. The results are shown in Table 4.

### (Appearance Evaluation in High Temperature Storage)

The optical element package was stored in a dry environment at 70° C. for 500 hours, and the change in appearance was confirmed. The results are shown in Table 4.

TABLE 4

| | | | Tensile force of sealed | | | | Tensile force of optical | | | | |
|---|---|---|---|---|---|---|---|---|---|---|---|
| | | | portion (N/m) | | | | element package (N/m) | | | | 70° C. × |
| | | | 25° C. | | 70° C. | | 25° C. | | 70° C. | | 500H |
| Sample | Material | Sealing method | MD | TD | MD | TD | MD | TD | MD | TD | Appearance |
| Sample 25 | Polyolefin A (PP/PE base) | 220° C. × 2 sec heating | 454 | 917 | 156 | 320 | 99 | 71.3 | 33.7 | 40.3 | No abnormal |
| | | | | | | | | | | | event |
| Sample 26 | Polyolefin A (PP/PE base) | 220° C. × 1 sec heating | 204 | 393 | 70 | 125 | | | | | No abnormal |
| | | | | | | | | | | | event |
| Sample 27 | Polyolefin A (PP/PE base) | 220° C. × 0.5 sec heating | 89 | 165 | 28 | 56 | | | | | Damaged |
| | | | | | | | | | | | end portion |

From Table 4, the following can be understood.

When the tensile force F of the sealed portion is smaller than the tensile force F of the packaging member, in a high temperature storage, the sealed portion is peeled off, and the packaging member may be damaged in some cases. Hence, the tensile force F of the sealed portion is preferably set larger than the tensile force F of the packaging member.

### <2. Investigation on Optical Element Laminate>

### <2-1. Relationship Between Tensile Force of Bonding Optical Element and Appearance of Optical Element Laminate>

Next, by changing the tensile force of the bonding optical element, the relationship between the tensile force of the bonding optical element and the appearance of the optical element laminate was investigated.

### (Sample 28)

First, as a diffusion film and a lens sheet, each functioning as the optical element, and a diffusion plate functioning as the support member, the following were prepared.

Diffusion plate: manufactured by Entire, trade name EMS-70G, (thickness of 2.0 mm, base material layer (core layer): PS layer, surface layer (skin layer): MS resin layer containing 60 mass percent of PMMA).
Diffusion film: manufactured by Keiwa Inc., trade name: BS912.
Lens film (for emission surface side): a lens sheet in which triangle prism shapes are formed on the surface of a PC film having a thickness of 80 μm.
Lens film (for incident surface side): a lenticular sheet in which semicylindrical lens shapes (lenticular lenses) are formed on the surface of a PC film having a thickness of 80 μm.

Next, the optical element laminate was formed as described below.

First, on the emission surface of the rectangular diffusion plate functioning as the support member, the rectangular diffusion film functioning as the internal addition optical element was placed. Subsequently, the rectangular lens film functioning as the bonding optical element was placed on the emission surface of the diffusion plate so as to cover the diffusion film. Next, while tensile forces are applied in the width direction (short side direction) and the long side direction of the diffusion plate and also in the in-plane direction thereof, the lens film was bonded to all the four side portions of the diffusion plate by welding. Next, on the incident surface of the diffusion plate, the lens film functioning as the bonding optical element was placed. Subsequently, while tensile forces are applied in the width direction (short side direction) and the long side direction of the diffusion plate and also in the in-plane direction thereof, the lens film was bonded to all the four side portions of the diffusion plate by welding.

As a result, a targeted optical element laminate was obtained.

### (Evaluation of Tensile Force)

Next, the tensile force of the lens film of the optical element laminate obtained as described above was measured as described below. By using a die having a predetermined size (for example, 15×130 mm), the bonding optical element is punched out of the optical element laminate to which the tensile force is applied. Although the tensile force is applied before the punching, the tensile force is released after the punching, and hence the tensile force can be obtained from the amount of change in size of the optical element before and after the punching. That is, (tensile force)=(amount of change)×(Young's modulus)×(length of optical element laminate) can be satisfied. In this case, for the measurement of the amount of change, a high-precision automatic measurement device (DR-5500 manufactured by Dainippon Screen MFG. Co., Ltd.) was used.

### (Evaluation of Appearance)

In addition, as described above, while the tensile force was applied, the appearance of the optical element laminate was observed, and the appearance was evaluated in accordance with the following criteria.

⊚: a level which indicates that when mounting is performed in a liquid crystal display device, and when entire-screen white display is performed, no shade can be confirmed even if the display is viewed at an oblique angle.
◯: a level which indicates that although shade is confirmed when the display is viewed at an oblique angle, it does not cause any strange feeling, and in other words, the level indicating that shade is first recognized when at least nine out of ten persons point out the presence of shade.
x: a level which indicates that shade caused by film warping can be confirmed when the display is viewed at an oblique angle.

Table 5 shows the measurement results of the elongation amount and the tensile force of the lens film of Sample 28, and the evaluation results of the appearance thereof.

TABLE 5

| | Elongation | | Required shear | |
|---|---|---|---|---|
| | amount (mm) | Tensile force (N) | tensile strength (N/15 mm) | Appearance |
| Sample 28 | 0.02 | 4.6 | 0.069 | x |
| | 0.04 | 9.2 | 0.138 | ∘ |
| | 0.1 | 23 | 0.345 | ⊚ |
| | 0.2 | 46 | 0.69 | ⊚ |

From Table 5, the following can be understood.
In order to suppress the generation of warping and undulation of the bonding optical element, the tensile force is preferably 9.2 N or more and more preferably 23 N or more.
In addition, in consideration of the tensile force, a required shear tensile strength is 0.14 N/15 mm or more and more preferably 0.4 m/15 mm or more.

### <2-2. Relationship Between Bonding Strength of Bonding Optical Element and Peeled State of Peeled Surface>

Next, by using diffusion plates having different surface materials, the relationship between the bonding strength of the bonding optical element and the peeled state of the peeled surface was investigated.

### (Sample 29)

A PC film having a width of 15 mm and a thickness of 80 μm was thermal-welded to a diffusion plate (manufactured by Teijin Chemicals Ltd., trade name: PC9391-505) functioning as the support member, so that a sample was formed. The width of the welded portion was set to approximately 2 mm. For the thermal purpose, a sealer (manufactured by FUJIIMPULSE Co., Ltd., trade name: Fi-300) was used.

### (Sample 30)

Except that as the support member, a diffusion plate (manufactured by Mitsubishi Rayon Co., Ltd., trade name: Acrylite) was used, a sample was formed in a manner similar to that of Sample 29.

Diffusion plate: Base material layer: PC layer, Surface layer: PC layer.

### (Sample 31)

Except that as the support member, a diffusion plate (manufactured by Entire Co., Ltd., trade name: EMS-70G) having the following structure was used, a sample was formed in a manner similar to that of Sample 29.

Diffusion plate: Base material layer: PS layer, Surface layer: MS resin layer containing 60 mass percent of PMMA.

### (Sample 32)

Except that as the support member, a diffusion plate (manufactured by Denka, trade name: TX800LF) having the following structure was used, a sample was formed in a manner similar to that of Sample 29.

Diffusion plate: Base material layer: PS layer, Surface layer: MS resin layer containing 50 mass percent of MMA.

### (Sample 33)

Except that as the support member, a diffusion plate (manufactured by Sumitomo Chemical Co., Ltd., trade name: RM861) was used, a sample was formed in a manner similar to that of Sample 29.

Diffusion plate: Base material layer: PS layer, Surface layer: MS resin layer containing 20 mass percent of MMA.

### (Sample 34)

Except that as the support member, a diffusion plate (manufactured by Asahi Kasei Corp., trade name: DSE60) was used, a sample was formed in a manner similar to that of Sample 29.

Diffusion plate: Base material layer: PS layer, Surface layer: PS layer.

### (Tensile Strength)

By using the samples obtained as described above, the shear tensile strength (0° tensile test) and the peeling strength (180° tensile test) were performed as describe below, and the bonding strength was evaluated. As a measurement apparatus, AG-5kNX manufactured by Shimadzu Corp. was used. The width of the bond portion of the sample was set to 15 mm. In addition, the measurement was performed at a pulling rate of 10 mm/min.

### (Peeled State)

By using the samples obtained as described above, the peeled state of the peeled surface was evaluated as described below. That is, after the PC film was manually peeled away from the support member, it was observed whether interfacial peeling or cohesion failure occurred. In addition, when the peeling was caused by cohesion failure, the surface of the bonding optical element and that of the support member were roughened, and hence recycling thereof becomes difficult. On the other hand, when the peeling was caused by interfacial peeling, the surface of the bonding optical element and that of the support member were not roughened, and hence recycling thereof can be performed.

In Table 6, the evaluation results of Samples 29 to 34 are shown.

TABLE 6

| | | | | Material for base | Shear tensile | Peeling | |
|---|---|---|---|---|---|---|---|
| | | Support member | Material for surface | material layer of | strength | strength | Appearance after |
| | Optical element | (Diffusion plate) | of support member | support member | (N/15 mm) | (N/15 mm) | peeling |
| Sample 29 | PC film | PC9391-50S by Teijin | PC | PC | 93 | 35 | Cohesion failure |
| Sample 30 | PC film | Acrylite by Mitsubishi Rayon | PMMA | PMMA | 79 | 11 | Interfacial peeling |
| Sample 31 | PC film | EMS-70G by Entire | MS | PS | 85 | 9 | Interfacial peeling |
| | | | (MMA:St = 60:40) | | | | |
| Sample 32 | PC film | TX800LF by Denka | MS | PS | 82 | 6 | Interfacial peeling |
| | | | (MMA:St = 50:50) | | | | |
| Sample 33 | PC film | RM861 by Sumitomo Chemical | MS | PS | Not bonded | Not bonded | Not bonded |
| | | | (MMA:St = 20:80) | | | | |
| Sample 34 | PC film | DSE60 by Asahi Kasei | PS | PS | Not bonded | Not bonded | Not bonded |

PC: polycarbonate
PMMA: poly(methyl methacrylate)
MS: methyl methacrylate/styrene copolymer
MMA: methyl methacrylate
St: styrene

From Table 6, the following can be understood.

When a PC film is used as the bonding optical element, and as the support member, a diffusion plate having a surface formed of a PC, a PMMA, or an MS resin (which is a MS resin containing 50 mass percent or more of an MMA component) is used, the bonding optical element and the support member can be bonded to each other. In addition, as described below, when a diffusion plate having a surface formed of SBC or ABS is used as the support member, as in the result described above, the support member and the bonding optical element can be bonded to each other.

When the bonding optical element and the support member are formed using different types of materials, the interfacial peeling can be performed between the support member and the bonding optical element. That is, the bonding optical element and the support member can be recycled.

Hereinafter, as for the MS resin, the relationship between a PMMA component ratio and the bonding strength will be described.

In a copolymer or a mixture between high molecular weight materials, such as PMMA and PS, having different hydrophilic and hydrophobic properties, when the component ratios thereof are different from each other, a so-called sea-island structure is formed in which a large amount component forms a “sea” and a small amount component forms “islands”. In addition, when the component ratios thereof are equivalent to each other, it has been known that in accordance with the component ratios, micro-layer separation occurs in a continuous structure, such as a cylindrical structure, a co-continuous structure, or a lamellar structure. Although the structures mentioned above are most stable from a thermodynamic point of view, since a molding speed of the support member is rapid, it is estimated that an ideal structure is not formed. However, it is believed that the structure tends to be formed in accordance with the component ratios described above.

When the above relationship between the composition ratio and the structure is applied to Samples 31 to 33, the following explanation can be made.

When the ratio of PMMA is smaller than that of PS, PMMA agglomerates, and a contact area between PMMA contained in the surface of the support member and the PC bonding optical element is decreased. Hence, in Sample 33, it is believed that a sufficient bonding strength could not be obtained.

On the other hand, when the ratio of PMMA and that of PS are approximately equivalent to each other, since PMMA forms a continuous structure, although the bonding strength is not so high in Sample 32, it is believed that the PC bonding optical element and the support member could be bonded to each other.

In addition, when the ratio of PMMA is larger than that of PS, since a structure in which PMMA forms a sea or a structure similar to that is formed, the contact area between PMMA contained in the surface of the support member and the PC bonding optical element is increased. Hence, in Sample 31, it is believed that a sufficient bonding strength could be obtained.

From the points described above, it is believed that the MS resin preferably contains 50 mass percent or more of a PMMA component.

### <2-3. Investigation on Bonding Layer>

Next, after various plastic sheets or gel resin layers were each inserted between the support member and the bonding optical element, the above two were bonded to each other with this plastic sheet or gel resin layer interposed therebetween, and the bonding strength was investigated.

### (Sample 35)

First, the following bonding optical element and support member were prepared.

Bonding optical element: a PC film having a width of 15 mm and a width of 80 μm.
Support member: a diffusion plate (manufactured by Entire, trade name: EMS-70G) including a surface layer of an MS resin in which a mass ratio (MMA: St) of poly(methyl methacrylate) MMA and styrene St is 60: 40.

Next, a sample was formed by performing thermal welding of the bonding optical element to the support member. The width of the welded portion was set to approximately 2 mm. For the thermal purpose, a sealer (manufactured by FUJIIMPULSE Co., Ltd., trade name: Fi-300) was used.

### (Sample 36)

Except that the following was used as the support member, a sample was formed in a manner similar to that of Sample 35.

Support member: a diffusion plate (manufactured by Sumitomo Chemical Co., Ltd., trade name: RM861) including a surface layer of an MS resin in which a mass ratio (MMA: St) of poly(methyl methacrylate) MMA and styrene St is 20: 80.

### (Sample 37)

Except that the following bonding layer was inserted between the support member and the bonding optical element, and that the bonding optical element was thermal-welded to the support member with this bonding layer interposed therebetween, a sample was formed in a manner similar to that of Sample 35.

Bonding layer: a PMMA sheet having a width of 3 mm and a thickness of 100 μm.

### (Sample 38)

Except that as the bonding layer, an SBC sheet was used, a sample was formed in a manner similar to that of Sample 35.

### (Sample 39)

Except that as the bonding layer, an ABS sheet was used, a sample was formed in a manner similar to that of Sample 35.

### (Sample 40)

Except that as the bonding layer, a PPO (poly(propylene oxide)) sheet was used, a sample was formed in a manner similar to that of Sample 35.

### (Sample 41)

Except that as the bonding layer, a PEI (poly(ethylene imine)) sheet was used, a sample was formed in a manner similar to that of Sample 35.

### (Sample 42)

Except that as the bonding layer, a sheet of acrylonitrile was used, a sample was formed in a manner similar to that of Sample 35.

### (Sample 43)

A sample was formed under all the same conditions as those of Sample 36.

### (Sample 44)

Except that as the bonding layer, a gel resin layer of cyanoacrylate was used, a sample was formed in a manner similar to that of Sample 35.

### (Sample 45)

Except that as the bonding layer, a gel resin layer of a nitrile rubber was used, a sample was formed in a manner similar to that of Sample 35.

### (Sample 46)

Except that as the bonding layer, a gel resin layer of a styrene butadiene rubber was used, a sample was formed in a manner similar to that of Sample 35.

### (Sample 47)

Except that as the bonding layer, a gel resin layer of a chloroprene rubber was used, a sample was formed in a manner similar to that of Sample 35.

### (Sample 48)

Except that as the bonding layer, a gel resin layer of vinyl acetate was used, a sample was formed in a manner similar to that of Sample 35.

### (Sample 49)

Except that as the bonding layer, a gel resin layer of a silylated urethane was used, a sample was formed in a manner similar to that of Sample 35.

### (Sample 50)

Except that as the bonding layer, a gel resin layer of a modified silicone was used, a sample was formed in a manner similar to that of Sample 35.

### (Sample 51)

Except that as the support member, a diffusion plate (manufactured by Asahi Kasei Corp., trade name: DSE60) having a surface layer of PS was used, a sample was formed in a manner similar to that of Sample 35.

### (Sample 52)

Except that as the bonding layer, a gel resin layer of cyanoacrylate was used, a sample was formed in a manner similar to that of Sample 35.

### (Sample 53)

Except that as the bonding layer, a gel resin layer of a nitrile rubber was used, a sample was formed in a manner similar to that of Sample 35.

### (Sample 54)

Except that as the bonding layer, a gel resin layer of a styrene butadiene rubber was used, a sample was formed in a manner similar to that of Sample 35.

### (Sample 55)

Except that as the bonding layer, a gel resin layer of a chloroprene rubber was used, a sample was formed in a manner similar to that of Sample 35.

### (Sample 56)

Except that as the bonding layer, a gel resin layer of vinyl acetate was used, a sample was formed in a manner similar to that of Sample 35.

### (Sample 57)

Except that as the bonding layer, a gel resin layer of a silylated urethane was used, a sample was formed in a manner similar to that of Sample 35.

### (Sample 58)

Except that as the bonding layer, a gel resin layer of a modified silicone was used, a sample was formed in a manner similar to that of Sample 35.

### (Tensile Strength)

By using the samples obtained as described above, the shear tensile strength (0° tensile test) and the peeling strength (180° tensile test) were performed as describe below, and the bonding strength was evaluated. As a measurement apparatus, AG-5kNX manufactured by Shimadzu Corp. was used. The width of the bond portion of the sample was set to 15 mm. In addition, the measurement was performed at a pulling rate of 10 mm/min.

### (Peeled State)

By using the samples obtained as described above, the peeled state was evaluated as described below. That is, after the PC film was manually peeled away from the support member, it was observed whether interfacial peeling or cohesion failure occurred. In addition, when the peeling was caused by cohesion failure, the surface of the bonding optical element and that of the support member were roughened, and hence recycling thereof becomes difficult. On the other hand, when the peeling was caused by interfacial peeling, the surface of the bonding optical element and that of the support member were not roughened, and hence recycling thereof can be performed.

In Table 7, the evaluation results of Samples 35 to 42 are shown in each of which the plastic sheet was used as the bonding layer.

TABLE 7

| | | | | Shear tensile | Peeling | |
|---|---|---|---|---|---|---|
| | | Surface of support | | strength | strength | Appearance after |
| | optical element | member | Bonding layer | (N/15 mm) | (N/15 mm) | peeling |
| Sample 35 | PC film | MS | No | 85 | 9 | Interfacial peeling |
| | | (MMA:St = 60:40) | | | | |
| Sample 36 | | MS | No | Not bonded | Not bonded | Not bonded |
| Sample 37 | | (MMA:St = 20:80) | PMMA | 90 | 12 | Interfacial peeling |
| Sample 38 | | | SBC | 87 | 24 | Cohesive failure |
| Sample 39 | | | ABS | 87 | 13 | Interfacial peeling |
| Sample 40 | | | PPO | Not bonded | Not bonded | Not bonded |
| Sample 41 | | | PEI | Not bonded | Not bonded | Not bonded |
| Sample 42 | | | Acrylonitrile | Not bonded | Not bonded | Not bonded |

PC: polycarbonate
MS: methyl methacrylate•styrene copolymer
MMA: methyl methacrylate
S: styrene
PMMA: poly(methyl methacrylate)
SBC: styrene•butadiene copolymer
ABS: acrylonitrile•butadiene•styrene copolymer

In Table 8, the evaluation results of Samples 43 to 58 are shown in each of which the gel resin layer was used as the bonding layer.

TABLE 8

| | | | | Shear tensile | Peeling | |
|---|---|---|---|---|---|---|
| | optical | Surface of | | strength | strength | |
| | element | support member | Bonding layer | (N/15 mm) | (N/15 mm) | Appearance after peeling |
| Sample 43 | PC film | MS | No | Not bonded | Not bonded | Not bonded |
| Sample 44 | | (MMS:St = 20:80) | Cyanoacrylate | 85 | 23 | Cohesion failure |
| Sample 45 | | | Nitrile rubber | 83 | 28 | Cohesion failure of adhesive |
| Sample 46 | | | Styrene butadiene rubber | 69 | 7 | Cohesion failure of adhesive |
| Sample 47 | | | Chloroprene rubber | 71 | 8 | Cohesion failure of adhesive |
| Sample 48 | | | Vinyl acetate | 68 | 7 | Cohesion failure of adhesive |
| Sample 49 | | | Silylated urethane | Not bonded | Not bonded | Not bonded |
| Sample 50 | | | Modified silicone | Not bonded | Not bonded | Not bonded |
| Sample 51 | | PS | No | Not bonded | Not bonded | Not bonded |
| Sample 52 | | | Cyanoacrylate | 79 | 14 | Interfacial peeling |
| Sample 53 | | | Nitrile rubber | 85 | 26 | Cohesion failure of adhesive |
| Sample 54 | | | Styrene butadiene rubber | 69 | 3 | Cohesion failure of adhesive |
| Sample 55 | | | Chloroprene rubber | 76 | 16 | Cohesion failure of adhesive |
| Sample 56 | | | Vinyl acetate | 71 | 7 | Cohesion failure of adhesive |
| Sample 57 | | | Silylated urethane | Not bonded | Not bonded | Not bonded |
| Sample 58 | | | Modified silicone | Not bonded | Not bonded | Not bonded |

PC: polycarbonate
MS: methyl methacrylate•styrene copolymer
MMA: methyl methacrylate
St: styrene
PS: polystyrene

From Table 7, the following can be understood.

Sample 35 and 36

In Sample 35, since the surface of the support member is formed of an MS resin layer containing 50 mass percent or more of PMMA, the PC bonding optical element and the support member can be bonded to each other.

On the other hand, in Sample 36, since the surface of the support member is formed of an MS resin layer containing less than 50 mass percent of MMA, the PC bonding optical element and the support member cannot be bonded to each other.

Sample 37 to 42

In Samples 37 to 39, as the bonding layer, the sheet formed of PMMA, SBC, or ABS is disposed between the PC bonding optical element and the support member. Hence, even when the surface of the support member is formed of an MS resin layer containing less than 50 mass percent of MMA, the PC bonding optical element and the support member can be bonded to each other.

On the other hand, in Samples 40 to 42, as the bonding layer, the sheet formed of PPO, PEI, or acrylonitrile is disposed between the PC bonding optical element and the support member. Hence, when the surface of the support member is formed of an MS resin layer containing less than 50 mass percent of MMA, the PC bonding optical element and the support member cannot be bonded to each other.

From Table 8, the following can be understood.

Samples 43 to 50

In Samples 44 to 48, between the PC bonding optical element and the support member, the gel resin layer formed of cyanoacrylate, a nitrile rubber, a styrene.butadiene rubber, a chloroprene rubber, or vinyl acetate is disposed as the bonding layer. Hence, even when the surface of the support member is formed of an MS resin layer containing less than 50 mass percent of PMMA, the PC bonding optical element and the support member can be bonded to each other.

On the other hand, in Sample 43, the bonding layer is not disposed between the PC bonding optical element and the support member. Hence, when the surface of the support member is formed of an MS resin layer containing less than 50 mass percent of MMA, the PC bonding optical element and the support member cannot be bonded to each other.

In addition, in Samples 49 and 50, between the PC bonding optical element and the support member, the gel resin layer formed of a silica urethane or a modified silicone is disposed as the bonding layer. Hence, when the surface of the support member is formed of an MS resin layer containing less than 50 mass percent of MMA, the PC bonding optical element and the support member cannot be bonded to each other.

Samples 51 to 58

In Samples 52 to 56, between the PC bonding optical element and the support member, the gel resin layer formed of cyanoacrylate, a nitrile rubber, a styrene.butadiene rubber, a chloroprene rubber, vinyl acetate, or an acryl adhesive tape is disposed as the bonding layer. Hence, even when the surface of the support member is formed of PS, the PC bonding optical element and the support member can be bonded to each other.

On the other hand, in Sample 51, the bonding layer is not disposed between the PC bonding optical element and the support member. Hence, when the surface of the support member is formed of PS, the PC bonding optical element and the support member cannot be bonded to each other.

In addition, in Samples 57 and 58, between the PC bonding optical element and the support member, the gel resin layer formed of a silica urethane or a modified silicone is disposed as the bonding layer. Hence, when the surface of the support member is formed of PS, the PC bonding optical element and the support member cannot be bonded to each other.

Furthermore, in Table 8, although the peeling strength is high, the interfacial peeling occurs. The interfacial peeling is generated at the interface between the adhesive and the support member or at the interface between the adhesive and the optical element. Instead of using thermal welding at the interface as performed in Samples 28 to 42, since the adhesives are used, it may be said that the critical point of a peeling strength at which the cohesion failure occurs is high.

When the results shown in Tables 7 and 8 are collectively taken into consideration, the following can be understood.

When the PC bonding optical element is used as the bonding optical element, and the support member including an MS resin containing less than 50 mass percent of MMA or a polystyrene resin in the surface thereof is used, the bonding layer is preferably provided between the bonding optical element and the support member. As the bonding layer, a plastic sheet including at least one of PMMA, SBC, and ABS as a primary component is preferable. In addition, as the bonding layer, a gel resin layer including at least one of cyanoacrylate, a nitrile rubber, a styrene.butadiene rubber, a chloroprene rubber, and vinyl acetate as a primary component is preferable.

Heretofore, the embodiments of the present invention have been particularly described; however, the present invention is not limited to those embodiments described above, and various changes based on the technical scope of the present invention may be made.

For example, the structures, methods, shapes, materials, numerical values, and the like described in the above embodiments are simply described by way of example, and whenever necessary, structures, methods, shapes, materials, numerical values, and the like different from those described above may also be used.

In addition, the individual structures of the above embodiments may be used in combination without departing from the scope of the present invention.

In addition, in the above embodiments, although the case in which the tensile force is applied to the bonging optical element before the bonding thereof is described by way of example, the tensile force may be applied to the bonding optical element after the boding thereof.

As a method for applying a tensile force after the bonding, for example, a method may be mentioned in which by using a heat contractive bonding optical element, a heat treatment is performed after the bonding so as to apply a tensile force to the bonding optical element. In addition, a method may also be mentioned in which at least one of the support member and the bonding optical element is heated and/or cooled to generate a temperature difference between the support member and the bonding optical element, and by using contraction and/or expansion caused by this temperature difference, a tensile force is applied to the bonding optical element. Furthermore, instead of using the contraction and/or expansion caused by the temperature difference, by using contraction and/or expansion caused by a humidity difference, a tensile force may be applied to the bonding optical element. In addition, the contraction and/or expansion caused by both differences in temperature and humidity may also be used.

As the method for applying a tensile force to the bonding optical element using the contraction and/or expansion caused by the temperature difference, for example, the following methods may be mentioned. A method may be mentioned in which after the support member is cooled lower than room temperature so as to be contracted, and the bonding optical element is bonded to the support member thus contracted, the support member is returned to room temperature and is thermally expanded so as to apply a tensile force to the bonding optical element. In addition, a method may also be mentioned in which after the bonding optical element is heated as compared to room temperature so as to be thermally expanded, and the bonding optical element thus thermally expanded is bonded to the support member, the bonding optical element is returned to room temperature and is contracted so as to apply a tensile force to the bonding optical element.

1-19. (canceled)

20. An optical element laminate comprising:
a plate-shaped support member having a first primary surface, a second primary surface, and end surfaces between the first primary surface and the second primary surface; and
a contractive or a stretch optical element which covers the first primary surface or the second primary surface of the support member and which has a film shape or a sheet shape,
wherein the optical element has a bond surface at least bonded to facing two side portions of a peripheral portion of the first primary surface or the second primary surface of the support member or to facing two end surfaces of the end surfaces of the support member, and
a tensile force F acting on the optical element satisfies the following relational expression (1) in an environment at a temperature of 70° C.
0≦F≦1.65×10⁴×t/L (1)
Where, in the expression (1), t, L, and F indicate the following.
t: a distance between the first primary surface and the second primary surface of the support member,
L: a length of the facing two side portions to which the optical element is bonded or a length of a long side of the facing two end surfaces to which the optical element is bonded, and
F: a tensile force of the optical element acting in a direction parallel to a side portion having the length L or a tensile force of the optical element acting in a direction parallel to the long side of an end surface having the length L.

21. The optical element laminate according to claim 20,
wherein the optical element has the bond surface bonded to all four side portions of the first primary surface or the second primary surface of the support member or to all four end surfaces of the support member, and
tensile forces F1 and F2 acting on the optical element satisfy the following relational expressions (2) and (3) at a temperature of 70° C.
0≦F≦1.65×10⁴×t/L2 (2)
0≦F2≦1.65×10⁴×t/L1 (3)
Where, in the expressions (2) and (3), t, L1, L2, F1, and F2 indicate the following.
t: a distance between the first primary surface and the second primary surface of the support member,
L1 and L2: each indicating a length of facing two side portions to which the optical element is bonded or a length of a long side of facing two end surfaces to which the optical element is bonded,
F1: a tensile force of the optical element acting in a direction parallel to a side portion having the length L1 or a tensile force of the optical element acting in a direction parallel to the long side of an end surface having the length L1, and
F2: a tensile force of the optical element acting in a direction parallel to a side portion having the length L2 or a tensile force of the optical element acting in a direction parallel to the long side of an end surface having the length L2.

22. An optical element laminate comprising:
a plate-shaped support member having a first primary surface, a second primary surface, and end surfaces between the first primary surface and the second primary surface; and
an optical element which covers the first primary surface or the second primary surface of the support member and which has a film shape or a sheet shape,
wherein the optical element has a bond surface at least bonded to facing two side portions of a peripheral portion of the first primary surface or the second primary surface of the support member or to facing two end surfaces of the end surfaces of the support member, and
a shear tensile strength between the optical element and the support member is 0.14 N/15 mm or more.

23. The optical element laminate according to claim 22,
wherein the bond surface of the optical element and the first primary surface, the second primary surface, or the end surfaces of the support member to which the bond surface is bonded include the same material.

24. The optical element laminate according to claim 22,
wherein a peeling strength between the optical element and the support member is less than 20 N/15 m.

25. The optical element laminate according to claim 22,
wherein the bond surface of the optical element includes a polycarbonate,
the first primary surface, the second primary surface, or the end surfaces of the support member to which the optical element is bonded include at least one of a copolymer of methyl methacrylate and styrene, a mixture of a poly(methyl methacrylate) and a polystyrene, and a poly(methyl methacrylate),
the copolymer contains 50 mass percent or more of the methyl methacrylate, and
the mixture contains 50 mass percent or more of the poly(methyl methacrylate).

26. The optical element laminate according to claim 25,
wherein the support member includes:
a base material layer, and
a surface layer formed on at least one surface of the base material layer,
the optical element is bonded to the support member with the surface layer,
the base material layer includes a polystyrene,
the surface layer includes at least one of a copolymer of methyl methacrylate and styrene, a mixture of a poly(methyl methacrylate) and a polystyrene, and a poly(methyl methacrylate),
the copolymer contains 50 mass percent or more of the methyl methacrylate, and
the mixture contains 50 mass percent or more of the poly(methyl methacrylate).

27. The optical element laminate according to claim 22,
wherein the bond surface of the optical element includes at least one of a copolymer of methyl methacrylate and styrene, a mixture of a poly(methyl methacrylate) and a polystyrene, and a poly(methyl methacrylate),
the copolymer of methyl methacrylate and styrene included in the bond surface of the optical element contains 50 mass percent or more of the methyl methacrylate,
the mixture of a poly(methyl methacrylate) and a polystyrene included in the bond surface of the optical element contains 50 mass percent or more of the poly(methyl methacrylate),
the first primary surface, the second primary surface, or the end surfaces of the support member to which the optical element is bonded include at least one of a copolymer of methyl methacrylate and styrene, a mixture of a poly(methyl methacrylate) and a polystyrene, and a polystyrene,
the copolymer of methyl methacrylate and styrene included in the first primary surface, the second primary surface, or the end surfaces of the support member contains less than 50 mass percent of the methyl methacrylate, and
the mixture of a poly(methyl methacrylate) and a polystyrene included in the first primary surface, the second primary surface, or the end surfaces of the support member contains less than 50 mass percent of the poly(methyl methacrylate).

28. The optical element laminate according to claim 27,
wherein the optical element includes:
a base material layer, and
a surface layer formed on at least one surface of the base material layer,
the optical element is bonded to the support member with the surface layer,
the base material layer includes at least one of a polycarbonate and a poly(ethylene terephthalate),
the surface layer includes at least one of the copolymer of methyl methacrylate and styrene, the mixture of a poly(methyl methacrylate) and a polystyrene, and a poly(methyl methacrylate),
the copolymer of methyl methacrylate and styrene included in the surface layer contains 50 mass percent or more of the methyl methacrylate, and
the mixture of a poly(methyl methacrylate) and a polystyrene included in the surface layer contains 50 mass percent or more of the poly(methyl methacrylate).

29. The optical element laminate according to claim 22, further comprising:
a bonding layer between the support member and the optical element,
wherein the bond surface of the optical element includes a polycarbonate,
the first primary surface, the second primary surface, or the end surfaces of the support member to which the optical element is bonded include at least one of a copolymer of methyl methacrylate and styrene, a mixture of a poly(methyl methacrylate) and a polystyrene, and a polystyrene,
the copolymer contains less than 50 mass percent of the methyl methacrylate,
the mixture contains less than 50 mass percent of the poly(methyl methacrylate), and
the bonding layer includes at least one of a poly(methyl methacrylate), a styrene.butadiene copolymer, and an acrylonitrile.butadiene.styrene copolymer.

30. The optical element laminate according to claim 29,
wherein the bonding layer is formed on the peripheral portion of at least one of the first primary surface and the second primary surface of the support member.

31. The optical element laminate according to claim 22, further comprising:
a bonding layer between the support member and the optical element,
wherein the bond surface of the optical element includes a polycarbonate,
the first primary surface, the second primary surface, or the end surfaces of the support member to which the optical element is bonded include at least one of a copolymer of methyl methacrylate and styrene, a mixture of a poly(methyl methacrylate) and a polystyrene, and a polystyrene,
the copolymer contains less than 50 mass percent of the methyl methacrylate,
the mixture contains less than 50 mass percent of the poly(methyl methacrylate), and
the bonding layer includes at least one of an acryl-based adhesive, a butadiene-based adhesive, an acrylonitrile.butadiene-based adhesive, and a chloroprene-based adhesive.

32. The optical element laminate according to claim 22,
wherein the support member is a diffusion plate or a light guide plate.

33. The optical element laminate according to claim 22,
wherein the support member is a reflective polarizer.

34. The optical element laminate according to claim 22, further comprising:
at least one optical element having a film shape or a sheet shape between the support member and the optical element bonded thereto.

35. A backlight comprising an optical element laminate including:
a plate-shaped support member having a first primary surface, a second primary surface, and end surfaces between the first primary surface and the second primary surface; and
a contractive or a stretch optical element which covers the first primary surface or the second primary surface of the support member and which has a film shape or a sheet shape,
wherein the optical element has a bond surface at least bonded to facing two side portions of a peripheral portion of the first primary surface or the second primary surface of the support member or to facing two end surfaces of the end surfaces of the support member, and
a tensile force F acting on the optical element satisfies the following relational expression (1) in an environment at a temperature of 70° C.
0≦F≦1.65×10⁴×t/L (1)
Where, in the expression (1), t, L, and F indicate the following.
t: a distance between the first primary surface and the second primary surface of the support member,
L: a length of the facing two side portions to which the optical element is bonded or a length of a long side of the facing two end surfaces to which the optical element is bonded, and
F: a tensile force of the optical element acting in a direction parallel to a side portion having the length L or a tensile force of the optical element acting in a direction parallel to the long side of an end surface having the length L.

36. A liquid crystal display device comprising an optical element laminate including:
a plate-shaped support member having a first primary surface, a second primary surface, and end surfaces between the first primary surface and the second primary surface; and
a contractive or a stretch optical element which covers the first primary surface or the second primary surface of the support member and which has a film shape or a sheet shape,
wherein the optical element has a bond surface at least bonded to facing two side portions of a peripheral portion of the first primary surface or the second primary surface of the support member or to facing two end surfaces of the end surfaces of the support member, and
a tensile force F acting on the optical element satisfies the following relational expression (1) in an environment at a temperature of 70° C.
0≦F≦1.65×10⁴×t/L (1)
Where, in the expression (1), t, L, and F indicate the following.
t: a distance between the first primary surface and the second primary surface of the support member,
L: a length of the facing two side portions to which the optical element is bonded or a length of a long side of the facing two end surfaces to which the optical element is bonded, and
F: a tensile force of the optical element acting in a direction parallel to a side portion having the length L or a tensile force of the optical element acting in a direction parallel to the long side of an end surface having the length L.

37. A method for manufacturing an optical element laminate comprising:
while a tensile force is applied to a contractive or a stretch optical element having a film shape or a sheet shape, bonding the optical element to facing two side portions of a peripheral portion of a first primary surface or a second primary surface of a plate-shaped support member or to facing two end surfaces of end surfaces of the support member,
wherein a thickness t of the support member, a length L of the support member, and a tensile force F of the optical element satisfy the following relational expression (1) in an environment at a temperature of 70° C.
0≦F≦1.65×10⁴×t/L (1)
Where, in the expression (1), t, L, and F indicate the following.
t: a distance between the first primary surface and the second primary surface of the support member,
L: a length of the facing two side portions to which the optical element is bonded or a length of a long side of the facing two end surfaces to which the optical element is bonded, and
F: a tensile force of the optical element acting in a direction parallel to a side portion having the length L or a tensile force of the optical element acting in a direction parallel to the long side of an end surface having the length L.

38. A method for manufacturing an optical element laminate comprising:
while a tensile force is applied to an optical element having a film shape or a sheet shape, bonding the optical element to facing two side portions of a peripheral portion of a first primary surface or a second primary surface of a plate-shaped support member or to facing two end surfaces of end surfaces of the support member,
wherein a shear tensile strength between the optical element and the support member is 0.14 N/15 mm or more.
